(19) United States
(12) Patent Application Publication
(10) Pub. No.: US 2022/0117307 A1
(43) Pub. Date: Apr. 21, 2022

(54) AEROSOL-GENERATING DEVICE

(71) Applicant: Nicoventures Trading Limited, London Greater London (GB)

(72) Inventors: Walid Abi Aoun, London (GB); Ashley John Sayed, London (GB); Luke James Warren, London (GB); Lois Mollison-Ball, London (GB); Ben Zainuddin, London (GB); Marina Trani, London (GB); Edward Joseph Halliday, London (GB); Thomas Alexander John Woodman, London (GB); Mitchel Thorsen, Madison, WI (US); Thomas Paul Blandino, Madison, WI (US)

(73) Assignee: Nicoventures Trading Limited, London Greater London (GB)

(21) Appl. No.: 17/593,140

(22) PCT Filed: Mar. 9, 2020
(86) PCT No.: PCT/EP2020/056270

§ 371 Date: Sep. 10, 2021

(30) Foreign Application Priority Data
Mar. 11, 2019 (GB) 1903298.6
Mar. 11, 2019 (GB) 1903299.4
Mar. 11, 2019 (GB) 1903303.4
Mar. 11, 2019 (GB) 1903305.9
Mar. 11, 2019 (GB) 1903306.7
Mar. 11, 2019 (GB) 1903307.5
May 24, 2019 (GB) 1907428.5
May 24, 2019 (GB) 1907429.3
May 24, 2019 (GB) 1907431.9
May 24, 2019 (GB) 1907432.7
May 24, 2019 (GB) 1907433.5
May 24, 2019 (GB) 1907434.3

(51) Int. Cl. A24F 40/465; A24F 40/57

(52) U.S. Cl. CPC A24F 40/465; A24F 40/20; A24F 40/57

(57) ABSTRACT

Described herein is an aerosol-generating device for generating aerosol from an aerosol-generating material. The aerosol-generating device comprises a heating assembly having a mouth end and a distal end. The heating assembly comprises: a first induction heating unit arranged to heat, but not burn, the aerosol-generating material in use; a second induction heating unit arranged to heat, but not burn, the aerosol-generating material in use, the first induction heating unit being disposed closer to the mouth end of the heating assembly than the second induction heating unit; and a controller for controlling the first and second induction heating units. The heating assembly is configured such that at least one induction heating unit reaches a maximum operating temperature within 20 seconds of supplying power to the at least one induction heating unit.

### PRIORITY CLAIM

The present application is a National Phase entry of PCT Application No. PCT/EP2020/056270, filed Mar. 9, 2020, which claims priority from Great Britain Application No. 1903305.9, filed Mar. 11, 2019; Great Britain Application No. 1903307.5, filed Mar. 11, 2019; Great Britain Application No. 1903299.4, filed Mar. 11, 2019; Great Britain Application No. 1903298.6, filed Mar. 11, 2019; Great Britain Application No. 1903306.7, filed Mar. 11, 2019; Great Britain Application No. 1903303.4, filed Mar. 11, 2019; U.S. Provisional Application No. 62/816,341, filed Mar. 11, 2019; Great Britain Application No. 1907432.7, filed May 24, 2019; Great Britain Application No. 1907431.9, filed May 24, 2019; Great Britain Application No. 1907433.5, filed May 24, 2019; Great Britain Application No. 1907429.3, filed May 24, 2019; Great Britain Application No. 1907428.5, filed May 24, 2019; and Great Britain Application No. 1907434.3, filed May 24, 2019, each of which is hereby fully incorporated herein by reference.

### TECHNICAL FIELD

The present invention relates to an aerosol-generating device, a method of generating an aerosol using the aerosol-generating device, and an aerosol-generating system comprising the aerosol-generating device.

### BACKGROUND

Articles such as cigarettes, cigars and the like burn tobacco during use to create tobacco smoke. Attempts have been made to provide alternatives to these types of articles, which burn tobacco, by creating products that release compounds without burning. Apparatuses are known that heat smokable material to

volatilize at least one component of the smokable material, typically to form an aerosol which can be inhaled, without burning or combusting the smokable material. Such apparatus is sometimes described as a “heat-not-burn” apparatus or a “tobacco heating product” (THP) or “tobacco heating device” or similar. Various different arrangements for volatilizing at least one component of the smokable material are known.

The material may be for example tobacco or other non-tobacco products or a combination, such as a blended mix, which may or may not contain nicotine.

### SUMMARY

First Aspect

According to one aspect of the present invention, there is provided an aerosol-generating device for generating aerosol from an aerosol-generating material, the aerosol-generating device comprising: a heating assembly having a mouth end and a distal end, the heating assembly comprising: a first induction heating unit arranged to heat, but not burn, the aerosol-generating material in use; a second induction heating unit arranged to heat, but not burn, the aerosol-generating material in use, the first induction heating unit being disposed closer to the mouth end of the heating assembly than the second induction heating unit; and a controller for controlling the first and second induction heating units; wherein the heating assembly is configured such that at least one induction heating unit reaches a maximum operating temperature within 20 seconds of supplying power to the at least one induction heating unit. In one embodiment, the at least one induction heating unit includes the first induction heating unit.

In some embodiments, the first temperature which the at least one induction heating unit holds substantially constant for at least 1, 3, 5, or 10 seconds is the maximum operating temperature.

In some embodiments, the heating assembly may be configured such that at least one induction heating unit such as the first induction heating unit reaches a maximum temperature within approximately 15 seconds of supplying power to the first induction heating unit, or 12 seconds, or 10 seconds, or 5 seconds, or 2 seconds. In a preferred embodiment, the heating assembly is configured such that the heating unit reaches a maximum temperature within approximately 2 seconds of supplying power to the heating unit. In a particularly preferred embodiment, the aerosol-generating device is a tobacco heating product, and the heating assembly is configured such that the first induction heating unit reaches a maximum temperature within approximately 12 seconds of supplying power to the first induction heating unit, or 10 seconds, or 5 seconds, or 2 seconds.

The device may be activated by a user interacting with the device. In some embodiments, the heating assembly may be configured such that the induction heating unit reaches a maximum temperature within approximately 15 seconds of activating the device, or 12 seconds, or 10 seconds, or 5 seconds, or 2 seconds. In a preferred embodiment, the heating assembly is configured such that the induction heating unit reaches a maximum temperature within approximately 2 seconds of activation. In a particularly preferred embodiment, the aerosol-generating device is a tobacco heating product, and thee heating assembly is configured such that the first induction heating unit reaches a maximum temperature within approximately 12 seconds of activating the device, or 10 seconds, or 5 seconds, or 2 seconds.

In some embodiments, the first induction heating unit is controllable independent from the second induction heating unit. In particular embodiments, the heating assembly may be configured such that the first induction heating unit reaches a maximum operating temperature within approximately 20 seconds of activating the device, and the second induction heating unit reaches a maximum operating temperature at a later stage.

In some embodiments the heating assembly may be configured such that the second induction heating unit reaches a maximum operating temperature after at least approximately 30 seconds, 40 seconds, 50 seconds, 60 seconds, 80 seconds, 100 seconds, or 120 seconds from the start of a session of use. Preferably, the assembly is arranged such that the second induction heating unit reaches a maximum operating temperature after at least approximately 120 seconds from the start of the session of use.

In some embodiments, the heating assembly is configured such that the second induction heating unit reaches a maximum operating temperature at least approximately 10 seconds, 20 seconds, 30 seconds, 40 seconds, 50 seconds, 60 seconds, 80 seconds, 100 seconds, or 120 seconds after the first induction heating unit reaches its maximum operating temperature. Preferably, the heating assembly is configured such that the second induction heating unit reaches a maximum operating temperature at least approximately 120 seconds after the first induction heating unit reaches its maximum operating temperature.

In some embodiments, the heating assembly is configured such that the second induction heating unit rises to a first operating temperature which is lower than the maximum operating temperature before subsequently rising to its maximum operating temperature. The heating assembly is configured such that the second induction heating unit reaches a first operating temperature lower than the maximum operating temperature at least approximately 10 seconds, 20 seconds, 30 seconds, 40 seconds, 50 seconds, or 60 seconds after the start of the session of use.

In some embodiments, the heating assembly is configured such that the second induction heating unit rises from a first operating temperature which is lower than the maximum operating temperature to its maximum operating temperature within 10 seconds, or 5 seconds, 4 seconds, 3 seconds or 2 seconds of the programmed time point for increasing the temperature of the second induction heating unit to its maximum operating temperature.

In some embodiments, the maximum operating temperature of the first and/or second heating unit is from approximately 200° C. to 300° C., or 220° C. to 280° C., or 230° C. to 270° C., or 240 to 260° C., or preferably approximately 250° C. In some embodiments, the maximum operating temperature is less than approximately 300° C., or 290° C., or 280° C., or 270° C., or 260° C., or 250° C. In some embodiments, the maximum operating temperature is greater than approximately 200° C., or 210° C., or 220° C., or 230° C., or 240° C. Advantageously, the maximum operating temperature of the induction heating unit is selected to rapidly heat an aerosol-generating material such as tobacco without burning or charring the aerosol-generating material or any protective wrapper associated with the aerosol-generating material (such as a paper wrap).

In some embodiments, the aerosol-generating device is configured to generate aerosol from a liquid aerosol-generating material. In some embodiments, the aerosol-generating device is configured to generate aerosol from a combination of liquid and non-liquid aerosol-generating material. In other, preferred embodiments, the aerosol-generating device is configured to generate aerosol from a non-liquid aerosol-generating material.

The aerosol-generating material preferably comprises tobacco and/or tobacco extract. In a particularly preferred embodiment, the aerosol-generating material comprises solid tobacco. The aerosol-generating material may also comprise an aerosol-generating agent such a glycerol. In a more preferred embodiment, the aerosol-generating device is a tobacco heating product which is configured to generate an aerosol from a non-liquid aerosol-generating material comprising tobacco and optionally aerosol-generating agent.

In some embodiments the aerosol-generating device comprises an indicator for indicating to a user that the device is ready for use within 20 seconds of activating the device. The indicator is preferably configured to indicate to a user that the device is ready for use by visual and/or haptic feedback. Advantageously, the indicator allows a user to be confident in receiving a satisfactory first puff when using the device.

Second Aspect

According to a further aspect of the present invention, there is provided an aerosol-generating device for generating aerosol from an aerosol-generating material, the aerosol-generating device comprising: a heating assembly having a mouth end and a distal end, the heating assembly comprising: a first induction heating unit arranged to heat, but not burn, the aerosol-generating material in use; a second induction heating unit arranged to heat, but not burn, the aerosol-generating material in use, the first induction heating unit being disposed closer to the mouth end of the heating assembly than the second induction heating unit; and a controller for controlling the first and second induction heating units; wherein the heating assembly is configured such that at least one induction heating unit reaches a maximum operating temperature at a rate of at least 50° C. per second in use. In one embodiment, the at least one induction heating unit includes the first induction heating unit.

In some embodiments, the heating assembly may be configured such that in a session of use the second induction heating unit rises from a first operating temperature which is lower than its maximum operating temperature to the maximum operating temperature at a rate of at least 50° C. per second. In a preferred embodiment, the heating assembly is configured such that in a session of use the second induction heating unit reaches the maximum operating temperature at a rate of at least 100° C. per second. In a particularly preferred embodiment, the heating assembly is configured such that in a session of use the second induction heating unit reaches the maximum operating temperature at a rate of at least 150° C. per second.

Third Aspect

According to a further aspect of the present invention, there is provided an aerosol-generating device for generating aerosol from an aerosol-generating material, the aerosol-generating device comprising: a heating assembly having a mouth end and a distal end, the heating assembly comprising: a first heating unit arranged to heat, but not burn, the aerosol-generating material in use; a second heating unit arranged to heat, but not burn, the aerosol-generating material in use, the first heating unit being disposed closer to the mouth end of the heating assembly than the second heating unit; and a controller for controlling the first and second heating units; wherein the heating assembly is configured such that the first heating unit reaches a maximum operating temperature within 15 seconds of supplying power to the first heating unit. One or more of the heating units may comprise a coil.

The heating assembly may be configured such that the first heating unit reaches a maximum operating temperature within 10 seconds, 8 seconds, 6 seconds, or 4 seconds of supplying power to the first heating unit. In one embodiment, the first heating unit is an electrically resistive heating element. For example, where the heating unit comprises a coil, the heating unit may be an induction heating unit comprising a susceptor, wherein the coil is configured to be an inductor element for supplying a varying magnetic field to the susceptor. In another embodiment, the first heating unit is an induction heating unit.

Fourth Aspect

According to a further aspect of the present invention there is provided a method of generating aerosol from an aerosol-generating material using an aerosol-generating device according the 0 Aspect or 0 Aspect comprising a first induction heating unit, the method comprising supplying power to the first induction heating unit, thereby heating the first induction heating unit to a maximum operating temperature within 20 seconds of supplying the power to the heating unit.

Fifth Aspect

According to further aspect of the present invention, there is provided an aerosol-generating device for generating aerosol from an aerosol-generating material, the aerosol-generating device comprising: a heating assembly having a mouth end and a distal end, the heating assembly comprising: a first induction heating unit arranged to heat, but not burn, the aerosol-generating material in use; a second induction heating unit arranged to heat, but not burn, the aerosol-generating material in use, the first induction heating unit being disposed closer to the mouth end of the heating assembly than the second induction heating unit; and a controller for controlling the first and second induction heating units; wherein the heating assembly is configured such that at least one induction heating unit reaches a temperature of from 200° C. to 300° C. within 20 seconds of supplying power to the at least one induction heating unit.

In some embodiments, the heating assembly is configured such that the at least one induction heating unit reaches a temperature of from 200° C. to 280° C. within 20 seconds and substantially maintains that temperature (that is, within 10° C., 5° C., 4° C., 3° C., 2° C. or 1° C. of that temperature) for 2 seconds, 3 seconds, 4 seconds, 5 seconds, 10 seconds, 15 seconds, 20 seconds, or 30 seconds.

In some embodiments, the at least one induction temperature reaches the temperature within 15 seconds of supplying power to the first induction heating unit, or 12 seconds, or 10 seconds, or 5 seconds, or 2 seconds.

In some embodiments, the at least one induction heating unit reaches a temperature of from 200° C. to 300° C., or 200° C. to 280° C., or 210° C. to 270° C., or 210° C. to 260° C., or 210° C. to 250° C. In some embodiments, the at least one induction heating unit reaches a temperature of less than approximately 300° C., or 290° C., or 280° C., or 270° C., or 260° C., or 250° C. In some embodiments, the at least one induction heating unit reaches a temperature of greater than approximately 200° C., or 210° C., or 220° C., or 230° C., or 240° C.

Sixth Aspect

According to a further aspect of the present invention, there is provided an aerosol-generating device for generating aerosol from an aerosol-generating material, the aerosol-generating device comprising: a heating assembly including one or more heating units arranged to heat, but not burn, the aerosol-generating material in use; and a controller for controlling the one or more heating units; wherein the heating assembly is operable in at least a first mode and a second mode; the first mode comprising supplying energy to the one or more heating units for a first-mode session of use having a first predetermined duration; and the second mode comprising supplying energy to the one or more heating units for a second-mode session of use having a second predetermined duration; wherein the first predetermined duration is different from the second predetermined duration.

Preferably, the first predetermined duration is longer than the second predetermined duration.

In one embodiment, the heating assembly comprises a plurality of heating units. The plurality comprises a first heating unit arranged to heat, but not burn, the aerosol-generating material in use, and a second heating unit arranged to heat, but not burn, the aerosol-generating material in use.

In this embodiment, the first mode may comprise supplying energy to the first heating unit for a first-mode predetermined duration, and the second mode may comprise supplying energy to the first heating unit for a second-mode predetermined duration. The first-mode predetermined duration of supplying energy to the first heating unit may be different from the second-mode predetermined duration of supplying energy to the first heating unit.

Preferably, the first-mode predetermined duration of supplying energy to the first heating unit is from approximately 3 minutes to 5 minutes. Preferably, the second-mode predetermined duration of supplying energy to the first heating unit is from approximately 2 minutes 30 seconds to 3 minutes 30 seconds.

Similarly, the first mode may comprise supplying energy to the second heating unit for a first-mode predetermined duration, and the second mode may comprise supplying energy to the second heating unit for a second-mode predetermined duration. The first-mode predetermined duration of supplying energy to the second heating unit may be different from the second-mode predetermined duration of supplying energy to the first heating unit.

Preferably, the first-mode predetermined duration of supplying energy to the second heating unit is from approximately 2 minutes to 3 minutes 30 seconds. Preferably, the second-mode predetermined duration of supplying energy to the second heating unit is from approximately 1 minute 30 seconds to 3 minutes.

In these embodiments, the first-mode predetermined duration of supplying energy to the first heating unit may be different from the first-mode predetermined duration of supplying energy to the second heating unit. Also, the second-mode predetermined duration of supplying energy to the first heating unit may be different from the second-mode predetermined duration of supplying energy to the second heating unit.

The first predetermined duration of the first-mode session of use may be greater than the first-mode predetermined duration of supplying energy to the second heating unit. Similarly, the second predetermined duration of the second-mode session of use may be greater than the second-mode predetermined duration of supplying energy to the second heating unit.

The first predetermined duration of the first-mode session of use may be substantially the same as the first-mode predetermined duration of supplying energy to the first heating unit. Similarly, the second predetermined duration of the second-mode session of use may be substantially the same as the second-mode predetermined duration of supplying energy to the first heating unit.

Seventh Aspect

According to a further aspect of the invention, there is provided an aerosol-generating device for generating aerosol from an aerosol-generating material. The aerosol-generating device comprises a heating assembly including one or more heating units arranged to heat, but not burn, the aerosol-generating material in use, and a controller for controlling the one or more heating units. The heating assembly is configured to provide a session of use having a duration of less than 7 minutes.

Preferably, the heating assembly is configured to provide a session of use having a duration of less than 4 minutes 30 seconds. More preferably, the heating assembly comprises induction heating units and is configured to provide a session of use having a duration of less than 4 minutes 30 seconds.

The aerosol-generating device of this second aspect may be operable in a plurality of modes as described herein in relation to the first aspect. Accordingly, features described herein in relation to one aspect of the invention are explicitly disclosed in combination with the other aspects, to the extent that they are compatible.

In one such embodiment, the first duration of the first-mode session of use and/or the second duration of the second-mode session of use is less than 7 minutes. In particular,

the first duration of the first-mode session of use and/or the second duration of the second-mode session of use may be from approximately 2 minutes 30 seconds to 5 minutes.

In some embodiments, of each session of use is less than 4 minutes 30 seconds. For example, the first predetermined duration may be from approximately 3 minutes to 4 minutes 30 seconds, and the second predetermined duration may be from approximately 2 minutes 30 seconds to 3 minutes 30 seconds.

In some embodiments, the duration of the first-mode session of use is longer than the duration of the second-mode session of use.

In some embodiments the first-mode session of use has a duration of less than 4 minutes. In some embodiments, the second-mode session of use has a duration of less than 3 minutes.

In one embodiment, each heating unit in the heating assembly comprises a coil. For example, each heating unit in the heating assembly may be an induction heating unit comprising a susceptor heating element, wherein the coil is configured to be an inductor element for supplying a varying magnetic field to the susceptor heating element. In another embodiment, each heating unit in the heating assembly is a resistive heating unit.

Eighth Aspect

According to a further aspect of the present invention, there is provided an aerosol-generating device for generating aerosol from an aerosol-generating material. The aerosol-generating device comprises a heating assembly. The heating assembly includes at least a first heating unit arranged to heat, but not burn, the aerosol-generating material in use, and a controller for controlling the first heating unit.

The heating assembly is configured such that the first heating unit reaches a maximum operating temperature of from 245° C. to 340° C. in use. In some embodiments, the heating assembly is configured such that the first heating unit reaches a maximum operating temperature of from 245° C. to 300° C. in use, preferably 250° C. to 280° C. in use.

In some embodiments, the heating assembly may further comprise a second heating unit arranged to heat, but not burn, the aerosol-generating material in use, the second heating unit being controllable by the controller. The second heating unit is preferably controllable independent of the first heating unit. The heating assembly may be configured such that the second heating unit reaches a maximum operating temperature of from 245° C. to 340° C. in use. In some embodiments, the heating assembly is configured such that the second heating unit reaches a maximum operating temperature of from 245° C. to 300° C. in use, preferably 250° C. to 280° C. in use.

In some embodiments, the heating assembly comprises a maximum of two heating units which are controllable by the controller. Alternatively, the heating assembly may comprise three or more heating units which are independently controllably by the controller.

In some embodiments, the heating assembly is configured such that, in use, the second heating unit rises to a first operating temperature which is lower than its maximum operating temperature, then subsequently rises to the maximum operating temperature.

In some embodiments, the heating assembly is configured such that, in use, the first heating unit is maintained at its maximum operating temperature for a first duration, and then the temperature of the first heating unit drops from the maximum operating temperature to a second operating temperature which is lower than its maximum operating temperature, and held at the second operating temperature for a second duration.

In one embodiment, at least one heating unit present in the heating assembly comprises a coil. In this embodiment, the at least one heating unit may be an induction heating unit. The induction heating unit comprises a susceptor heating element, and the coil is configured to be an inductor for supplying a varying magnetic field to the susceptor heating element.

In one embodiment, at least one heating unit present in the heating assembly comprises a resistive heating element.

Ninth Aspect

According to a further aspect of the present invention, there is provided an aerosol-generating device comprising a heating assembly. The heating assembly includes at least a first heating unit arranged to heat, but not burn, the aerosol-generating material in use, and a controller for controlling the first heating unit. The heating assembly is operable in at least a first mode and a second mode, and the heating assembly is configured such that the first heating unit reaches a first-mode maximum operating temperature in the first mode, and a second-mode maximum operating temperature in the second mode. The first-mode maximum operating temperature is different from the second-mode operating temperature.

In some embodiments, the second-mode maximum operating temperature of the first heating unit is higher than the first-mode maximum operating temperature of the first heating unit.

In some embodiments, the heating assembly may further comprise a second heating unit arranged to heat, but not burn, the aerosol-generating material in use, the second heating unit being controllable by the controller. The second heating unit is preferably controllable independent of the first heating unit. In some embodiments, the heating assembly comprises a maximum of two heating units. Alternatively, the heating assembly may comprise three or more heating units which are independently controllably by the controller.

In these embodiments, the heating assembly may be configured such that the second heating unit reaches a first-mode maximum operating temperature in the first mode, and a second-mode maximum operating temperature in the second mode. In some embodiments, the first-mode maximum operating temperature of the second heating unit is different from the second-mode maximum operating temperature of the second heating unit. In some embodiments, the second-mode maximum operating temperature of the second heating unit is higher than the first-mode maximum operating temperature of the second heating unit.

In some embodiments, the first-mode maximum operating temperature of the first heating unit is substantially the same as the first-mode maximum operating temperature of the second heating unit.

In some embodiments, the second-mode maximum operating temperature of the first heating unit is different from the second-mode maximum operating temperature of the second heating unit. In particular embodiments, the second-mode maximum operating temperature of the first heating unit is higher than the second-mode maximum operating temperature of the second heating unit.

In some embodiments, the first-mode maximum operating temperature of the first heating unit and/or the first-mode maximum operating temperature of the second heating unit is from 240° C. to 300° C.

In some embodiments, the second-mode maximum operating temperature of the first heating unit, and/or the second-mode maximum operating temperature of the second heating unit, is from 250° C. to 300° C.

In some embodiments, the heating assembly is configured such that, in use, for each mode, the second heating unit rises to a first operating temperature which is lower than its maximum operating temperature, then subsequently rises to the maximum operating temperature.

In some embodiments, the heating assembly is configured such that, in use, for each mode, the first heating unit is maintained at its maximum operating temperature for a first duration, and then the temperature of the first heating unit drops from the maximum operating temperature to a second operating temperature which is lower than its maximum operating temperature, and held at the second operating temperature for a second duration.

In one embodiment, each heating unit present in the heating assembly is an induction heating unit comprising a susceptor heating element and an inductor for supplying a varying magnetic field to the susceptor heating element.

Tenth Aspect

In another aspect of the present invention, there is provided an aerosol-generating device comprising a heating assembly. The heating assembly includes at least a first heating unit arranged to heat, but not burn, the aerosol-generating material in use, a second heating unit arranged to heat, but not burn, the aerosol-generating material in use, and a controller for controlling the first and second heating units. The heating assembly is operable in at least a first mode and a second mode, and the heating assembly is configured such each of the first and second heating units reaches a first-mode maximum operating temperature in the first mode, and a second-mode maximum operating temperature in the second mode. The ratio between the first-mode maximum operating temperature of the first heating unit and the first-mode maximum operating temperature of the second heating unit is different from the ratio between the second-mode maximum operating temperature of the first heating unit and the second-mode maximum operating temperature of the second heating unit.

In some embodiments, the ratio between the first-mode maximum operating temperature of the first heating unit and the first-mode maximum operating temperature of the second heating unit, and/or the ratio between the second-mode maximum operating temperature of the first heating unit and the second-mode maximum operating temperature of the second heating unit, is from 1:1 to 1.2:1.

In particular embodiments, the ratio between the first-mode maximum operating temperature of the first heating unit and the first-mode maximum operating temperature of the second heating unit is approximately 1:1.

In further particular embodiments, the ratio between the second-mode maximum operating temperature of the first heating unit and the second-mode maximum operating temperature of the second heating unit is from 1.01:1 to 1.2:1.

In some embodiments, the heating assembly is configured such that, in use, for each mode, the second heating unit rises to a first operating temperature which is lower than its maximum operating temperature, then subsequently rises to the maximum operating temperature.

In particular embodiments, the ratio between the first-mode first operating temperature and the first-mode maximum operating temperature is different from the ratio between the second-mode first operating temperature and the second-mode maximum operating temperature. In one embodiment the first-mode and/or second mode first operating temperature is from 150° C. to 200° C.

The ratio between the first-mode first operating temperature and the first-mode maximum operating temperature, and/or the ratio between the second-mode first operating temperature and the second-mode maximum operating temperature, may be from 1:1.1 to 1:2. In some embodiments, the ratio between the first mode first operating temperature and the first-mode maximum operating temperature is from 1:1.1 to 1:1.6. In some embodiments, the ratio between the second-mode first operating temperature and the second-mode maximum operating temperature is from 1:1.6 to 1:2.

In some embodiments, the heating assembly is configured such that, in use, for each mode, the first heating unit is maintained at its maximum operating temperature for a first duration, and then the temperature of the first heating unit drops from the maximum operating temperature to a second operating temperature which is lower than its maximum operating temperature, and held at the second operating temperature for a second duration.

In particular embodiments, the ratio between the first-mode maximum operating temperature and the first-mode second operating temperature is different from the ratio between the second-mode maximum operating temperature and the second-mode second operating temperature. In one embodiment, first-mode and/or second mode second operating temperature is from 180° C. to 240° C. In some embodiments, the ratio between the first-mode maximum operating temperature and the first-mode second operating temperature, and/or the ratio between the second-mode maximum operating temperature and the second-mode second operating temperature, is from 1.1:1 to 1.4:1. In one embodiment, the ratio between the first mode maximum operating temperature and the first-mode second operating temperature is from 1:1 to 1.2:1. In another embodiment, the ratio between the second-mode maximum operating temperature and the second-mode second operating temperature is from 1.1:1 to 1.4:1.

In some embodiments, the first duration of the first heating unit being maintained at its maximum operating temperature is greater than the second duration of the first heating unit being maintained at the second operating temperature in each mode of operation of the heating assembly. In one embodiment, the ratio between the first duration and the second duration in each mode is from 1.1:1 to 7:1.

In one embodiment, each heating unit present in the heating assembly is an induction heating unit comprising a susceptor heating element and an inductor for supplying a varying magnetic field to the susceptor heating element.

The heating assembly comprises a maximum of two heating units. Alternatively, the heating assembly may comprise three or more heating units.

Eleventh Aspect

According to another aspect of the present invention, there is provided an aerosol-generating device for generating aerosol from an aerosol-generating material. The aerosol-generating device comprises a heating assembly including at least a first heating unit arranged to heat, but not burn, the aerosol-generating material in use, and a controller for controlling the at least first heating unit. The heating assembly is operable in at least a first mode and a second mode, and the first mode and second mode are selectable by a user interacting with user interface for selecting the first mode or second mode.

In one example, the first mode and second mode are selectable from a single user interface.

In an embodiment of this example, the first mode is selectable by activating the user interface for a first duration, and the second mode is selectable by activating the user interface for a second duration, the first duration being different from the second duration. The first duration and/or the second duration is from 1 second to 10 seconds.

Preferably the second duration is longer than the first duration. The first duration may be, for example, from 1 second to 5 seconds, preferably from 2 seconds to 4 seconds. The second duration may be, for example, from 2 seconds to 10 seconds, preferably from 4 to 6 seconds.

In another embodiment, the first mode is selectable by a first number of activations of the user interface, and the second mode is selectable by a second number of activations of the user interface, the first number of activations being differing from the second number of activations.

Preferably, the second number of activations is greater than the first number of activations. The first number of activations may be, for example, a single activation. The second number of activations may be, for example, a plurality of activations.

The user interface of the aerosol-generating device may comprise a mechanical switch, an inductive switch, a capacitive switch. In embodiments wherein the user interface comprises a mechanical switch, the switch may be selected from a biased switch, a rotary switch, a toggle switch, or a slide switch.

In one embodiment, the user interface is configured such that a user interacts with the user interface by depressing at least a portion of the user interface.

In a particular embodiment, the user interface is a slide switch, and the first mode is selectable by positioning the slide switch in a first position, and the second mode is selectable by positioning the slide switch in a second position, the first position being different from the second position. In a preferred embodiment, the slide switch forms a movable cover for selectively covering an opening of a receptacle disposed in the aerosol-generating device, the receptacle being configured to receive a smoking article.

In one embodiment, the device further comprises an actuator for activating the device, the actuator being arranged apart from the user interface. Alternatively, in a preferred embodiment, the user interface is also configured for activating the device.

Twelfth Aspect

According to a further aspect of the invention, there is provided a method of operating an aerosol-generating device according to the 0 Aspect. The method comprises receiving a signal from the user interface, identifying a selected mode of operation associated with the received signal, and instructing the at least one heating element to operate according to a predetermined heating profile based on the selected mode of operation.

Thirteenth Aspect

According to a further aspect of the invention, there is provided an aerosol-generating device for generating aerosol from an aerosol-generating material. The aerosol-generating device comprises a heating assembly including at least a first heating unit arranged to heat, but not burn, the aerosol-generating material in use, and a controller for controlling the at least first heating unit. The heating assembly is operable in at least a first mode and a second mode. The heating assembly further comprises an indicator for indicating the mode of operation of the device to a user.

The indicator may be configured to provide a visual indication of the selected mode. For example, in some embodiments, the indicator comprises a plurality of light sources, the indicator being configured to indicate the selected mode by selective activation of the light sources. The light sources may be arranged to form a shape; for example, the light sources may form the perimeter of the shape. In one embodiment, the shape may have a substantially outline. In a particularly preferred embodiment, the shape is an annulus.

The device may be configured such that the indicator indicates selection of the first mode by sequentially activating each of the light sources, the sequence comprising activating a first light source, subsequently activating a second light source adjacent to the first light source, and subsequently activating further light sources adjacent to activated light sources sequentially until all of the light sources are activated.

The device may be configured such that the indicator indicates selection of the second mode by activating a selection of the plurality of light sources, the selection changing throughout indication of selection of the second mode, but the number of activated light sources remaining constant throughout indication of selection of the second mode.

In one embodiment, the indicator comprises a display screen. However, in a preferred embodiment, the indicator does not comprise a display screen.

The indicator may be configured to provide haptic indication of the selected mode. For example, the indicator may comprise a vibration motor. The vibration motor may be an eccentric rotating mass vibration motor or a linear resonant actuator, for example.

The device may be configured such that the indicator indicates selection of the first mode by activating the vibration motor for a first duration, and selection of the second mode by activating the vibration motor for a second duration, the first duration being different from the second duration.

Preferably, the second duration is longer than the first duration.

Alternatively, or additionally, the device may be configured such that the indicator indicates selection of the first mode by activating the vibration motor for a first number of pulses, and selection of the second mode by activating the vibration for a second number of pulses, the first number of pulses being different from the second number of pulses.

Preferably, the second number of pulses is greater than the first number of pulses. The first number of pulses may be, for example, a single pulse. The second number of pulses may be, for example, a plurality of pulses.

In a preferred embodiment, the indicator is configured to provide a visual and a haptic indication of the selected mode according to any of the embodiments described hereinabove.

In a particularly preferred embodiment, the device and indicator are configured to indicate the first mode via a first sequence of activation of light sources and a single activation of a vibration motor, and the second mode via a second sequence of activation of light sources different from the first sequence and a double activation of the vibration motor.

The indicator may be configured to provide audible indication of the selected mode.

In these embodiments, the device may be configured such that the indicator indicates the selected mode to a user throughout a session of use. Preferably, though, the device is configured such that the indicator indicates the selected mode for a portion of the session of use. In particular, the device may be configured such that the indicator indicates the selected mode only before the device is ready for use. For example, from the point at which the mode of operation is selected until the device is ready for use.

In some embodiments, the device is further configured such that the indicator indicates to the user when the aerosol-generating device is ready for use.

In some embodiments, the device is further configured such that the indicator indicates to the user when a session of use is nearly over.

In some embodiments, the device is further configured such that the indicator indicates to the user when the session of use has ended.

Features described herein in relation to one aspect of the invention are explicitly disclosed in combination with the other aspects, to the extent that they are compatible. For example, in one embodiment, the user interface is arranged within the indicator. In another embodiment, the indicator is arranged apart from the user interface.

Fourteenth Aspect

According to a further aspect of the present invention, there is provided an aerosol-generating device for generating aerosol from an aerosol-generating material, the aerosol-generating device comprising a heating assembly including a controller and at least a first heating unit arranged to heat, but not burn, the aerosol-generating material in use. The heating assembly is operable in at least a first mode and a second mode, and configured such that the first mode and second mode are selectable by a user before a session of use and/or during a first portion of a session of use, and the selected mode cannot be changed by the user during a second portion of the session of use. In a preferred embodiment, the modes are selectable before the session of use and during the first portion of the session.

A session of use starts when power is first supplied to a heating unit in the heating assembly. Preferably, the first portion of the session of use begins at the start of the session of use.

The aerosol-generating device may further comprise an actuator. The actuator may be configured to activate the device. The modes may be selectable by a user after activation of the device and before a session of use, and optionally during a first portion of the session of use.

In some embodiments, the first portion of the session of use ends at or before the point at which the first heating unit reaches an operating temperature. The second portion may begin at or after the point at which the first heating unit reaches an operating temperature.

In some embodiments, the first portion of the session of use ends at or before the point at which the first heating unit reaches a maximum operating temperature. The second portion may begin at or after the point at which the first heating unit reaches a maximum operating temperature.

In some embodiments, the first portion of the session of use ends at or before the point at which the device can provide an acceptable first puff to a user. The second portion may begin at or after the point at which the device can provide an acceptable first puff to a user.

In some embodiments, the first portion of the session of use ends between 5 and 20 seconds after the beginning of the session of use.

In some embodiments, the second portion of the session of use ends with the end of the session of use.

As above, features described herein in relation to one aspect of the invention are explicitly disclosed in combination with the other aspects, to the extent that they are compatible. For example, in one embodiment, the first portion of the session of use ends when a user terminates interaction with the user interface. For example, when the user interface is configured such that the user interacts with the user interface by depressing a portion of the user interface, the first portion of the session of use may end when the user terminates depression of the user interface.

Fifteenth Aspect

According to a further aspect of the present invention, there is provided an aerosol-generating device for generating aerosol from an aerosol-generating material, the aerosol-generating device comprising a heating assembly including a first heating unit arranged to heat, but not burn, the aerosol-generating material in use, and a controller for controlling the first heating unit. The heating assembly is configured such that the first heating unit has an average temperature of from 180° C. to 280° C. over an entire session of use. The average temperature is calculated from temperature measurements taken at the first heating unit with a frequency of at least 1 Hz across the entire session of use.

In one embodiment, the heating assembly is operable in a plurality of modes, the plurality comprising at least a first mode and a second mode, wherein the heating assembly is configured such that the average temperature of the first heating unit in the first mode is different from the average temperature of the first heating unit in the second mode. The heating assembly may be configured such that the average temperature of the first heating unit in the second mode is higher than the average temperature of the first second heating unit in the first mode.

In one embodiment, the heating assembly includes a plurality of heating units, the plurality comprising the first heating unit and at least a second heating unit arranged to heat, but not burn, the aerosol-generating material in use. The heating assembly may comprise more than two heating units. Alternatively, the heating assembly may comprise a maximum of two heating units.

In this embodiment, the heating assembly may be configured such that the second heating unit has an average temperature of from 180 to 280° C. over an entire session. The average temperature of the second heating unit over the entire session of use may be different from the average temperature of the first heating unit over the entire session of use. For example, the average temperature of the second heating unit over the entire session of use may be higher than the average temperature of the first heating unit over the entire session of use.

In this embodiment, the heating assembly may be operable in a plurality of modes, the plurality comprising at least a first mode and a second mode, wherein the heating assembly is configured such that the average temperature of the first and/or second heating unit in the first mode is different from the average temperature of the first and/or second heating unit in the second mode respectively. The heating assembly may be configured such that the average temperature of each heating unit present in the heating assembly in the first mode is different from that in the second mode. For example, the heating assembly may be configured such that the average temperature of the first and/or second heating unit in the second mode is higher than in the first mode. In a particular embodiment, the heating assembly is configured such that the average temperature of each heating unit present in the heating assembly in the second mode is higher than in the first mode.

In some embodiments, the average temperature of the first and/or second heating unit in the second mode is from approximately 1 to 100° C. higher than in the first mode.

In some embodiments, the average temperature of the first heating unit in the first and/or second mode is from approximately 180° C. to 280° C.

In some embodiments, the average temperature of the second heating unit in the first and/or second mode is from approximately 140° C. to 240° C.

In particular embodiments, each heating unit present in the heating assembly is an induction heating unit.

In some embodiments, the aerosol-generating device is a tobacco heating product.

Sixteenth Aspect

According to a further aspect of the present invention there is provided a method of generating an inhalable aerosol with an aerosol-generating device according to the 0 Aspect. The method comprises instructing the first heating unit of the heating assembly to heat an aerosol-generating material over a session of use, the first heating unit having an average temperature of from 180° C. to 280° C. over the session of use.

Seventeenth Aspect

According to a further aspect of the present invention, there is provided an aerosol-generating device for generating an inhalable aerosol from aerosol-generating material. The aerosol-generating device includes a heating assembly comprising a first induction heating unit arranged to heat, but not burn, the aerosol-generating material in use, aa second induction heating unit arranged to heat, but not burn, the aerosol-generating material in use and a controller for controlling the first and second induction heating units. The heating assembly is configured such that during one or more portions of a session of use of the aerosol-generating device, the first induction heating unit operates at a substantially constant first temperature and the second induction heating temperature operates at a substantially constant second temperature. Preferably, the first temperature is different from the second temperature.

Preferably, at least one of the one or more portions has a duration of at least 10 seconds. In a particularly preferred embodiment, at least one of the one or more portions has a duration of 60 seconds.

In one embodiment, the difference between the first and second temperatures is at least 25° C.

In one embodiment, the one or more portions comprises a first portion during which the first temperature is higher than the second temperature, the first portion beginning within the first half of the session of use. The first portion begins within the first 60 seconds of the session of use, and/or end after 60 seconds or more from the beginning of the session of use. In this embodiment, the first temperature during the first portion may be from 240° C. to 300° C., and/or the second temperature during the first portion may be from 100 to 200° C.

In one embodiment, the one or more portions further comprises a second portion during which the second temperature is higher than the first temperature, the second portion beginning after not less than 60 seconds from the beginning of the session of use. The second portion may end within 60 seconds of the end of the session of use; preferably, the second portion ends substantially simultaneously with the end of the session of use. In this embodiment, the first temperature during the second portion may be from 140° C. to 250° C., and/or the second temperature during the second portion may be from 240° C. to 300° C.

The device may have a mouth end and a distal end, and the first and second heating units may be arranged in the heating assembly along an axis extending from the mouth end to the distal end, the first induction unit being arranged closer to the mouth end than the second induction heating unit.

In this embodiment, the first and second heating units may each have an extent along the axis, the extent of the second heating unit being greater than the first heating unit.

In a particular embodiment, the controller is configured to selectively activate the first induction heating unit and the second induction heating unit such that only one of the first induction heating unit and the second induction heating unit is active at any one time during the one or more portions of the session of use.

Eighteenth Aspect

According to a further aspect of the present invention there is provided a method of providing an aerosol using an aerosol-generating device according to the 0 Aspect. The method comprises controlling the first induction heating unit to have the first temperature and the second induction heating unit to have the second temperature during the one or more portions. The controlling comprises selectively activating the first induction heating unit and the second induction heating unit such that only one of the first induction heating unit and the second induction heating unit is active at any one time during the one or more portions. The method may further comprise detecting a characteristic of at least one of the induction heating units, and selectively activating the induction heating unit based on the detected characteristic. The detected characteristic may be indicative of the temperature of the heating unit.

Nineteenth Aspect

According to a further aspect of the present invention, there is provided an aerosol-generating device for generating aerosol from an aerosol-generating material. The aerosol-generating device comprises a heating assembly including a first heating unit arranged to heat, but not burn, the aerosol-generating material in use, and a controller for controlling the first heating unit. The heating assembly is configured such that the controller specifies a programmed temperature profile for the first heating unit over a session of use, and the first heating unit has an observed temperature profile over a session of use. The mean absolute error of the observed temperature profile from the programmed temperature profile over the session of use is less than 20° C., preferably less than 15° C., more preferably less than 10° C., most preferably less than 5° C. The mean absolute error is calculated from temperature measurements taken at the first heating unit at a frequency of at least 1 Hz during the session of use, and the programmed temperatures at corresponding timepoints of the programmed temperature profile.

In some embodiments, the heating assembly further comprises a second heating unit, the heating assembly being configured such that the controller specifies a programmed temperature profile for the second heating unit over a session of use, and the second heating unit has an observed temperature profile over a session of use. The programmed temperature profile for the second heating unit may be different from the programmed temperature profile for the second heating unit.

The heating assembly may be configured such that the second heating unit has a mean absolute error of the observed temperature profile from the programmed temperature profile over the session of use which is less than 50° C.

In some embodiments, the heating assembly is configured such that the first and second heating units taken together have a mean absolute error of the observed temperature profiles from the programmed temperature profiles over the session of use which is less than 40° C.

The heating assembly may be configured to have a mean absolute error of less than 40° C.

In some embodiments, the heating assembly may be configured such that the first heating unit has a first average temperature over a session of use and the second heating unit has a second average temperature over a session of use, the first average temperature being different from the second average temperature.

In some embodiments, the mean absolute error of the first heating unit is less than the mean absolute error of the second heating unit.

The heating assembly may be operable in a plurality of modes, the plurality comprising at least a first mode and a second mode. In these embodiments, the heating assembly may be configured such that the mean absolute error of the first heating unit in the first mode is substantially the same as the mean absolute error of the first heating unit in the second mode, or differs by less than 5° C.

The aerosol-generating device may comprise a temperature sensor arranged at each heating unit in the heating assembly. In one embodiment the controller is configured to control the temperature of each heating unit in the heating assembly by a control feedback mechanism based on temperature data supplied from the temperature sensor arranged at each heating unit.

Each heating unit may comprise a coil. In a preferred embodiment, each heating unit present in the heating assembly is an induction heating unit comprising a susceptor heating element, wherein the coil is configured to be an inductor element for supplying a variable magnetic field to the heating element.

In some embodiments, the heating assembly is configured such that the first heating unit has a maximum operating temperature of from 200° C. to 300° C.

Twentieth Aspect

According to a further aspect of the present invention there is provided an aerosol-generating system comprising an aerosol-generating device according to the 0, 0, 0, 0, 0, 0, 0, 0, 0, 0, 0, 0, 0, 0, or 0 Aspect, in combination with an aerosol-generating article.

Twenty-First Aspect

According to another aspect of the invention there is provided a method of generating aerosol from an aerosol-generating material using an aerosol-generating device according to 0, 0, 0, 0, 0, 0, 0, 0, 0, 0, 0, 0, 0, 0, or 0 Aspect.

Features described herein in relation to one aspect of the invention are explicitly disclosed in combination with the other aspects, to the extent that they are compatible. For example, features described in relation to an aerosol-generating device are explicitly disclosed in the context of a method of using said aerosol-generating device. Similarly, features described in relation to one method are explicitly disclosed in the context of other methods, to extent that they are combinable.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A is a schematic diagram of an exemplary heating assembly of an aerosol-generating device according to aspects of the present invention; FIG. 1B is a cross-section of the heating assembly shown in FIG. 1A with an aerosol-generating article disposed therein.

FIG. 2 shows a front view of an example of an aerosol generating device according to aspects of the present invention, including at least the 0 Aspect.

FIG. 3 shows a front view of the aerosol generating device of FIG. 2 with an outer cover removed.

FIG. 4 shows a cross-sectional view of the aerosol generating device of FIG. 2.

FIG. 5 shows an exploded view of the aerosol generating device of FIG. 2.

FIG. 6A shows a cross-sectional view of an exemplary heating assembly within an aerosol generating device according to aspects of the present invention.

FIG. 6B shows a close-up view of a portion of the heating assembly of FIG. 6A.

FIG. 7A is a schematic cross-section of an exemplary aerosol-generating article for use with an aerosol-generating device according to aspects of the present invention; FIG. 7B is a perspective view of the aerosol-generating article.

FIG. 8 is a graph showing a general temperature profile of a first heating unit in an aerosol-generating device according to aspects of the present invention during an exemplary session of use.

FIG. 9 is a graph showing a general temperature profile of a second heating unit in an aerosol-generating device according to aspects of the present invention during an exemplary session of use.

FIG. 10 is a graph showing programmed heating profiles of first and second induction heating elements in an example according to aspects of the present invention during a session of use, wherein the device was operated in a first mode. The programmed heating profiles shown correspond to programmed heating profiles 1 and 2 respectively of Table 3.

FIG. 11 is a graph showing the measured temperature profiles of the first and second induction elements during the session of use shown in FIG. 10.

FIG. 12 is a graph showing the first 10 seconds of the programmed heating profiles shown in FIG. 10.

FIG. 13 is a graph showing the first 10 seconds of the measured temperature profiles shown in FIG. 11.

FIG. 14 is a graph showing programmed heating profiles of first and second induction heating elements in an example according to aspects of the present invention during a session of use, wherein the device was operated in a second mode. The programmed heating profiles shown correspond to programmed heating profiles 3 and 4 respectively of Table 3 respectively.

FIG. 15 is a graph showing the measured temperature profiles of the first and second induction elements during the session of use shown in FIG. 14.

FIG. 16 is a graph showing the first 10 seconds of the programmed heating profiles shown in FIG. 14.

FIG. 17 is a graph showing the first 10 seconds of the measured temperature profiles shown in FIG. 15.

FIG. 18 is a graph showing programmed heating profiles of first and second induction heating elements in an example according to aspects of the present invention during a session of use, wherein the device was operated in a first mode different from that shown in FIG. 10. The programmed heating profiles shown correspond to programmed heating profiles 5 and 6 respectively of Table 3.

FIG. 19 is a graph showing programmed heating profiles of first and second induction heating elements in an example according to aspects of the present invention during a session of use, wherein the device was operated in a second mode different from that shown in FIG. 14. The programmed heating profiles shown correspond to programmed heating profiles 7 and 8 respectively of Table 3.

FIG. 20 is a graph showing a general programmed heating profile of a heating element in an aerosol-generating device according to an example of aspects according to the present invention during an exemplary session of use.

FIG. 21 is a graph showing programmed heating profiles of first and second induction heating elements in an example of aspects according to the present invention, the profiles corresponding to profiles 9 and 10 respectively of Table 3.

FIG. 22 is a graph showing programmed heating profiles of first and second induction heating elements in an example of aspects according to the present invention, the profiles corresponding to profiles 11 and 12 respectively of Table 3.

FIG. 23 is a graph showing programmed heating profiles of first and second induction heating elements in an example of aspects according to the present invention, the profiles corresponding to profiles 13 and 14 respectively of Table 3.

FIG. 24 is a graph showing programmed heating profiles of first and second induction heating elements in an example of aspects according to the present invention, the profiles corresponding to profiles 15 and 16 respectively of Table 3.

FIG. 25 is a graph showing programmed heating profiles of first and second induction heating elements in an example of aspects according to the present invention, the profiles corresponding to profiles 17 and 18 respectively of Table 3.

FIG. 26 is a graph showing programmed heating profiles of first and second induction heating elements in an example of aspects according to the present invention, the profiles corresponding to profiles 19 and 20 respectively of Table 3.

FIG. 27 is a graph showing programmed heating profiles of first and second induction heating elements in an example of aspects according to the present invention, the profiles corresponding to profiles 21 and 22 respectively of Table 3.

FIG. 28 is a graph showing programmed heating profiles of first and second induction heating elements in an example of aspects according to the present invention, the profiles corresponding to profiles 23 and 24 respectively of Table 3.

FIG. 29 is a graph showing programmed heating profiles of first and second induction heating elements in an example of aspects according to the present invention, the profiles corresponding to profiles 25 and 26 respectively of Table 3.

FIG. 30 is a graph showing programmed heating profiles of first and second induction heating elements in an example of aspects according to the present invention, the profiles corresponding to profiles 27 and 28 respectively of Table 3.

FIG. 31 is a graph showing programmed heating profiles of first and second induction heating elements in an example of aspects according to the present invention, the profiles corresponding to profiles 29 and 30 respectively of Table 3.

FIG. 32 is a graph showing programmed heating profiles of first and second induction heating elements in an example of aspects according to the present invention, the profiles corresponding to profiles 31 and 32 respectively of Table 3.

FIG. 33 is a graph showing programmed heating profiles of first and second induction heating elements in an example of aspects according to the present invention, the profiles corresponding to profiles 33 and 34 respectively of Table 3.

FIG. 34 is a graph showing programmed heating profiles of first and second induction heating elements in an example of aspects according to the present invention, the profiles corresponding to profiles 35 and 36 respectively of Table 3.

FIG. 35 is a graph showing programmed heating profiles of first and second induction heating elements in an example of aspects according to the present invention, the profiles corresponding to profiles 37 and 38 respectively of Table 3.

FIG. 36 is a graph showing programmed heating profiles of first and second induction heating elements in an example of aspects according to the present invention, the profiles corresponding to profiles 39 and 40 respectively of Table 3.

FIG. 37 is a graph showing programmed heating profiles of first and second induction heating elements in an example of aspects according to the present invention, the profiles corresponding to profiles 41 and 42 respectively Table 3.

FIG. 38 is a graph showing programmed heating profiles of first and second induction heating elements in an example of aspects according to the present invention, the profiles corresponding to profiles 43 and 44 respectively of Table 3.

FIG. 39 is a graph showing programmed heating profiles of first and second induction heating elements in an example of aspects according to the present invention, the profiles corresponding to profiles 45 and 46 respectively of Table 3.

FIG. 40 is a graph showing programmed heating profiles of first and second induction heating elements in an example of aspects according to the present invention, the profiles corresponding to profiles 47 and 48 respectively of Table 3.

FIG. 41 is a graph showing programmed heating profiles of first and second induction heating elements in an example of aspects according to the present invention, the profiles corresponding to profiles 49 and 50 respectively of Table 3.

FIG. 42 is a graph showing programmed heating profiles of first and second induction heating elements in an example of aspects according to the present invention, the profiles corresponding to profiles 51 and 52 respectively of Table 3.

FIG. 43 is a graph showing programmed heating profiles of first and second induction heating elements in an example of aspects according to the present invention, the profiles corresponding to profiles 53 and 54 respectively of Table 3.

FIG. 44 shows an example of an aerosol-generating device according to aspects of the present invention, including at least the 0, 0 and 0 Aspects.

FIGS. 45A to 45G show an exemplary user interface and indicator during selection and indication of a first mode of operation of the device shown in FIG. 44.

FIGS. 46A to 46G show the exemplary user interface and indicator during selection and indication of a second mode of operation of the device shown in FIG. 44.

FIGS. 47A and 47B show an example of an alternative user interface of an aerosol-generating device according to aspects of the present invention, including at least the 0, 0 and 0 Aspects.

FIGS. 48A to 48E show an example of a further alternative user interface of an aerosol-generating device according to aspects of the present invention, including at least the 0, 0 and 0 Aspects, during indication of the first mode of operation of the device.

### DETAILED DESCRIPTION OF THE DRAWINGS

As used herein, “the” may be used to mean “the” or “the or each” as appropriate. In particular, features described in relation to “the at least one heating unit” may be applicable to the first, second or further heating units where present. Further, features described in respect of a “first” or “second” integers may be equally applicable integers. For example, features described in respect of a “first” or “second” heating unit may be equally applicable to the other heating units in different embodiments. Similarly, features described in respect of a “first” or “second” mode of operation may be equally applicable to other configured modes of operation.

In general, reference to a “first” heating unit in the heating assembly does not indicate that the heating assembly contains more than one heating unit, unless otherwise specified; rather, the heating assembly comprising a “first” heating unit must simply comprise at least one heating unit. Accordingly, a heating assembly containing only one heating unit expressly falls within the definition of a heating assembly comprising a “first” heating unit.

Similarly, reference to a “first” and “second” heating unit in the heating assembly does not necessarily indicate that the heating assembly contains two heating units only; further heating units may be present. Rather, in this example, the heating assembly must simply comprise at least a first and a second heating unit.

Similarly, reference to a “first” and “second” portion of a session of use does not necessarily indicate that the session of use contains only two distinct portions.

Similarly, reference to a “first” and “second” mode of operation does not necessarily indicate that the heating assembly is configured to operate in two modes only; the assembly may be configured to operate in further modes, such as a third, fourth or fifth mode.

Where reference is made to an event such as reaching a maximum operating temperature occurring “within” a given period, the event may occur at any time between the beginning and the end of the period.

As used herein, the term “aerosol-generating material” includes materials that provide volatilized components upon heating, typically in the form of an aerosol. Aerosol-generating material includes any tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”. In a preferred embodiment, the aerosol-generating material is a non-liquid aerosol-generating material. In a particularly preferred embodiment, the non-liquid aerosol-generating material comprises tobacco.

Apparatuses are known that heat aerosol-generating material to volatilize at least one component of the aerosol-generating material, typically to form an aerosol which can be inhaled, without burning or combusting the aerosol-generating material. Such apparatus is sometimes described as an “aerosol-generating device,” an “aerosol provision device,” a “heat-not-burn device,” a “tobacco heating product,” a “tobacco heating product device,” a “tobacco heating device,” or similar. In a preferred embodiment of the present invention, the aerosol-generating device of the present invention is a tobacco heating product. The non-liquid aerosol-generating material for use with a tobacco heating product comprises tobacco.

Similarly, there are also so-called e-cigarette devices, which are typically aerosol-generating devices which vaporize an aerosol-generating material in the form of a liquid, which may or may not contain nicotine. The aerosol-generating material may be in the form of or be provided as part of a rod, cartridge or cassette or the like which can be inserted into the apparatus. A heater for heating and volatilizing the aerosol-generating material may be provided as a “permanent” part of the apparatus.

An aerosol-generating device according to aspects of the present invention can receive an article comprising aerosol-generating material for heating, also referred to as a “smoking article”. An “article”, “aerosol-generating article” or “smoking article” in this context is a component that includes or contains in use the aerosol-generating material, which is heated to volatilize the aerosol-generating material, and optionally other components in use. A user may insert the article into the aerosol-generating device before it is heated to produce an aerosol, which the user subsequently inhales. The article may be, for example, of a predetermined or specific size that is configured to be placed within a heating chamber of the device which is sized to receive the article.

The aerosol-generating device of the present invention comprises a heating assembly. The heating assembly comprises at least one heating unit arranged to heat, but not burn, the aerosol-generating material in use. According to some aspects, the heating assembly comprises a plurality of heating units, each heating unit being arranged to heat, but not burn, the aerosol-generating material in use.

A heating unit typically refers to a component which is arranged to receive electrical energy from an electrical energy source, and to supply thermal energy to an aerosol-generating material. A heating unit comprises a heating element. A heating element is typically a material which is arranged to supply heat to an aerosol-generating material in use. The heating unit comprising the heating element may comprise any other component required, such as a component for transducing the electrical energy received by the heating unit. In other examples, the heating element itself may be configured to transduce electrical energy to thermal energy.

The heating unit may comprise a coil. In some examples, the coil is configured to, in use, cause heating of at least one electrically-conductive heating element, so that heat energy is conductible from the at least one electrically-conductive heating element to aerosol generating material to thereby cause heating of the aerosol generating material.

In some examples, the coil is configured to generate, in use, a varying magnetic field for penetrating at least one heating element, to thereby cause induction heating and/or magnetic hysteresis heating of the at least one heating element. In such an arrangement, the or each heating element may be termed a “susceptor”. A coil that is configured to generate, in use, a varying magnetic field for penetrating at least one electrically-conductive heating element, to thereby cause induction heating of the at least one electrically-conductive heating element, may be termed an “induction coil”, “inductive element”, or “inductor coil”.

The device may include the heating element(s), for example electrically-conductive heating element(s), and the heating element(s) may be suitably located or locatable relative to the coil to enable such heating of the heating element(s). The heating element(s) may be in a fixed position relative to the coil. Alternatively, the at least one heating element, for example at least one electrically-conductive heating element, may be included in an article for insertion into a heating zone of the device, wherein the article also comprises the aerosol generating material and is removable from the heating zone after use. Alternatively, both the device and such an article may comprise at least one respective heating element, for example at least one electrically-conductive heating element, and the coil may be to cause heating of the heating element(s) of each of the device and the article when the article is in the heating zone.

In some examples, the coil is helical. In some examples, the coil encircles at least a part of a heating zone of the device that is configured to receive aerosol generating material. In some examples, the coil is a helical coil that encircles at least a part of the heating zone.

In some examples, the device comprises an electrically-conductive heating element that at least partially surrounds the heating zone, and the coil is a helical coil that encircles at least a part of the electrically-conductive heating element. In some examples, the electrically-conductive heating element is tubular. In some examples, the coil is an inductor coil.

In some examples, the heating unit is an induction heating unit. Surprisingly, it has been found by the inventors that induction heating units in an aerosol-generating device according to aspects of the present invention reach a maximum operating temperature much more rapidly than corresponding resistive heating elements. In a preferred embodiment, the heating assembly is configured such that the first induction heating unit reaches its maximum operating temperature at a rate of at least 100° C. per second. In a particularly preferred embodiment, the heating assembly is configured such that the first induction heating unit reaches the maximum operating temperature at a rate of at least 150° C. per second.

Induction heating systems may also be advantageous because the varying magnetic field magnitude can be easily controlled by controlling power supplied to the heating unit. Moreover, as induction heating does not require a physical connection to be provided between the source of the varying magnetic field and the heat source, design freedom and control over the heating profile may be greater, and cost may be lower.

An induction heating unit comprises an inductor element and a heating element. In the context of an induction heating unit, the heating element may also be referred to as a susceptor, or zone of a susceptor. The inductor receives electrical energy, usually in the form of an alternative electrical current, and supplies a varying magnetic field to the susceptor. The susceptor supplies thermal energy to the aerosol-generating material.

In some examples, the heating unit is a resistive heating unit. A resistive heating unit may consist of a resistive heating element. That is, it may be unnecessary for a resistive heating unit to include a separate component for transducing the electrical energy received by the heating unit, because a resistive heating element itself transduces electrical energy to thermal energy.

Using electrical resistance heating systems may be advantageous because the rate of heat generation is easier to control, and lower levels of heat are easier to generate, compared with using combustion for heat generation. The use of electrical heating systems therefore allows greater control over the generation of an aerosol from a tobacco composition.

Reference is made to the temperature of heating elements (or susceptor zones, where induction heating systems are employed) throughout the present specification. The temperature of a heating element may also be conveniently referred to as the temperature of the heating unit which comprises the heating element. This does not necessarily mean that the entire heating unit is at the given temperature. For example, where reference is made to the temperature of an induction heating unit, it does not necessarily mean that the both the inductive element and the susceptor have such a temperature. Rather, in this example, the temperature of the induction heating unit corresponds to the temperature of the heating element composed in the induction heating unit. For the avoidance of doubt, the temperature of a heating element and the temperature of a heating unit can be used interchangeably.

Similarly, reference may be made to “activating” an inductor element, which typically consists of supplying power to the inductor element. Conveniently, this may also be referred to as activating an induction heating unit which comprises the inductor element and heating element.

As used herein, “temperature profile” refers to the variation of temperature of a material over time. For example, the varying temperature of a heating element measured at the heating element for the duration of a session of use (also referred to as a ‘smoking session’) may be referred to as the temperature profile of that heating element (or equally as the temperature profile of the heating unit comprising that heating element). The heating elements provide heat to the aerosol-generating material during use, to generate an aerosol. The temperature profile of the heating element therefore induces the temperature profile of aerosol-generating material disposed near the heating element. Put another way, for examples employing an induction heating unit, the temperature of the aerosol-generating material is dependent on the susceptor temperature. Thus, in examples where each heating unit has a different temperature, the portions of aerosol-generating material associated with each heating unit will generally also have different temperatures.

As used herein, “puff” refers to a single inhalation by the user of the aerosol generated by the aerosol-generating device.

In use, the device of the present invention heats an aerosol-generating material to provide an inhalable aerosol. The device may be referred to as “ready for use” when at least a portion of the aerosol-generating material has reached a lowest operating temperature and a user can take a puff which contains a satisfactory amount of aerosol. In some embodiments the device may be ready for use within approximately 20 seconds of supplying power to the first heating unit, or 15 seconds, or 10 seconds, e.g. within 30 seconds of activation of the device, or 25 seconds, or 20 seconds, or 15 seconds, or 10 seconds. Preferably, the device is ready for use within approximately 20 seconds of activation of the device, or 15 seconds, or 10 seconds. The device may begin supplying power to a heating unit such as the first heating unit when the device is activated, or it may begin supplying power to the heating unit after the device is activated. Preferably, the device is configured such that power starts being supplied to the first heating unit some time after activation of the device, such as at least 1 second, 2 seconds or 3 seconds after activation of the device. Preferably, the device is configured such that power is not supplied to the first heating unit, or any heating unit present in the heating assembly until at least 2.5 seconds after activation of the device. This may advantageously prolong battery life by avoiding unintentional activation of the heating unit(s). In examples, the lowest operating temperature is greater than 150° C.

The aerosol-generating device according to aspects of the present invention may be ready for use more quickly than corresponding aerosol-generating devices known in the art, providing an improved user experience. Generally, the point at which the device is ready for use will be some time after the first heating unit has reached its maximum operating temperature, as it will take some amount of time to transfer sufficient thermal energy from the heating unit to the aerosol-generating material in order to generate the aerosol. Preferably, the device is ready for use within 20 seconds of the first heating unit reaching its maximum operating temperature, or 15 seconds, or 10 seconds.

Further, surprisingly it has been found that characteristics of the aerosol generated from the aerosol-generating material may depend on the rate at which the aerosol-generating material is heated. For example, the aerosol generated from an aerosol-generating material which is subject to heating from a heating unit which is configured to change temperature quickly may provide an improved user experience. In one embodiment wherein the aerosol-generating material comprises menthol, it has been found that rapidly increasing the temperature of the heating unit may increase the rate at which menthol is delivered to a user in the aerosol, and thereby reduce the amount of menthol component that is wasted (i.e. does not form part of the aerosol inhaled by a user) from static heating.

In some embodiments, the user's sensorial experience arising from the aerosol generated by the present device is like that of smoking a combustible cigarette, such as a factory-made cigarette.

In examples, the device indicates that it is ready for use via an indicator. In a preferred embodiment, the device is such that the indicator indicates that the device is ready for use within approximately 20 seconds of power being supplied to the first heating unit, or 15 seconds, or 10 seconds. In a particularly preferred embodiment, the device is configured such that the indicator indicates that the device is ready for use within approximately 20 seconds of activation of the device, or 15 seconds, or 10 seconds. In another preferred embodiment, the device is configured such that the indicator indicates that the device is ready for use within approximately 20 seconds of the first heating unit reaching its maximum operating temperature, or 15 seconds, or 10 seconds.

The “programmed temperature” of a heating unit refers to the temperature at which the heating unit is instructed to operate by the controller at any given time during the session of use. The “observed temperature” of a heating unit refers to the measured temperature at the heating unit at any given time during the session of use. The programmed temperature may be compared against the observed temperature of the heating at the same time point in the session of use. As described herein, the programmed temperature and observed temperature of a heating unit at any point in the session of use may differ somewhat. Aspects of the present invention reduce the difference between the programmed temperature and the observed temperature.

According to examples, the heating assembly also comprises a controller for controlling each heating unit present in the heating assembly. The controller may be a PCB. The controller is configured to control the power supplied to each heating unit, and controls the “programmed heating profile” of each heating unit present in the heating assembly. For example, the controller may be programmed to control the current supplied to a plurality of inductors to control the resulting temperature profiles of the corresponding induction heating elements. As between the temperature profile of heating elements and aerosol-generating material described above, the programmed heating profile of a heating element may not exactly correspond to the observed temperature profile of a heating element, for the same reasons given above.

In examples, the heating assembly is operable in at least a first mode and a second mode. The heating assembly may be operable in a maximum of two modes, or may be operable in more than two modes, such as three modes, four modes, or five modes.

In examples, the heating assembly is configured to operate in a plurality of modes. Examples of aerosol-generating devices according to aspects of the present invention may at least partially be configured to operate in this manner by the controller of the heating assembly being programmed to operate the device in the plurality of modes. Accordingly, references herein to the configuration of the device of the present invention or components thereof may refer to the controller of the heating assembly being programmed to operate the device as disclosed herein, amongst other features (such as spatial arrangement of the components of the heating assembly).

Each mode may be associated with a predetermined heating profile for each heating unit in the heating assembly, such as a programmed heating profile. For example, the heating assembly may be arranged such that the controller receives a signal identifying a selected mode of operation, and instructs the or each heating element present in the heating assembly to operate according to a predetermined heating profile. The controller selects which predetermined heating profile to instruct the or each heating unit based on the signal received.

One or more of the programmed heating profiles may be programmed by a user. Alternatively, or additionally, one or more of the programmed heating profiles may be programmed by the manufacturer. In these examples, the one or more programmed heating profiles may be fixed such that an end-user cannot alter the one or more programmed heating profiles.

“Session of use” as used herein refers to a single period of use of the aerosol-generating device by a user. The session of use begins at the point at which power is first supplied to at least one heating unit present in the heating assembly. The device will be ready for use after a period of time has elapsed from the start of the session of use. The session of use may also be referred to as the “total session of use”. The session of use ends at the point at which no power is supplied to any of the heating units in the aerosol-generating device. The end of the session of use may coincide with the point at which the aerosol-generating article is depleted (the point at which the total particulate matter yield (mg) in each puff would be deemed unacceptably low by a user).

The device will be ready for use after a period of time has elapsed from the start of the session of use. The device may include an indicator for indicating when the user should begin inhaling aerosol from the device. “Inhalation session” as used herein refers to the period which begins at the point at which the device is ready for use and/or the point at which the indicator indicates to the user that the device is ready for use, and ends at the end of the session of use. The inhalation session will inherently have a duration shorter than the total session of use. “Indicated inhalation session” refers to an inhalation session wherein the starting point is defined as the point at which an indicator indicates to the user that the device is ready for use. “Operating temperature inhalation session” refers to an inhalation session wherein the starting point is defined as the point at which at least a portion of the aerosol-generating material has reached a lowest operating temperature and a user can take a puff which contains a satisfactory amount of aerosol. The indicated inhalation session may or may not be the same as the operating temperature inhalation session. For the avoidance of doubt, the general term “inhalation session” includes both of these session definitions. References to the inhalation session herein can be taken to refer to either the indicated inhalation session or the operating temperature inhalation session, unless otherwise indicated.

The session of use/inhalation session will have a duration of a plurality of puffs. Said session may have a duration less than 7 minutes, or 6 minutes, or 5 minutes, or 4 minutes and 30 seconds, or 4 minutes, or 3 minutes and 30 seconds. In some embodiments, the session of use may have a duration of from 2 to 5 minutes, or from 3 to 4.5 minutes, or 3.5 to 4.5 minutes, or suitably 4 minutes. A session may be initiated by the user actuating a button or switch on the device, causing at least one heating unit to begin rising in temperature when activated or some time after activation.

In some examples, the total session of use may have a duration less than 7 minutes, or 6 minutes, or 5 minutes, or 4 minutes and 30 seconds, or 4 minutes, or 3 minutes and 30 seconds. In some embodiments, the session of use may have a duration of from 2 to 5 minutes, or from 3 to 4.5 minutes, or 3.5 to 4.5 minutes, or suitably 4 minutes. A session may end at after a predetermined duration, such as a programmed duration in a controller. A session is also considered to end if a user deactivates the device, such as before the programmed end of the session of use (deactivation of the device will terminate power being supplied to any of the heating elements in the aerosol-generating device).

In some examples, the inhalation session may have a duration less than 7 minutes, or 6 minutes, or 5 minutes, or 4 minutes and 30 seconds, or 4 minutes, or 3 minutes and 30 seconds. In some embodiments, the session of use may have a duration of from 2 to 5 minutes, or from 3 to 4.5 minutes, or 3.5 to 4.5 minutes, or suitably 4 minutes.

“Operating temperature” as used herein in relation to a heating element or a heating unit refers to any heating element temperature at which the element can heat an aerosol-generating material to produce sufficient aerosol for a satisfactory puff without burning the aerosol-generating material. The maximum operating temperature of a heating element is the highest temperature reached by the element during a smoking session. The lowest operating temperature of the heating element refers to the lowest heating element temperature at which sufficient aerosol can be generated from the aerosol-generating material by the heating element for a satisfactory puff. Where there is a plurality of heating elements present in the aerosol-generating device, each heating element has an associated maximum operating temperature. The maximum operating temperature of each heating element may be the same, or it may differ for each heating element.

In examples, the heating assembly is configured such that the first heating unit reaches a maximum operating temperature of from 200° C. to 340° C. in use.

In some embodiments, the maximum operating temperature is from approximately 200° C. to 300° C., or 210° C. to 290° C., preferably from 220° C. to 280° C., more preferably 230° C. to 270° C.

In some embodiments, the maximum operating temperature is from approximately 245° C. to 340° C., or 245° C. to 300° C., preferably from 250° C. to 280° C.

In some embodiments, the maximum operating temperature is less than approximately 340° C., 330° C., 320° C., 310° C., 300° C., or 290° C., or 280° C., or 270° C., or 260° C., or 250° C.

In some preferred embodiments, the maximum operating temperature is greater than approximately 245° C. Advantageously, the maximum operating temperature of the induction heating element is selected to rapidly heat an aerosol-generating material such as tobacco without burning or charring the aerosol-generating material or any protective wrapper associated with the aerosol-generating material (such as a paper wrap).

Surprisingly, it has been found that a small difference in maximum operating temperature may have an unexpectedly large impact on the characteristics of the aerosol produced by the aerosol-generating device. For example, an aerosol-generating device which reaches a maximum operating temperature of 240° C. surprisingly produces an aerosol markedly different from an aerosol provided by an aerosol-generating device which reaches a maximum operating temperature of 250° C., such as an aerosol-generating device according to the present invention. This effect may be particularly noticeable for tobacco heating products.

In some embodiments, the user's sensorial experience arising from the aerosol generated by the present device is like that of smoking a combustible cigarette, such as a factory-made cigarette.

In the aerosol-generating device of the present invention, each heating element in the heating assembly is arranged to heat, but not burn, aerosol-generating material. Although the temperature profile of each heating element induces the temperature profile of each associated portion of aerosol-generating material, the temperature profiles of the heating element and the associated portion of aerosol-generating material may not exactly correspond. For example: there may be “bleed” in the form of conduction, convection and/or radiation of heat energy from one portion of the aerosol-generating material to another; there may be variations in conduction, convection and/or radiation of heat energy from the heating elements to the aerosol-generating material; there may be a lag between the change in the temperature profile of the heating element and the change in the temperature profile of the aerosol-generating material, depending on the heat capacity of the aerosol-generating material.

The heating assembly also comprises a controller for controlling each heating unit present in the heating assembly. The controller may be a PCB. The controller is configured to control the power supplied to each heating unit, and controls the “programmed heating profile” of each heating unit present in the heating assembly. For example, the controller may be programmed to control the current supplied to a plurality of inductors to control the resulting temperature profiles of the corresponding induction heating elements. As between the temperature profile of heating elements and aerosol-generating material described above, the programmed heating profile of a heating element may not exactly correspond to the observed temperature profile of a heating element, for the same reasons given above.

The term “operating temperature” can also be used in relation to the aerosol-generating material. In this case, the term refers to any temperature of the aerosol-generating material itself at which sufficient aerosol is generated from the aerosol-generating material for a satisfactory puff. The maximum operating temperature of the aerosol-generating material is the highest temperature reached by any part of the aerosol-generating material during a smoking session. In some embodiments, the maximum operating temperature of the aerosol-generating material is greater than 200° C., 210° C., 220° C., 230° C., 240° C., 250° C., 260° C., or 270° C. In some embodiments, the maximum operating temperature of the aerosol-generating material is less than 300° C., 290° C., 280° C., 270° C., 260° C., 250° C. The lowest operating temperature is the lowest temperature of aerosol-generating material at which sufficient aerosol is generated from the material to product sufficient aerosol for a satisfactory “puff”. In some embodiments, the lowest operating temperature of the aerosol-generating material is greater than 90° C., 100° C., 110° C., 120° C., 130° C., 140° C. or 150° C. In some embodiments, the lowest operating temperature of the aerosol-generating material is less than 150° C., 140° C., 130° C., or 120° C.

Where there is a plurality of heating elements present in the aerosol-generating device, each heating element has an associated maximum operating temperature. The maximum operating temperature of each heating element may be the same, or it may differ for each heating element.

An object of the present invention is reducing the amount of time it takes for an aerosol-generating device to be ready for use, and more generally improve the inhalation experience for a user. Surprisingly, it has been found that reducing the time taken for a heating element to reach an operating temperature may at least partially alleviate “hot puff”, a phenomenon which occurs when the generated aerosol contains a high water content. Accordingly, the aerosol-generating device of the present invention may provide an inhalable aerosol to a consumer which has better organoleptic properties than an aerosol provided by an aerosol-generating device of the prior art which does not include a heating unit which reaches a maximum operating temperature as rapidly.

In some embodiments, the heating assembly is configured such that at least one heating element in the heating assembly reaches its maximum operating temperature within 20 seconds, and the first temperature at which the at least one heating unit is held for at least 1 second, 2 seconds, 3 seconds, 4 seconds, 5 seconds, 10 seconds, or 20 seconds is the maximum operating temperature. That is, in these embodiments, the heating unit is not held at a temperature which is not the maximum operating temperature before reaching the maximum operating temperature.

In some embodiments, the at least one heating unit reaches its maximum operating temperature within the given period from ambient temperature.

The heating assembly is configured to operate as described herein. The device of the present disclosure may at least partially be configured to operate in this manner by the controller of the heating assembly being programmed to operate the device in the plurality of modes. Accordingly, references herein to the configuration of the device of the present invention or components thereof may refer to the controller of the heating assembly being programmed to operate the device as disclosed herein, amongst other features (such as spatial arrangement of the components in the heating assembly).

In some embodiments, the user's sensorial experience arising from the aerosol generated by the present device is like that of smoking a combustible cigarette, such as a factory-made cigarette.

Aerosol-generating articles for aerosol-generating devices (such as tobacco heating products) usually contain more water and/or aerosol-generating agent than combustible smoking articles to facilitate formation of an aerosol in use. This higher water and/or aerosol-generating agent content can increase the risk of condensate collecting within the aerosol-generating device during use, particularly in locations away from the heating unit(s). This problem may be greater in devices with enclosed heating chambers, and particularly those with external heaters, than those provided with internal heaters (such as “blade” heaters). Without wishing to be bound by theory, it is believed that since a greater proportion/surface area of the aerosol-generating material is heated by external-heating heating assemblies, more aerosol is released than a device which heats the aerosol-generating material internally, leading to more condensation of the aerosol within the device. The inventors have found that programmed heating profiles of the present disclosure may advantageously be employed in a device configured to externally heat aerosol-generating material to provide a desirable amount of aerosol to the user whilst keeping the amount of aerosol which condenses inside the device low. For example, the maximum operating temperature of a heating unit may affect the amount of condensate formed. It may be that lower maximum operating temperatures provide less undesirable condensate. The difference between maximum operating temperatures of heating units in a heating assembly may also affect the amount of condensate formed. Further, the point in a session of use at which each heating unit present in the heating assembly reaches its maximum operating temperature may affect the amount of condensate formed.

According to aspects of the present invention, the heating assembly comprises induction heating units and is configured such that during at least one portion of the session of use, the first induction heating unit operates at a substantially constant first temperature and the second induction heating temperature operates at a substantially constant second temperature.

In one embodiment, the first temperature may be substantially equal to the second temperature. Surprisingly, it has been found that configuring a plurality of induction heating units to operate at substantially the same temperature may at least partially ameliorate the negative condensation and filtering effects which may result from different portions of an aerosol-generating material being heated to different temperatures.

In another embodiment, the first temperature is different from the second temperature. The inventors have found that controlling induction heating units in an aerosol-generating device presents a number of challenges which are different from corresponding devices which employ different heating units, such as resistive heating units. One advantage provided by aspects of the present disclosure is that the device is configured such that, for the first time, different induction heaters in the heating assembly can be operated consistently at different temperatures. For example, according to one embodiment, the heating assembly is configured such that the controller only provides power to one induction heating unit at any given time. Surprisingly, the inventors have discovered that by supplying power to only one induction heating unit at any one time, it is possible to maintain consistent operation of multiple heating units at different temperatures without interference.

For example, during usage of the device, the controller may determine when to activate each heating unit at the pre-determined frequency, i.e. one time for each of a plurality of pre-determined time intervals. Where the pre-determined frequency (which may be referred to as an “interrupt rate”) is 64 Hz, for example, the controller 1001 determine at pre-determined intervals of 1/64s, which heating unit to activate for a following duration of 1/64s until the controller makes the next determination of which heating unit to activate, at the end of the following 1/64s interval. In other examples, the interrupt rate may be, for example, from 20 Hz to 80 Hz, or correspondingly the pre-determined intervals may be of length 1/80s to 1/20s. In order to determine which inductor element is to be activated for a pre-determined interval, the controller determines which heating element should be heated for that pre-determined interval. In examples, the controller determines which susceptor zone heating element should be heated with reference to a measured temperature of the susceptor zones heating element.

The controller may determine whether to activate a heater based by detecting a characteristic of at least one of the induction heating units, and selectively activating the induction heating unit based on the detected characteristic. For example, a suitable component of the device may detect the energy supplied to the inductor coil, the temperature of the susceptor element, and so on. Preferably, the detected characteristic is indicative of the temperature of the heating unit. The controller may then either activate or not activate the induction heating unit based on the detected characteristic. For example, if it is detected that the temperature of the first heating unit is below the programmed temperature of the first heating unit, the controller will activate the first induction heating unit so that the temperature is raised to correspond to the programmed temperature. Similarly, if it is detected that the temperature is the same as the programmed temperature, the controller will deactivate the heating unit to avoid overheating the unit.

A “portion” of a session of use refers to any period during a session of use. A portion may have a maximum duration being the same as the duration of the session of use, but preferably each portion has a duration of less than the duration of the session of use. Preferably, each portion referred to has a duration of at least 10 seconds. More preferably still, the heating assembly is configured such that there is at least one portion having a duration of at least 60 seconds, 70 seconds, 80 seconds, 90 seconds, or 100 seconds.

A session of use may comprise a plurality of portions during which the heating assembly is configured to operate as described above. For example, the heating assembly may be configured for a first portion and a second portion. In some embodiments, the heating assembly is configured for a maximum of two portions; in other embodiments, the heating assembly is configured for more than two portions, such as three, four or five.

Where the device is configured such that there is a plurality of portions at which the first and second heating units have different temperatures over a sustained period, each portion may have the same duration, or different durations. Preferably, the heating assembly is configured to operate as described above for a first portion and a second portion, the first portion having a duration different from the second portion.

The first portion may have a duration which is greater than or less than the second portion. Preferably, the second portion is greater than the first portion. The second portion is preferably 20, 30, 40, 50 or 50 seconds longer than the first portion. Alternatively, the first portion may be 20, 30, 40, 50 or 50 seconds longer than the second portion. The inventors have identified that the first portion being longer than the second portion may help to reduce the amount of undesired condensate which collects in the device during use.

Where the session of use comprises a plurality of portions as contemplated herein, the first temperature is not necessarily the same for each portion, nor is the second temperature necessarily the same for each portion. That is, each portion is associated with a first temperature and a second temperature which may differ between the portions of the session of use.

In a preferred embodiment, the session of use comprises a first and a second portion. In the first portion, the first temperature is from 200° C. to 300° C., or 220° C. to 300° C., or 230° C. to 300° C., or 240° C. to 300° C., preferably 240° C. to 290° C. In a particular embodiment, the first temperature is from 240° C. to 260° C. In another embodiment, the first temperature is from 270° C. to 290° C. In another embodiment, the first temperature is from 230° C. to 250° C.

In these embodiments, the second temperature of the first portion is from 100° C. to 200° C., preferably 120° C. to 180° C., more preferably 150° C. to 170° C.

In this embodiment, the first temperature of the second portion is from 140° C. to 250° C., preferably 160° C. to 240° C., more preferably 180° C. to 240° C., still more preferably 210° C. to 230° C.

In this embodiment, the second temperature of the second portion is from 200° C. to 300° C., such as 220° C. to 260° C., or 240° C. to 300° C., preferably 240° C. to 270° C.

Where the session of use comprises a plurality of portions, each portion will necessarily begin and end at different points in the session of use. In one example, the first portion begins and ends before the second portion begins.

The second portion preferably starts after not less than 60 seconds from the start of the session of use.

In one embodiment, there is a period of time between the first portion and the second potion during which the first temperature and second temperature are substantially the same.

The induction heating units preferably extend along the heating assembly in a direction from the top of the device to the base device. In preferred embodiments, the lengths of the heating units in this direction are not equal. Having heating units of different lengths may allow for particular fine tuning of the use experience for a user. For example, the first unit is preferably disposed closer to the mouth end of the device and has a shorter length than the second unit. This arrangement may allow for a quick first puff.

In some embodiments, the heating assembly is configured such that a session of use includes a final “ramp-down” portion. In examples, the aerosol-generating device is configured to indicate to the user to stop inhaling from the aerosol-generating article; in examples, the final ramp-down portion begins when the aerosol-generating device indicates to the user to stop inhaling from the aerosol-generating article. In examples, the final ramp-down portion is initiated at a pre-determined time-point in the session of use. In other examples, the final ramp-down portion is initiated in response to a signal indicating that the aerosol-generating article has been removed from the aerosol-generating device. For example, the aerosol-generating device comprises a contact sensor arranged to contact the aerosol-generating article while the aerosol-generating article is disposed in the aerosol-generating device. The contact sensor completes or breaks an electrical circuit upon removal of the aerosol-generating article from the aerosol-generating device, thereby providing a signal for initiating the final ramp-down portion. In other examples, the sensor is a light sensor, arranged such that removal of the aerosol-generating article from the aerosol-generating device provides a change which is detectable by the light sensor. It is typically advantageous to remove the aerosol-generating article from the aerosol-generating device during the ramp-down period to enhance condensate removal. The final ramp-down portion ends at the end of the session of use.

During the final ramp-down portion, the heating assembly has a programmed temperature lower than an operating temperature and above ambient temperature. Typically, the heating assembly has a programmed temperature of about 80 to 120° C., or about 100° C. This configuration means that the heating unit(s) will gradually reduce in observed temperature from an operating temperature to the programmed temperature. By removing the aerosol-generating article from the aerosol-generating device while still providing power to the heating unit(s) during the ramp-down portion, aerosol and/or condensate disposed in the aerosol-generating device can be driven out of the housing before the end of the session of use. It is believed that this configuration reduces the amount of condensate which collects within the aerosol-generating device over time. A programmed temperature of about 100° C. is typically selected so that water disposed within the aerosol-generating device is vaporized such that it leaves the aerosol-generating device during the final ramp-down portion.

The final ramp-down portion may have any suitable duration. In examples, the final ramp-down portion has a duration of about 3 to 10 seconds, suitably about 5 seconds.

Each heating unit (or heating element) present in the heating assembly has an observed average (mean) temperature across the entire session of use. The observed average temperature (T̅) of a heating unit is calculated by taking temperature measurements at the heating unit throughout the session of use, and dividing the sum of the temperature measurements by the number of temperature measurements taken:

$$\overline{T} = \frac{{\sum }_{i = 1}^{n} {T}_{i}}{n}$$

The frequency of temperature measurements may affect the average temperature value calculated. For example, too long a period between each temperature measurement may result in a calculated average temperature which does not take into account relatively long fluctuations in temperature. Such a calculated average temperature would be unsatisfactorily unprecise. Accordingly, the average temperature as defined herein is calculated from temperature measurements having a frequency of at least 1 Hz. That is, to obtain a suitably precise average temperature, the temperature of the heating element must be measured at least once per second over the period for which the average temperature is calculated, and these measurements used to calculate the average temperature.

The average temperature may be calculated using any frequency of measurements which is at least 1 Hz. For example, the average may be calculated from temperature measurements taken at a frequency of at least 2 Hz, 3 Hz, 5 Hz, 10 Hz, 20 Hz, 30 Hz, 60 Hz or more.

The temperature measurements may be taken by any suitable temperature probe disposed at each heating element. For example, at each heating element present in the heating assembly there may be provided a temperature sensor such as a thermocouple, thermopile or resistance temperature detector (RTD, also referred to as a resistance thermometer). The aerosol-generating device may be provided with such temperature sensors. Alternatively, the aerosol-generating device may not comprise a fixed temperature probe at each heating element, in which case the average temperature of each heating unit must be calculated using separate temperature sensors.

In embodiments wherein the heating assembly comprises a plurality of heating units, the average temperature of each heating unit may be the same, or it may be different. For example, the average temperature of the first heating unit may be different from the average temperature of the second heating unit. Preferably, the average temperature of the first heating unit is higher than the average temperature of the second heating unit.

Surprisingly, the inventors have found that configuring a heating assembly such that the heating units comprised in the assembly have particular average temperatures over a session of use may be advantageous. The average temperature of a heating element over a session of use may be used as an indicator of the amount of thermal energy delivered to the aerosol-generating material during the session of use. The heating assembly is configured such that each heating unit present in the heating assembly has an average temperature over a session of use which corresponds to the amount of thermal energy required to generate a desirable amount of aerosol from the aerosol-generating material over the session of use.

Moreover, it may be advantageous for the heating assembly to be configured such that one or more of the heating units present in the heating assembly has an average temperature over the session of use which ameliorates at least some negative effects associated with the heating unit having a different average temperature. For example, operating a heating unit which results in heating of the aerosol-generating article at too low a temperature for a portion of a session of use may result in undesirable condensation in a portion of the aerosol-generating article, and/or may result in the portion of the aerosol-generating article filtering desirable components from the inhalable aerosol delivered to the user. The heating assembly is therefore preferably configured such that at least one heating unit has an average temperature over a session of use which diminishes the condensation or filtering effects associated with operating at too low a temperature.

In some embodiments, the user's sensorial experience arising from the aerosol generated by the present device is like that of smoking a combustible cigarette, such as a factory-made cigarette.

The heating assembly is configured to operate as described herein. The device of the present disclosure may at least partially be configured to operate in this manner by the controller of the heating assembly being programmed to operate the device in the plurality of modes. Accordingly, references herein to the configuration of the device of the present invention or components thereof may refer to the controller of the heating assembly being programmed to operate the device as disclosed herein, amongst other features (such as spatial arrangement of the components in the heating assembly).

In some embodiments, the heating assembly is configured such that, in use, at least one heating unit of the heating assembly has an average temperature across the entire session of use of from approximately 180° C. to 280° C., preferably from approximately 200° C. to 270° C., more preferably from approximately 220° C. to 260° C., still more preferably from approximately 230° C. to 250° C., or most preferably from 235° C. to 245° C. Without wishing to be bound by theory, it is believed that operating at least one heating unit with such an average temperature may help to ameliorate the negative condensation and filtering effects discussed above.

The controller of the heating assembly is configured to instruct each heating unit present in the heating assembly to have a predetermined temperature profile. The predetermined temperature profile in associated with a predetermined average temperature across the entire session of use. A predetermined average temperature is calculated in the same way as an observed average temperature (as discussed above), but instead of obtaining each temperature value by taking temperature measurements with a temperature probe, it is the programmed temperatures of each time point which are summed together.

The programmed average temperature of a heating unit and the observed average temperature of a heating unit may be compared by ensuring that for each observed temperature value which is obtained at any given timepoint, the corresponding programmed temperature is obtained for the same timepoint. Put another way, for an observed temperature average temperature to be compared with its corresponding programmed average temperature, the number of programmed temperature values used to calculate the programmed average temperature and their frequency must be the same as the number of observed temperature values used to calculate the observed average temperature and their frequency.

There may be a difference between the programmed average temperature and the observed average temperature for each heating unit of the heating assembly due to lag, or thermal bleed. Preferably, though, the heating assembly is configured such that the difference is relatively small. For example, the heating assembly may be configured such that the difference between the programmed average temperature and the observed average temperature for at least one heating unit present in the heating assembly over an entire session of use is less than 40° C., preferably less than 30° C., more preferably less than 20° C., more preferably less than 10° C., and most preferably less than 5° C.

Where the heating assembly comprises a first heating unit and a second heating unit, the heating assembly is preferably configured such that the difference between the programmed average temperature and the observed average temperature of the first heating unit over an entire session of use is less than 40° C., preferably less than 30° C., more preferably less than 20° C., more preferably less than 10° C., and most preferably less than 5° C.

In one example, the difference between the programmed average temperature and the observed average temperature of the first and second heating units over an entire session of use is less than 40° C., or less than 30° C., or less than 20° C., or less than 10° C., or less than 5° C.

The heating assembly described herein in relation to aspects of the present invention is configured such that at least one heating unit exhibits a particular Mean Absolute Error in use. The Mean Absolute Error (MAE) as used herein is a measure of difference between the programmed temperature profile of a heating unit over a session of use, and the observed temperature profile over a session of use.

The inventors of the present invention have identified that configuring the heating assembly such that at least one heater having a low MAE value may mean that the device is much more responsive. For example, programmed changes in temperature may be more accurately performed by the heating unit. The heating unit preferably has a low MAE value over an entire session. This may allow a substrate temperature profile to be more accurately defined. This may provide an enhanced user experience—for example, more accurate control of the temperature profile of the heating unit (and thereby more accurate control of the temperature profile of the aerosol-generating material) may provide for better control of the aerosol content of each puff inhaled by a user.

A heating unit exhibiting a low MAE value may be found to be more responsive. More rapid and larger temperature changes may therefore be achieved. For example, a quicker ramp-up may be achieved so that the device is ready for use in a shorter amount of time compared with aerosol-generating devices known in the art. The observed temperature profile of such a heating unit is very close to the programmed temperature profile.

The heating assembly is configured to operate as described herein. The device of the present disclosure may at least partially be configured to operate in this manner by the controller of the heating assembly being programmed to operate the device in the plurality of modes. Accordingly, references herein to the configuration of the device of the present invention or components thereof may refer to the controller of the heating assembly being programmed to operate the device as disclosed herein, amongst other features (such as spatial arrangement of the components in the heating assembly).

In one aspect, the present invention relates to a heating assembly configured such that the at least first heating unit has a given MAE value for an entire session of use. In other aspects, the present invention relates to at least one heating unit having a given MAE value over a portion of a session of use. For example, the portion of a session of use during which the heating unit has the highest temperature of any heating units arranged in the heating assembly.

For convenience, the programmed temperature of a heating unit at any point during the session of use may be indicated with the symbol T^{Pr}. The observed temperature of a heating unit may be indicated with the symbol T^{Ob}.

The MAE of the at least first heater in the heating assembly may be calculated according to the following equation:

$$MAE = \frac{1}{n} {\sum }_{i = 1}^{n} \vert {T}_{i}^{Ob} - {T}_{i}^{Pr} \vert$$

wherein n is the number of temperature measurements taken. The MAE should be calculated using programmed average temperature values and observed temperature values at corresponding timepoints in the session of use. That is, for each observed temperature value which is obtained at any given timepoint, the corresponding programmed temperature is obtained for the same timepoint. Put another way, for an observed temperature average temperature to be compared with its corresponding programmed average temperature, the number of programmed temperature values used to calculate the programmed average temperature and their frequency must be the same as the number of observed temperature values used to calculate the observed average temperature and their frequency.

As with the average temperature discussed hereinabove, the frequency of temperature measurements may affect the MAE value calculated. For example, too long a period between each temperature measurement may result in a MAE value which does not take into account relatively large or long deviations in temperature. Such a calculated MAE would be unsatisfactorily unprecise. Accordingly, the MAE as defined herein is calculated from temperature measurements having a frequency of at least 1 Hz. That is, to obtain a suitably precise MAE value, the temperature of the heating element must be measured at least once per second over the period for which the average temperature is calculated, programmed temperature values obtained for the corresponding timepoints, and these measurements used to calculate the MAE value.

The MAE may be calculated using any frequency of measurements which is at least 1 Hz. For example, the average may be calculated from temperature measurements taken at a frequency of at least 2 Hz, 3 Hz, 5 Hz, 10 Hz, 20 Hz, 30 Hz, 60 Hz or more.

The temperature measurements may be taken by any suitable temperature probe disposed at each heating element. For example, at each heating element present in the heating assembly there may be provided a temperature sensor such as a thermocouple, thermopile or resistance temperature detector (RTD, also referred to as a resistance thermometer). The aerosol-generating device may be provided with such heating elements. Alternatively, the aerosol-generating device may not comprise a fixed temperature probe at each heating element, in which case the average temperature of each heating unit must be calculated using separate temperature sensors.

The MAE of the at least first heating unit over a session of use is 20° C. or less, preferably 10° C. or less. The inventors have found that a MAE of this small magnitude provides a particularly accurate observed temperature profile, providing better control of the inhalable aerosol provided to a user. In some embodiments, the MAE of the at least first heating unit over a session of use is less than 9° C., 8° C., 7° C., 6° C., 5° C., 4° C., or 3° C. In a preferred embodiment, the MAE of the at least first heating unit over a session of use is less than 5° C.

As described hereinabove, the heating assembly may comprise a plurality of heating units. A temperature relating to the jth heating unit in a heating assembly may be shown as ^{hj}T. For example, the temperature of a first heating unit may be shown as ^{h1}T; the temperature of a second heating unit may be shown as ^{h2}T.

These labels may be combined with those set out above to indicate the observed temperature of a jth heating unit in the heating assembly as ^{hj}T^{Ob}, and the programmed temperature of the jth heating unit as ^{hj}T^{Pr}. For example, the observed temperature of a first heating unit may be shown as ^{h1}T^{Ob}.

Accordingly, the MAE of a heating unit hⱼ arranged in the heating assembly can be calculated as follows:

$${}^{hj} MAE = \frac{1}{n} {\sum }_{i = 1}^{n} \vert {}_{}^{hj}{T}{}_{i}^{Ob} - {}_{}^{hj}{T}{}_{i}^{Pr} \vert$$

For example, the MAE of a first heating unit (h₁), which may be referred to as ^{h1}MAE, is calculated as follows:

$${}^{h 1} MAE = \frac{1}{n} {\sum }_{i = 1}^{n} {\vert}^{h 1} {T}_{i}^{Ob} - {}_{}^{h 1}{T}{}_{i}^{Pr} \vert$$

Each heating unit also has an observed average (mean) temperature across an entire session of use. The observed average temperature (T̅) of a heating unit is calculated by taking temperature measurements at the heating unit throughout the session of use, and dividing the sum of the temperature measurements by the number of temperature measurements taken:

$$\overline{T} = \frac{{\sum }_{i = 1}^{n} {T}_{i}}{n}$$

In embodiments wherein the heating assembly comprises a plurality of heating units, the average temperature of each heating unit may be the same, or it may be different. For example, the average temperature of the first heating unit may be different from the average temperature of the second heating unit. Preferably, the average temperature of the first heating unit is higher than the average temperature of the second heating unit.

In some embodiments, the heating assembly is configured such that, in use, at least one heating unit of the heating assembly has an average temperature across the entire session of use of from approximately 180° C. to 280° C., preferably from approximately 200° C. to 270° C., more preferably from approximately 220° C. to 260° C., still more preferably from approximately 230° C. to 250° C., or most preferably from 235° C. to 245° C. Without wishing to be bound by theory, it is believed that operating at least one heating unit with such an average temperature may help to ameliorate the negative condensation and filtering effects discussed above.

In embodiments wherein the heating assembly comprises a plurality of heating units, the MAE of each heating unit may be the same, or it may be different. For example, the MAE of the first heating unit over a session of use may be different from the MAE of the second heating unit. In particular embodiments, the MAE and average temperature of the first heating unit may differ from the MAE and average temperature of the second heating unit. The MAE of the heating unit having the higher average temperature may be lower than the MAE of the heating unit having the lower average temperature. The difference in MAE bay be attributed to thermal bleed from the heating unit having the higher average temperature to the heating unit having the lower average temperature.

In a preferred embodiment, the heating assembly comprises a first heating unit having a first MAE and a first average temperature over a session of use, and a second heating unit having a second MAE and a second average temperature over a session of use. The first average temperature is higher than the second average temperature, and the second MAE is higher than the first MAE.

In preferred embodiments, the heating unit in the heating assembly which has the highest average programmed temperature over a session of use has a MAE of less than 10° C. For example, the heating unit has a MAE less than 9° C., 8° C., 7° C., 6° C., 5° C., 4° C., or 3° C. In a particularly preferred embodiment, the MAE of the heating unit which has the highest average programmed temperature over a session of use has a MAE of less than 5° C.

In embodiments wherein the heating assembly comprises at least a first heating unit and a second heating unit, the MAE of the first heating unit is preferably less than 10° C., and the MAE of the second heating unit less than 50° C., 45° C., 40° C., or 35° C. In a preferred embodiment, the MAE of the second heating unit is less than 35° C.

In preferred embodiments, the heating unit in the heating assembly which reaches the highest maximum operating temperature during a session of use has a MAE of less than 10° C. For example, the heating unit has a MAE less than 9° C., 8° C., 7° C., 6° C., 5° C., 4° C., or 3° C. In a preferred embodiment, the MAE of the heating unit which reaches the highest maximum operating temperature over a session of use is less than 5° C.

In particular embodiments, the controller of the heating assembly controls each heating unit by a control loop feedback mechanism to control the temperature of the heating elements based on data supplied from one or more temperature sensors disposed in the device. Preferably, the controller comprises a PID controller configured to control the temperature of each heating unit based on temperature data supplied from thermocouples disposed at each of the heating elements. In a particularly preferred embodiment, each heating unit is an induction heating unit.

The heating assembly may alternatively or additionally be configured such that the first heating unit and second heating unit together have a particular mean absolute error over a session of use.

The mean absolute error of a first heating unit and a second heating unit over a session of use is calculated as follows:

$${}^{h 1 + h 2} MAE = \frac{1}{2 n} {\sum }_{j = 1}^{2} {\sum }_{i = 1}^{n} {\vert}^{h 1} {T}_{i}^{Ob} - {}_{}^{h 1}{T}{}_{i}^{Pr} \vert$$

Alternatively, ^{h1+h2}MAE may be calculated as the mean of ^{h1}MAE and ^{h2}MAE:

$${}^{h 1 + h 2} MAE = \frac{{}^{h 1} MAE + {}^{h 2} MAE}{2}$$

In some embodiments, ^{h1+h2}MAE is less than 40° C., 35° C., 30° C., 25° C., or 20° C. Preferably, ^{h1+h2}MAE is less than 20° C. By controlling the MAE of a plurality of heating units, the device may provide more controlled heating of the aerosol-generating article along the entire aerosol-generating article.

The heating assembly may alternatively or additionally be configured such that entire heating assembly operates having a particular MAE. In this case, the MAE of the heating assembly comprising m heating units is calculated as follows:

$${}^{assembly} MAE = \frac{1}{mn} {\sum }_{j = 1}^{m} {\sum }_{i = 1}^{n} {\vert}^{h j} {T}_{i}^{Ob} - {}_{}^{h j}{T}{}_{i}^{Pr} \vert$$

Alternatively, ^{assembly}MAE may be calculated as the mean of the MAE values of each heating unit present in the heating assembly.

$${}^{assembly} MAE = \frac{1}{mn} {\sum }_{j = 1}^{m} {}^{hj} MAE$$

For example, for an assembly having three heating units, m=3; the heating assembly comprises heating units h₁, h₂ and h₃. Accordingly, for a heating assembly comprising a first and second heating unit only, m=2 and ^{h1+h2}MAE=^{assembly}MAE.

In some embodiments, ^{assembly}MAE is less than 40° C. For example, ^{assembly}MAE may be less than 35° C., 30° C., 25° C., or 20° C. Preferably, ^{assembly}MAE is less than 20° C. By controlling the MAE of an entire heating assembly, the device may provide more controlled heating of the aerosol-generating article along the entire aerosol-generating article, and throughout a session of use.

The heating assembly may alternatively or additionally be configured such that the assembly has a MAE taking into account only the programmed and observed temperature values of whichever heating unit is programmed to have the highest temperature in the heating assembly at any given time. This value may conveniently be referred to as ^{assembly}MAE^{hottest} or the mean absolute error of the heating assembly based on the hottest heating unit(s) only.

Controlling the MAE of the hottest heating unit in the heating assembly may advantageously provide better control of the temperature in portions of the aerosol-generating article which are generating large amounts of aerosol.

In some embodiments, ^{assembly}MAE^{hottest} is less than 20° C. For example, the ^{assembly}MAE^{hottest} may be less than 15° C., 10° C., or 5° C. Preferably, ^{assembly}MAE^{hottest} is less than 5° C. over a session of use.

The heating assembly described herein may also be configured such that at least one heating unit exhibits a particular Mean Error in use. The Mean Error (ME) as used herein is another measure of difference between the programmed temperature profile of a heating unit over a session of use, and the observed temperature profile over a session of use, which takes into account whether the observed temperature is generally higher or lower than the programmed temperature. The ME for a heating unit hⱼ may be calculated as follows:

$${}^{hj} MAE = \frac{1}{n} {\sum }_{i = 1}^{n} {}_{}^{hj}{T}{}_{i}^{Ob} - {}_{}^{hj}{T}{}_{i}^{Pr}$$

The ME may also be calculated by subtracting the mean programmed temperature (T̅^{Pr}) of a heating unit from the mean observed temperature (T̅^{Pr}):

^{hg}ME=^{hj}T̅^{Ob}−^{hj}T̅^{Pr}

A positive ME value indicates that the observed temperature of a heating unit is generally higher than the programmed temperature over a session of use. A negative ME value indicates that the observed temperature of a heating unit is generally lower than the programmed temperature over a session of use. Thus, the ME of a heating unit may be used to indicate whether the heating unit has supplied more or less thermal energy to the aerosol-generating material than programmed over a session of use.

In one embodiment, the ME value of at least one heating unit in the heating assembly over a session of use is positive. In another embodiment, the ME value of at least one heating unit is positive.

In a preferred embodiment, the heating unit which has the highest maximum operating temperature in a session of use has a negative ME value. This may at least partially avoid charring of the paper wrapper of the aerosol-generating article, and/or at least partially avoid burning the substrate.

In another embodiment, the first heating unit has a negative ME, and the second heating unit has a positive ME. In a particularly preferred embodiment, the first heating unit has a negative ME and first average temperature over a session of use, and the second heating unit has a positive ME and second average temperature over a session of use, the first average temperature being higher than the second average temperature.

As for the MAE, the assembly may be configured to have a particular ME over a session of use:

$${ }^{assembly} MAE = \frac{1}{n} {\sum }_{i = 1}^{n} {}_{}^{hj}{T}{}_{i}^{Ob} - {}_{}^{hj}{T}{}_{i}^{Pr}$$

In some embodiments, the heating assembly is operable in at least a first mode and a second mode. The heating assembly may be operable in a maximum of two modes, or may be operable in more than two modes, such as three modes, four modes, or five modes. Each mode may be associated with a predetermined heating profile for each heating unit in the heating assembly, such as a programmed heating profile. One or more of the programmed heating profiles may be programmed by a user. Additionally, or alternatively, one or more of the programmed heating profiles may be programmed by the manufacturer. In these examples, the one or more programmed heating profiles may be fixed such that an end user cannot alter the one or more programmed heating profiles.

The modes of operation may be selectable by a user. For example, the user may select a desired mode of operation by interacting with a user interface. Preferably, power begins to be supplied to the first heating unit at substantially the same time as the desired mode of operation is selected.

In examples, each mode is associated with a temperature profile which differs from the temperature profiles of the other modes. Further, one or more modes may be associated with a different point at which the device is ready for use. For example, the heating assembly may be configured such that, in the first mode, the device is ready for use a first period of time after the start of a session of use, and in the second mode, the device is ready for use a second period of time after the start of the session. The first period of time may be different from the second period of time. Preferably, the second period of time associated with the second mode is shorter than the first period of time associated with the second mode.

In some examples, the heating assembly is configured such that the device is ready for use within 30, 25 seconds, 20 seconds or 15 seconds of supplying power to the first heating unit when operated in the first mode. The heating assembly may also be configured such that the device is ready for use in a shorter period of time when operating in the second mode—within 25 seconds, 20 seconds, 15 seconds, or 10 seconds of supplying power to the first heating unit when operating in the second mode. Preferably, the heating assembly is configured such that the device is ready for use within 20 seconds of supplying power to the first heating unit when operated in the first mode, and within 10 seconds of supplying power to the second heating unit when operated in the second mode. Advantageously, the second mode of this embodiment may also be associated with the first and/or second heating unit having a higher maximum operating temperature in use.

In a particularly preferred embodiment, the device is configured such that the indicator indicates that the device is ready for use within 20 seconds of selection of the first mode, and within 10 seconds of selection of the second mode.

In examples, each mode of operation is associated with a predetermined duration for a session of use. At least some modes of operation are associated with predetermined durations which differ from each other. For example, where the heating assembly is operable in a first mode and a second mode, the duration associated with the first mode (the first predetermined duration of the first-mode session of use) differs from the duration associated with the second mode (the second predetermined duration of the second-mode session of use). The first predetermined duration of the first-mode session of use may be longer or shorter than the second predetermined duration of the second-mode session of use. Preferably, the first predetermined duration of the first-mode session of use is longer than the second predetermined duration of the second-mode session of use.

Providing an aerosol-generating device such as a tobacco heating product with a heating assembly that is operable in a plurality of modes advantageously gives more choice to the consumer, particularly where each mode is associated with a different maximum heater temperature and/or a different duration of session of use. Moreover, such a device is capable of providing different aerosols having differing characteristics, because volatile components in the aerosol-generating material will be volatilized at different rates and concentrations at different heater temperatures and/or over different session lengths. This may allow a user to select a particular mode based on a desired characteristic of the inhalable aerosol, such as degree of tobacco flavor, nicotine concentration, and aerosol temperature. For example, modes in which the device is ready for use more quickly may provide a quicker first puff, or a greater nicotine content per puff, or a more concentrated flavor per puff. Conversely, modes in which the device is ready for use at a later point in the session of use may provide a longer overall session of use, lower nicotine content per puff, and more sustained delivery of flavor. In examples, modes in which the session of use has a relatively short duration may be configured to provide a quicker first puff, or a greater nicotine content per puff, or a more concentrated flavor per puff. Conversely, modes in which the or each heating unit rises to a lower temperature may be configured to provide a lower nicotine content per puff, or more sustained delivery of flavor.

Each mode may also be associated with a maximum temperature to which the or each heating unit in the heating assembly rises in use. The heating assembly may be configured such that each heating unit reaches a first-mode maximum operating temperature in the first mode, and a second-mode maximum operating temperature in the second mode. The maximum operating temperature of at least one heating unit of the heating assembly in the first mode may differ from the maximum operating temperature of that heating unit in the second mode. For example, the maximum operating temperature of the first heating unit in the first mode (herein referred to as the “first-mode maximum operating temperature” of the first heating unit) may differ from the maximum operating temperature of the first heating unit in the second mode (herein referred to as the “second-mode maximum operating temperature” of the first heating unit). In some examples, the first mode maximum operating temperature is higher than the second-mode maximum operating temperature; in other examples, the first-mode maximum operating temperature is lower than the second-mode maximum operating temperature. Preferably, the second-mode maximum operating temperature of the first heating unit is higher than the first-mode maximum operating temperature of the first heating unit.

In embodiments wherein the device is ready for use more quickly in the second mode, and/or the first and/or second heating unit has a higher maximum operating temperature in the second mode, the second mode may be referred to as a “boost” mode. For the first time, aspects of the present invention provide an aerosol-generating device which is operable in a first “normal” mode, and a second “boost” mode. The “boost” mode may advantageously provide a quicker first puff, or a greater nicotine content per puff, or a more concentrated flavor per puff.

In examples, the heating assembly is configured such that the second mode is associated with a shorter duration of session of use and a higher maximum operating temperature. This may allow for delivery of consistent amounts of volatile components to a user over a session of use—a hotter maximum operating temperature may result in quicker depletion of the volatile components from the aerosol-generating material, so a shorter duration of session of use is preferable.

Preferably, the first session of use duration is longer than the second session of use duration. In some examples, the first and/or second session of use may have a duration of at least 2 minutes, 2 minutes 30 seconds, 3 minutes, 3 minutes 30 seconds, 4 minutes, 4 minutes 30 seconds, 5 minutes, 5 minutes 30 seconds, or 6 minutes. In some examples, the first and/or second session of use may have a duration of less than 7 minutes, 6 minutes, 5 minutes 30 seconds, 5 minutes, 4 minutes 30 seconds, or 4 minutes. Preferably, the first session of use has a duration of from 3 minutes to 5 minutes, more preferably from 3 minutes 30 seconds to 4 minutes 30 seconds. Preferably, the second session of use has a duration of from 2 minutes to 4 minutes, more preferably from 2 minutes 30 seconds to 3 minutes 30 seconds.

Each mode of operation is also associated with a predetermined duration for the inhalation session in each mode. Preferably, the first inhalation session duration is longer than the second inhalation session duration. In some examples, the first and/or second inhalation session may have a duration of at least 2 minutes, 2 minutes 30 seconds, 3 minutes, 3 minutes 30 seconds, 4 minutes, 4 minutes 30 seconds, 5 minutes, 5 minutes 30 seconds, or 6 minutes. In some examples, the first and/or second inhalation session may have a duration of less than 7 minutes, 6 minutes, 5 minutes 30 seconds, 5 minutes, 4 minutes 30 seconds, or 4 minutes. Preferably, the first inhalation session has a duration of from 3 minutes to 5 minutes, more preferably from 3 minutes 30 seconds to 4 minutes 30 seconds. Preferably, the second inhalation session has a duration of from 2 minutes to 4 minutes, more preferably from 2 minutes 30 seconds to 3 minutes 30 seconds.

Each mode may be associated with an average temperature across a session of use for each heating unit present in the heating assembly. The average temperature for each session may be the same, or it may differ. For example, the average temperature of the first heating unit in the first mode may be different from the average temperature of the first heating unit in the second mode. The first-mode average temperature may be higher than the second-mode average temperature, or lower. Preferably, the second-mode average temperature of the first heating unit is higher than the first-mode average temperature.

In embodiments where the heating assembly comprises a first heating unit and a second heating unit, the first-mode average temperature of the first and/or second unit may differ from each respective second-mode average temperature. In a preferred embodiment, the second-mode average temperatures of both the first and second units are higher than the first mode average temperatures for each respective unit.

In a particular embodiment, the device comprises an indicator and is configured to indicate to the user when the device is ready for use. In one embodiment, the device is configured such that the point of the session of use at which the indicator indicates to the user that the device is ready for use differs between at least two modes. Preferably, the device is configured such that the point at which the indicator indicates to the user is earlier in the second mode than in the first mode. For example, the device may indicate to the user that they should begin inhaling aerosol from the device approximately 20 seconds from the start of the session of use in the first mode, but approximately 10 seconds from the start of the session of use in the second mode.

In some embodiments, the heating assembly comprises a plurality of heating units. For example, the heating assembly may comprise two heating units: the first heating unit described above, and a second heating unit. The second heating unit is arranged to heat, but not burn, the aerosol-generating material in use. The second heating unit is controllable by the controller of the heating assembly. The second heating unit is controllable independent from the first heating unit.

The heating assembly may comprise a maximum of two heating units. In other examples, the heating assembly comprises more than two independently controllable heating units, such as three, four or five independently controllable heating units.

In examples, the heating assembly comprises at least a first heating unit and a second heating unit. In examples of aerosol-generating devices which are operable in a plurality of modes, the first mode of operation may comprise supplying energy to the first heating unit for a first-mode predetermined duration; and the second mode may comprise supplying energy to the first heating unit for a second-mode predetermined duration. The first mode may also comprise supplying energy to the second heating unit for a first-mode predetermined duration; and the second mode may also comprise supplying energy to the second heating unit for a second-mode predetermined duration.

In some embodiments, the predetermined duration of at least one heating unit is the same in each mode. In some embodiments, the predetermined duration of at least one heating unit differs between modes. In a preferred embodiment, the predetermined duration of supplying energy to each heating unit differs between each mode.

It is expressly contemplated that a heating assembly configured to operate in at least two modes having different durations of session of use may be configured such that at least one heating unit in the assembly is supplied with energy for the same amount of time in both modes. For example, the assembly may be configured to provide a first-mode inhalation session lasting 4 minutes, and a second-mode inhalation session lasting 3 minutes. In this example, if the assembly included two heating units, the first heating unit may be supplied with energy for the entirety of each session of use. The second heating unit may be supplied with energy only for the last minute of each session of use. Accordingly, in this embodiment, even though the first-mode session of use has a different duration from the second-mode session of use, the assembly is configured such that power is supplied to the second heating unit for the same amount of time in both modes.

In preferred embodiments, at least one of the heating units provided in the heating assembly is supplied with power for the entire session of use in at least one mode. In particular, it is preferred that the first heating unit is supplied with power for the entire first-mode session of use and/or second-mode session of use. In a particularly preferred embodiment, the first heating unit is supplied with power for the entire session of use in each mode of operation of the device.

In preferred embodiments, at least one of the heating units provided in the heating assembly is supplied with power for less than the entire session of use in at least one mode. This may advantageously allow for more economical power use while maintaining an acceptable aerosol to be delivered to the user. In particular, it is preferred that the second heating unit is supplied with power for less than the entire first-mode session of use and/or second-mode session of use. In a particularly preferred embodiment, the second heating unit is supplied with power for less than the entire session of use in each mode of operation of the device. More preferably still, the second heating unit is supplied with power for at least half the session of use in each mode, but less than the entire session of use in each mode.

In some embodiments, the first-mode predetermined duration of supplying energy to the first heating unit is from approximately 3 minutes to 5 minutes, more preferably from 3 minutes 30 seconds to 4 minutes 30 seconds. This first-mode predetermined duration may be less than 4 minutes 30 seconds, 4 minutes, or 3 minutes 30 seconds. This first-mode predetermined duration may be greater than 3 minutes, 3 minutes 30 seconds, or 4 minutes.

In some embodiments, the first-mode predetermined duration of supplying energy to the second heating unit is from approximately 2 minutes to 4 minutes, more preferably from 2 minutes 30 seconds to 3 minutes 30 seconds. This first-mode predetermined duration may be less than 4 minutes, 3 minutes 30 seconds, or 3 minutes. This first-mode predetermined duration may be greater than 2 minutes, 2 minutes 30 seconds, or 3 minutes.

In some embodiments, the second-mode predetermined duration of supplying energy to the first heating unit is from approximately 2 minutes to 4 minutes, preferably 2 minutes 30 seconds to 3 minutes 30 seconds, most preferably approximately 3 minutes. This second-mode predetermined duration may be less than 4 minutes, or 3 minutes 30 seconds. This first-mode predetermined duration may be greater than 2 minutes, or 2 minutes 30 seconds.

In some embodiments, the second-mode predetermined duration of supplying energy to the second heating unit is from approximately 1 minute 30 seconds to 3 minutes, preferably 2 minutes to 3 minutes, most preferably approximately 2 minutes 30 seconds. This second-mode predetermined duration may be less than 3 minutes, or 2 minutes 30 seconds. This first-mode predetermined duration may be greater than 1 minute 90 seconds, 2 minutes, or 2 minutes 30 seconds.

Preferably, the heating assembly is configured such that each heating unit present in the heating assembly reaches a first-mode maximum operating temperature in the first mode, and a second-mode maximum operating temperature in the second mode. For example, the second heating unit may reach a first-mode maximum operating temperature in the first mode, and a second-mode maximum operating temperature in the second mode. The maximum operating temperature of each heating unit in each mode may be the same, or may be different. For example, the maximum operating temperature of the second heating unit in each mode may or may not be the same as the maximum operating temperature of the first heating unit in each mode.

The first-mode maximum operating temperature of the first heating unit may differ from the second-mode maximum operating temperature of the first heating unit. For example, the first-mode maximum operating temperature may be higher than the second-mode maximum operating temperature; alternatively, the first-mode maximum operating temperature may be lower than the second-mode maximum operating temperature. Preferably, the second-mode maximum operating temperature of the first heating unit is higher than the first-mode maximum operating temperature of the first heating unit.

The first-mode maximum operating temperature of the second heating unit may differ from the second-mode maximum operating temperature of the second heating unit. For example, the first-mode maximum operating temperature may be higher than the second-mode maximum operating temperature; alternatively, the first-mode maximum operating temperature may be lower than the second-mode maximum operating temperature. Preferably, the second-mode maximum operating temperature of the second heating unit is higher than the first-mode maximum operating temperature of the second heating unit.

In some embodiments, each heating unit of the heating assembly has a higher maximum operating temperature in the second mode than in the first mode.

As mentioned above, the maximum operating temperatures of the first heating unit may or may not be the same as those of the second heating unit. In one embodiment, the first-mode maximum operating temperature of the first heating unit is substantially the same as the first-mode maximum operating temperature of the second heating unit. In another embodiment, the first-mode maximum operating temperature of the first heating unit differs from the first-mode maximum operating temperature of the second unit. For example, the first-mode maximum operating temperature of the first heating unit may be higher than the first-mode maximum operating temperature of the second heating unit, or the first-mode maximum operating temperature of the first heating unit may be lower than the first-mode maximum operating temperature of the second heating unit. Preferably, the first-mode maximum operating temperature of the first heating unit is substantially the same as the first-mode maximum operating temperature of the second heating unit. The inventors have found that configuring the heating assembly such that the first-mode maximum operating temperature of the first heating unit is substantially the same as the first-mode maximum operating temperature of the second heating unit may reduce the amount of condensate which collects within the device during use, while still providing an acceptable puff to the user.

In some examples, the first-mode maximum operating temperature of the first heating unit and/or the second heating unit is less than 300° C., 290° C., 280° C., 270° C., 260° C., or 250° C. In some examples, the first-mode maximum operating temperature of the first heating unit and/or the second heating unit is greater than 245° C., 250° C., 255° C., 260° C., 265° C., or 270° C. In some examples, the first-mode maximum operating temperature of the first heating unit and optionally the second heating unit is from 240° C. to 300° C., or 240° C. to 280° C., or 245° C. to 270° C. Preferably, the first-mode maximum operating temperature of the first heating unit and the first-mode maximum operating temperature of the second heating unit is from 245° C. to 270° C. A lower maximum operating temperature may reduce the amount of undesirable condensate provided in the device in use.

In some examples, the first-mode maximum operating temperature of the second heating unit is less than 300° C., 290° C., 280° C., 270° C., 260° C., or 250° C. In some examples, the first-mode maximum operating temperature of the second heating unit is greater than 220° C., 230° C., 240° C., 245° C., 250° C., 255° C., 260° C., 265° C., or 270° C. In some examples, the first-mode maximum operating temperature of the first heating unit and/or the second heating unit is from 240° C. to 300° C., or 240° C. to 280° C., or 245° C. to 270° C. In one embodiment, the first-mode maximum operating temperature of the first heating unit and the first-mode maximum operating temperature of the second heating unit is from 245° C. to 270° C. In another embodiment, the first-mode maximum operating temperature of the first heating unit and the first-mode maximum operating temperature of the second heating unit is from 220° C. to 250° C. A lower maximum operating temperature may reduce the amount of undesirable condensate provided in the device in use.

In one embodiment, the second-mode maximum operating temperature of the first heating unit is substantially the same as the second-mode maximum operating temperature of the second heating unit. In another embodiment, the second-mode maximum operating temperature of the first heating unit differs from the second-mode maximum operating temperature of the second heating unit. For example, the second-mode maximum operating temperature of the first heating unit may be higher than the second-mode maximum operating temperature of the second heating unit, or the second-mode maximum operating temperature operating temperature of the first heating unit may be lower than the second-mode maximum operating temperature of the second heating unit. Preferably, the second-mode maximum operating temperature of the first heating unit is higher than the second-mode maximum operating temperature of the second unit. The inventors have found that configuring the heating assembly such that the second-mode maximum operating temperature of the first heating unit is substantially the same as the second-mode maximum operating temperature of the second heating unit may reduce the amount of condensate which collects within the device during use, while still providing an acceptable puff to the user.

In some examples, the second-mode maximum operating temperature of the first heating unit and/or the second heating unit is less than 330° C., 320° C., 310° C., 300° C., 290° C., 280° C., 270° C., or 260° C. In some examples, the second-mode maximum operating temperature of the first heating unit and/or the second heating unit is greater than 200° C., 220° C., 230° C., 245° C., 250° C., 255° C., 260° C., 265° C., or 270° C. In some examples, the second-mode maximum operating temperature of the first heating unit and/or the second heating unit is from 250° C. to 300° C., or 260° C. to 290° C. In one embodiment, the second-mode maximum operating temperature of the first heating unit may be from 260° C. to 300° C., or 270° C. to 290° C. In another embodiment, the second-mode maximum operating temperature of the first heating unit may be from 250° C. to 280° C. In one embodiment, the second-mode maximum operating temperature of the second heating unit may be from 240° C. to 280° C., or 250° C. to 270° C. In another embodiment, the second-mode maximum operating temperature of the second heating unit may be from 220° C. to 260° C. A lower maximum operating temperature may reduce the amount of undesirable condensate provided in the device in use. The inventors have identified that a lower maximum operating temperature of the second heating unit may in particular help to reduce the amount of undesirable condensate which collects in the device in use.

The relationship between maximum operating temperatures of the various heating units across different modes may be expressed in ratios. For example, in some embodiments, there is a ratio between the first-mode maximum operating temperature of the first heating unit and the first-mode maximum operating temperature of the second heating unit. Where the first-mode maximum operating temperature of the first heating unit is 250° C. and the first-mode maximum operating temperature of the second heating unit is also 250° C., then the ratio between the first-mode maximum operating temperatures of the first and second heating units is 1:1.

For simplicity, such ratios may be abbreviated. For example, the ratio between the first-mode maximum operating temperatures of the first (1^{st}) and second (2^{nd}) heating units may be shown as FMMOTₕ₁:FMMOTₕ₂. Similarly, the ratio between the second-mode maximum operating temperatures of the first (1^{st}) and second (2^{nd}) heating units may be shown as SMMOTₕ₁:SMMOTₕ₂.

In some embodiments, the ratio FMMOTₕ₁:FMMOTₕ₂ and/or the ratio SMMOTₕ₁:SMMOTₕ₂ is from 1:1 to 1.2:1.

In some embodiments, the ratio FMMOTₕ₁:FMMOTₕ₂ is substantially the same as the ratio SMMOTₕ₁:SMMOTₕ₂. In preferred embodiments, the ratio FMMOTₕ₁:FMMOTₕ₂ is different from the ratio SMMOTₕ₁:SMMOTₕ₂.

In a preferred embodiment, the ratio FMMOTₕ₁:FMMOTₕ₂ is approximately 1:1. In another preferred embodiment, the ratio SMMOTₕ₁:SMMOTₕ₂ is from 1.01:1 to 1.2:1. Preferably, the ratio SMMOTₕ₁:SMMOTₕ₂ is from 1.05:1 to 1.15:1.

In another preferred embodiment, both FMMOTₕ₁:FMMOTₕ₂ and SMMOTₕ₁:SMMOTₕ₂ are approximately 1:1. That is, in some embodiments, the maximum temperatures of the first and second heating units in the first mode of operation are substantially the same, and the maximum temperature of the first and second heating units in the second mode of operation are substantially the same. Configuring the heating assembly in this manner may further help to reduce the amount of condensate which collects in an external-heating device.

In a further embodiment, the respective maximum temperatures of each heating unit present in the heating assembly are the same in the first mode of operation, and the same in the second mode of operation.

There is also a ratio between the first-mode maximum operating temperature and the second-mode maximum operating temperature of each heating unit. In some examples, the ratio FMMOTₕ₁:SMMOT ₕ₁ and/or the ratio FMMOTₕ₂:SMMOTₕ₂ is from 1:1 to 1:1.2.

In a preferred embodiment, the ratio FMMOTₕ₁:SMMOTₕ₁ is from 1:1.1 to 1:1.2. In another preferred embodiment, the ratio FMMOTₕ₂:SMMOTₕ₂ is from 1:1 to 1:1.1.

As discussed hereinabove, in some embodiments each mode of operation of the heating assembly may be associated with a predetermined duration for a session of use (i.e. a predetermined duration for a session of use). In some embodiments, the session of use duration associated with at least one mode differs from the session of use duration(s) associated with other modes. In some embodiments, each mode may be associated with different predetermined durations of session of use. In particular, the first mode may be associated with a first session of use duration, and the second mode may be associated with a second session of use duration. The first session of use duration may differ from the second session of use duration. Preferably, the first session of use duration is longer than the second session of use duration. In some examples, the first and/or second session of use may have a duration of at least 2 minutes, 2 minutes 30 seconds, 3 minutes, 3 minutes 30 seconds, 4 minutes, 4 minutes 30 seconds, 5 minutes, 5 minutes 30 seconds, or 6 minutes. In some examples, the first and/or second session of use may have a duration of less than 7 minutes, 6 minutes, 5 minutes 30 seconds, 5 minutes, 4 minutes 30 seconds, or 4 minutes. Preferably, the first session of use has a duration of from 3 minutes to 5 minutes, more preferably from 3 minutes 30 seconds to 4 minutes 30 seconds. Preferably, the second session of use has a duration of from 2 minutes to 4 minutes, more preferably from 2 minutes 30 seconds to 3 minutes 30 seconds.

Preferably, at least one of the heating units present in the heating assembly operates substantially at its maximum operating temperature for the majority of a session of use. For example, at least one of the heating units operates substantially at its maximum operating temperature for at least 60%, 70%, 80%, or 90% of the session of use. In a particularly preferred embodiment, the first heating unit operates substantially at its maximum operating temperature for at least 50%, preferably 60% of the session of use. In embodiments wherein the heating assembly is operable in a plurality of modes, the heating assembly may be configured such that the first heating unit operates substantially at its maximum operating temperature for at least 50%, preferably 60% of the session of use in at least one mode. Preferably, the heating assembly is configured such that the first heating unit operates substantially at its maximum operating temperature for at least 50%, preferably 60% of the session of use in each mode.

As discussed hereinabove, in some embodiments, at least one of the heating units provided in the heating assembly is an induction heating unit. In these embodiments, the heating unit comprises an inductor (for example, one or more inductor coils), and the device will comprise a component for passing a varying electrical current, such as an alternating current, through the inductor. The varying electric current in the inductor produces a varying magnetic field. When the inductor and the heating element are suitably relatively positioned so that the varying magnetic field produced by the inductor penetrates the heating element, one or more eddy currents are generated inside the heating element. The heating element has a resistance to the flow of electrical currents, so when such eddy currents are generated in the object, their flow against the electrical resistance of the object causes the object to be heated by Joule heating. Supplying a varying magnetic field to a susceptor may conveniently be referred to as supplying energy to a susceptor.

Where the heating assembly comprises first and second induction units, the first and second induction heating units are preferably controllable independent from each other. Heating the aerosol-generating material with independent induction heating units may advantageously provide more accurate control of heating of the aerosol-generating material. Independently controllable induction heating units may also provide thermal energy differently to each portion of the aerosol-generating material, resulting in differing temperature profiles across portions of the aerosol-generating material. In particular embodiments, the first and second induction heating units are configured to have temperature profiles which differ from each other in use. This may provide asymmetrical heating of the aerosol-generating material along a longitudinal plane between the mouth end and the distal end of the device when the device is in use.

An object that is capable of being inductively heated is known as a susceptor. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application. The heating element may be a susceptor. In preferred embodiments, the susceptor comprises a plurality of heating elements—at least a first induction heating element and a second induction heating element.

In other embodiments, the heating units are not limited to induction heating units. For example, the first heating unit may be an electrical resistance heating unit which may consist of a resistive heating element. The second heating unit may additionally or alternatively be an electrical resistance heating unit which may consist of a resistive heating element. By “resistive heating element”, it is meant that on application of a current to the element, resistance in the element transduces electrical energy into thermal energy which heats the aerosol-generating substrate. The heating element may be in the form of a resistive wire, mesh, coil and/or a plurality of wires. The heat source may be a thin-film heater.

The heating element may comprise a metal or metal alloy. Metals are excellent conductors of electricity and thermal energy. Suitable metals include but are not limited to: copper, aluminum, platinum, tungsten, gold, silver, and titanium. Suitable metal alloys include but are not limited to: nichrome and stainless steel.

In examples, the aerosol-generating device is configured such that each mode of operation is selectable by a user. The user can select a mode of operation by interacting with one or more user interfaces. Aspects of the present invention provide an aerosol-generating device wherein a user may select a mode of operation in a simple or intuitive manner. Moreover, aspects of the present invention provide an aerosol-generating device which may provide different user experiences based on user demand.

The user selects a desired mode of operation by interacting with one or more user interfaces. In some examples, the device may comprise a user interface for each possible mode of operation. For example, the device may comprise a first actuator associated with a first mode of operation, a second actuator associated with a second mode of operation, and so on. Each user interface may be configured to send a distinguishable signal to the controller. The user may select the desired mode of operation by actuating the user interface associated with that mode of operation. The actuated user interface sends its corresponding signal to the controller, and the controller instructs the at least one heater to operate according to the predetermined heating profile associated with the selected mode.

Preferably, though, each mode of operation is selectable from a single interface. This embodiment advantageously simplifies operation of the device for a user. In this embodiment, the user interface must be capable of providing a plurality of distinguishable signals to the controller of the heating assembly from a single input means. That is, the device must be configured to differentiate different user inputs communicated via a single user interface. The user interface is configured such that when a user interacts with the user interface in a first manner, the user interface detects the interaction and sends a signal to the controller of the heating assembly, wherein the signal indicates a first mode of operation has been selected. When a user interacts with the user interface in a second manner, different from the first manner, the user interface detects the interaction and sends a signal to the controller, wherein the signal indicates that a second mode of operation has been selected. This may be applied to any number of modes of operation, such as three, four, five, or more modes of operation.

In one embodiment, the user interface may also be configured for activating the device. That is, the user interface may be configured such that the user can switch on the device by interacting with the user interface, as well as selecting a mode of operation. This embodiment advantageously simplifies operation of the device for a user.

Alternatively, the aerosol-generating device may comprise the user interface for selecting the desired mode of operation, and an actuator for activating the device, wherein the actuator is arranged apart from the user interface.

Suitable user interfaces of the present aerosol-generating device comprise, for example, mechanical switches, inductive switches, or capacitive switches. Where the user interface comprises a mechanical switch, the mechanical switch may be selected from a biased switch (such as a push button), a rotary switch, a toggle switch, or a slide switch, for example. In a preferred embodiment, the user interface comprises a push button.

The user interface may receive user input in different ways. For example, the user may interact with the user interface by contacting the user interface. Contacting the user interface may include pressing the user interface. Activation of some user interfaces can result in travel of at least part of the user interface. For example, actuating a biased switch may include depressing a part of the user interface (push button); actuating a rotary switch may include turning a part of the user interface; actuating a toggle switch may comprise positioning a part of the user interface in a predetermined position; actuating a slide switch may include sliding a part of the user interface to position the part in a predetermined position.

In one embodiment, a mode of operation is selectable based on the duration of user interaction with the user interface. For example, a first mode of operation is selectable by activating the user interface for a first duration, and a second mode of operation is selectable by activating the user interface for a second duration, different from the first duration.

The user interface detects that the user has activated the user interface for a first duration or a second duration, and sends a signal to the controller identifying that the first mode or second mode of operation has been selected, respectively.

This embodiment may be preferred where the user interface comprises a push button, an inductive switch, or a capacitive switch.

Each duration of activation associated with a selectable mode may have any suitable duration. In some examples, at least one of the durations is from 1 to 10 seconds. In some examples, each duration is from 1 second to 10 seconds. For example, in an embodiment wherein the heating assembly is operable in at least two modes, the first duration associated with the first mode and the second duration associated with the second mode has a duration of from 1 second to 10 seconds.

The second duration may be longer than the first duration, or shorter than the first duration. Preferably, the second duration is longer than the first. In a preferred embodiment, the first duration is from 1 to 5 seconds, preferably 2 to 4 seconds. In a preferred embodiment, the second duration is from 2 seconds to 10 seconds, preferably 4 to 6 seconds. In a particularly preferred embodiment, the first duration is from 2 to 4 seconds, suitable 3 seconds, and the second duration is from 4 to 6 seconds, suitable 5 seconds.

In a particular embodiment, the first mode of operation is selectable by interacting with the user interface for a first duration, and the second mode is selectable by interacting with the user interface for a second duration. Selection of the second mode may be achieved after selection of the first mode. That is, after selection of the first mode, the user may continue to interact with the user interface until the second duration has been reached, thereby selecting the second mode.

In a particular embodiment, the user interface comprises a push button. The user interface is configured such that the first mode is selected by the user depressing the push button for a first duration (such as approximately three seconds). The second mode is selected by the user depressing the push button for a different, second duration (such as approximately five seconds). The user interface is configured such that the signal sent to the controller after the first duration depression (three-second depression) indicates selection of the first mode, and the signal sent to the controller after the second duration depression (five-second depression) indicates selection of the second mode.

Preferably, the push button of this embodiment is also configured to activate the aerosol-generating device. For example, as soon as the push button is depressed, the device is activated. The user can then keep the push button depressed for the first duration to select the first mode, or the second duration of the second mode.

In another embodiment, a mode of operation may be selectable based on the number of activations of the user interface. For example, a first mode of operation may be selectable by activating the user interface a first number of instances, and the second mode of operation may be selectable by activating the user interface a second number of instances, the second number being different from the first.

The user interface detects that the user has activated the user interface a first number of instances or a second number of instances, and sends a signal to the controller identifying that the first mode or second mode of operation has been selected, respectively.

This embodiment may be preferred where the user interface comprises a push button, an inductive switch, or a capacitive switch.

The second number of instances may be greater than the first number, or less than the first number. Preferably, the second number of instances is greater than the first. In a preferred embodiment, the first mode is selectable by a single activation of the user interface. In a preferred embodiment, the second mode is selectable by a plurality of activations of the user interface, such as two, three or four activations. Preferably the second mode is selectable be activating the user interface twice. Where a mode is selectable by a plurality of activations, the user interface may be configured such that the activations must occur within a particular period of time to register as a plurality of activations. This may be preferred so that the user interface can more effectively differentiate a single activation from a plurality of activations. In these embodiments, the user interface may be configured such that in a plurality of activations each activation must occur within 1000 ms, 500 ms, 400 ms, 300 ms, 200 ms, 100 ms, or 50 seconds of the previous activation to be detected as a plurality of activations.

In a particular embodiment, the user interface comprises a push button. The user interface is configured such that the first mode is selected by the user depressing the push button once. The second mode is selected by the user depressing the push button a plurality of times (such as twice). The user interface is configured such that the signal sent to the controller after a single depression indicates selection of the first mode, and the signal sent to the controller after a plurality of depressions (a double depression) indicates selection of the second mode.

Preferably, the push button of this embodiment is also configured to activate the aerosol-generating device. For example, a single depression of the push button may activate the device as well as select the first mode. The user can then depress the push button again to select the second mode. In this example, the first mode may be referred to as the “default” mode. Where the second mode is associated with a hotter and/or quicker heating profile of at least one of the heating units, the second mode may be referred to as a “boost” mode.

In another example, a single depression of the push button activates the device. Then, a further single activation selects the first mode, or a further plurality of activations selects the second mode. In this example, none of the operable modes is necessarily defined as a default mode. The desired mode must be selected each time the aerosol-generating device is activated

In another embodiment, the user interface comprises a slide switch. Each mode of operation of the heating assembly may be selectable based on the position of the slide switch. For example, a first mode of operation may be selectable by positioning the slide switch in a first position, and the second mode of operation may be selectable by positioning the slide switch in a second position, the second position different from the first.

The user interface detects that the user has positioned the slide switch in a first position or a second position, and sends a signal to the controller identifying that the first mode or second mode of operation has been selected, respectively.

Preferably, the slide switch of this embodiment is also configured to activate the aerosol-generating device. For example, positioning the switch in the first position may activate the device as well as select the first mode. The user can then move the switch to the second position to select the second mode. In this example, the first mode may be referred to as the “default” mode. Where the second mode is associated with a hotter and/or quicker heating profile of at least one of the heating units, the second mode may be referred to as a “boost” mode.

In another example, positioning the slide switch in a third position, different from the first and second positions, activates the device. Then, positioning the switch in either the first position or second position selects the first or second mode respectively. In this example, none of the operably modes is necessarily defined as a default mode. The desired mode must be selected each time the aerosol-generating device is activated.

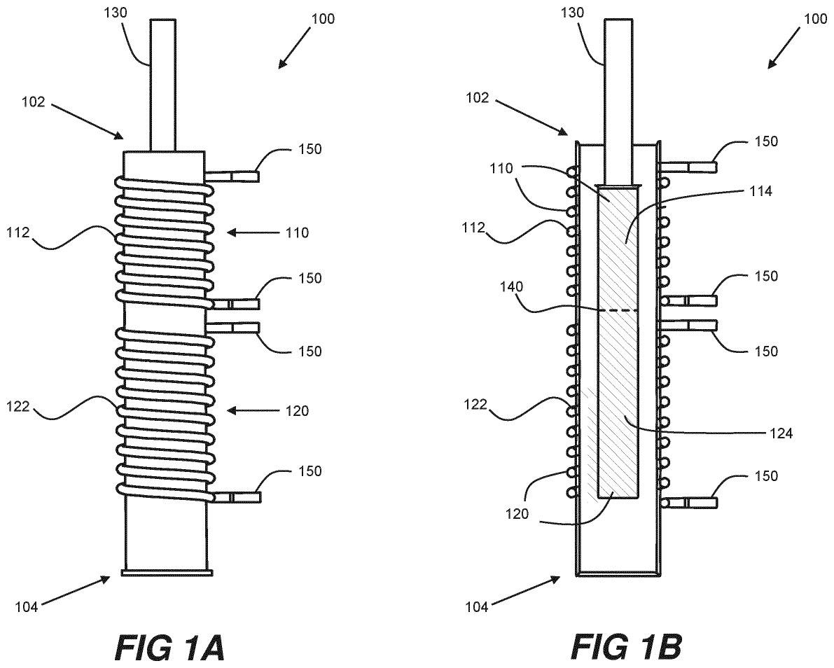

In a particularly preferred embodiment, the slide switch forms a movable cover for selectively covering an opening of a receptacle disposed in the aerosol-generating device, the receptacle being configured to receive a smoking article. A suitable cover is shown as cover 150 in FIG. 1, discussed hereinbelow.

Aspects of the present invention relate to a method of operating an aerosol-generating device. The method comprises receiving a signal from the user interface, and identifying a selected mode of operation which is associated with the received signal. For example, the signal and selected mode of operation may be stored in a look-up table; the received signal may be compared with the look-up table, and the selected mode of operation identified. The method then comprises instructing at least one heating unit of the heating assembly to operate according to a predetermined heating profile based on the selected mode of operation. The method is preferably carried out by the controller of the heating assembly. Suitable embodiments of this aspect are described above with respect to the aerosol-generating device. Methods of operating an aerosol-generating device as described above in relation to the configuration of the device are expressly disclosed herein.

According aspects of the present invention, there is provided an aerosol-generating device comprising a heating assembly including a first heating unit arranged to heat, but not burn, the aerosol-generating material in use, and a controller to control the first heating unit. The heating assembly is operable in at least a first mode and a second mode. The device comprises an indicator for indicating the selected mode to a user.

It has been found by the inventors that it is advantageous to indicate to a user which mode of operation has been selected. In particular, indicating the selected mode while the device “ramps up” to be ready for the first puff means that a user can confirm that the device has initiated in the correct mode before taking a first puff.

The indicator may be configured to indicate the selected mode by being instructed to indicate the selected mode of operation. For example, the controller of the heating assembly may receive a signal associated with the selected mode, and identify the selected mode of operation which is associated with the received signal. For example, the signal and selected mode of operation may be stored in a look-up table; the received signal may be compared with the look-up table, and the selected mode of operation identified. The controller may then instruct the indicator to indicate the selected mode of operation. Methods of indicating the selected mode of operation as described in relation to the configuration of the device and indicator are expressly disclosed herein.

The indicator may indicate the selected mode to the user at any point during a session of use. For example, the indicator may be configured to indicate the selected mode to the user throughout an entire session of use, or a majority of a session of use. However, indicating the selected mode to a user throughout an entire or majority of a session of use may be considered unnecessary, as the user is unlikely to forget the selected mode once it has been communicated by the indicator. Moreover, indicating the selected mode throughout the entire session of use may use an unnecessarily large proportion of power and processing capabilities of the device. Accordingly, in a preferred embodiment, the indicator only indicates the selected mode to a user for a portion of a session of use which is less than an entire session of use. For example, the indicator may indicate the selected mode near the start of the session of use. Preferably, the indicator indicates the selected mode from the point at which the user selects the mode, to the point at which the device is “ready for use” (that is, the point in a session of use at which the device can provide an acceptable inhalable aerosol to a user).

The indicator preferably further indicates to the user when the device is ready for use. The device may be configured to indicate that the device is ready for use within 30 seconds of activation of the device, or 25 seconds, or 20 seconds, or 15 seconds, or 10 seconds. The device may be configured to indicate that the device is ready for use within 30 seconds of selecting the desired mode of operation, or 25 seconds, or 20 seconds, or 15 seconds, or 10 seconds, or 5 seconds.

More preferably still, the indicator indicates to the user that the session of use will soon end. For example, the device may be configured such that the indicator indicates to the user that the session will end 30 seconds, or 20 seconds, or 10 seconds from indication.

Preferably, the indicator indicates the user that the session of use has ended. Indicating the end of a session of use may comprise deactivating components of the indicator.

In a particularly preferred embodiment, the device is configured to indicate the selected mode from the point at which the user selects the mode to the point at which the device is ready for use, to indicate when the device is ready for use, to indicate that the session of use will soon end, and to indicate that the session of use has ended.

The indicator may indicate to the user by any sensory cue. For example, the indicator may indicate the selected mode via visual, auditory, and/or haptic cues. Further, the indicator may indicate that the device is ready for use, or that a session of use will soon end, via visual, auditory, and/or haptic cues.

The indicator may be configured to provide a visual indication of the selected mode; the indicator may comprise a visual indicator component. In one embodiment, the indicator may comprise a display screen to indicate the selected mode. “Display screen” in this context refers to a full-area 2-dimensional display (also referred to as a video display). For example, the indicator may comprise a liquid-crystal display (LCD), light-emitting diode display (LED) such as OLED or AMOLED, plasma display (PDP), or quantum dot display (QLED), which may indicate the selected mode with, for example, text indicating the selected mode. However, a display screen may be prone to scratching or failure in use. Moreover, this means of indication may be found to be complicated by a user. Therefore, the indicator preferably does not comprise a display screen.

In another embodiment, the visual indicator comprises at least one light source. A “light source” refers to a single source of light, or a plurality of sources of light which are only operable as one (i.e. the sources of light are not operable independently) and thereby form a single “light source”. Thus, a single light source may have a shape, formed by an arrangement of a plurality of jointly-operable sources of light.

The visual indicator may comprise a plurality of light sources, wherein each light source is independently operable. In these embodiments, the indicator may be configured to indicate the selected mode by selective activation of the light sources. The indicator may preferably comprise one or more LEDs.

In one example, the visual indicator comprises a plurality of light sources capable of indicating the selected mode by color. For example, the indicator may comprise a combination of different colored LEDs. The LEDs may be provided in separate cases, or in a single case (such as a bi-color or tri-color LED). The LEDs may be configured to provide light of any wavelength, provided that the color for indicating each mode is visually discernible by a human user. The indicator may indicate selection of a first mode by activating one or more light sources to provide light of a first wavelength, and indicate selection of a second mode by activating one or more light sources to provide light of a second wavelength, different from the first wavelength. For example, the indicator may indicate selection of a first mode by selectively activating a red-light source, and a second mode by selectively activating a blue-light source. In a preferred embodiment, the visual indicator comprises a red LED, a green LED, and/or a blue LED.

Additionally, or alternatively, the indicator may be configured to indicate the selected mode by selectively activating a plurality of light sources disposed across a surface of the aerosol-generating device. For example, the light sources may be arranged in a particular pattern or configuration, and selectively activating or deactivating particularly light sources in the pattern or configuration may be used to indicate the selected mode. In particular, a sequence of selectively activating and deactivating light sources may be associated with each selectable mode. In a particularly preferred embodiment, the sequence comprises intermittently activating at least one of the light sources during indication of the selected mode. Advantageously, intermittent activation of at least one light source may also indicate to the user that the device is continuing to operate.

The light sources may be arranged in any suitable pattern or configuration. For example, the light sources may be arranged to form a shape. In particular, they may be arranged to define a perimeter of a shape. The shape may be, for example, a regular polygon. The shape may be elliptical (including ovular and circular), triangular, quadrilateral such as rectangular (including square), obround, pentagonal, hexagonal, and so on. In a preferred embodiment, the shape is elliptical. In a particularly preferred embodiment, the shape is circular.

The indicator may be configured to provide a haptic indication of the selected mode; the indicator may comprise a haptic indicator component. In one embodiment, the haptic indicator comprises a vibration motor. The vibration motor may be any suitable vibration motor. For example, the vibration motor may be an eccentric rotating mass vibration motor, or a linear resonant actuator. In some embodiments, the vibrating motor is a permanent magnet motor. For example, the vibration motor may be a coin permanent magnet motor, or a pancake permanent magnet motor.

In one embodiment, the indicator may be configured to indicate selection of a mode of operation by activating the vibration motor for different durations. For example, a first mode of operation may be indicated by activating the vibration motor for a first duration, and a second mode of operation may be indicated by activating the vibration motor for a second duration, different from the first duration.

Each duration of activation associated with a mode of operation may have any suitable duration. In some examples, at least one of the durations is from 10 ms to 2000 ms. In some examples, each duration is from 10 ms to 2000 ms. For example, in an embodiment wherein the heating assembly is operable in at least two modes, the first duration associated with the first mode and the second duration associated with the second mode has a duration of from 10 ms to 2000 ms.

The second duration may be longer than the first duration, or shorter than the first duration. Preferably, the second duration is longer than the first.

In another embodiment, the indicator may be configured to indicate selection of a mode of operation by activating the vibration motor for different numbers of instances. An instance of activation of a vibration motor may suitably be referred to as a “pulse”. For example, a first mode of operation may be indicated by activating the vibration motor a first number of pulses, and the second mode of operation may be indicated by activating the vibration motor for a second number of pulses, the second number being different from the first.

The second number of pulses may be greater than the first number, or less than the first number. Preferably, the second number of pulses is greater than the first. In a preferred embodiment, the first mode is indicated by a single pulse. In a preferred embodiment, the second mode is indicated by a plurality of pulses, such as two, three or four pulses. Preferably the second mode is indicated be two pulses.

The indicator may comprise both a visual indicator component and a haptic indicator component. Preferably, the indicator is configured to provide both visual and haptic indication of the selected mode for at least one of the selectable modes. More preferably, the indicator is configured to provide both visual and haptic indication of the selected mode for each selectable mode. Suitably, the indicator may be configured according to any combination of the visual and haptic embodiments described hereinabove.

In a particularly preferred embodiment, the device and indicator are configured to indicate the first mode via a first sequence of activation of light sources and a single activation of a vibration motor, and the second mode via a second sequence of activation of light sources different from the first sequence and a double activation of the vibration motor.

The indicator may be configured to provide an auditory indication of the selected mode; the indicator may comprise an auditory indicator component. For example, the indicator may comprise an electromechanical audio signaling device, a mechanical audio signaling device, or a piezoelectric signaling device. Preferably, an auditory indicator comprises a piezoelectric signaling device. The auditory indicator may indicate the selected mode in any suitable manner, such as any of the duration or instance embodiments described hereinabove in relation to haptic indicators.

The indicator may comprise both an auditory indicator component and a visual indicator component and/or a haptic indicator component. The indicator may be configured to provide both visual and auditory indication of each selected mode, or haptic and auditory indication of each selected mode, or visual, haptic and auditory indication of each selected mode. Suitably, the indicator may be configured according to any combination of the visual, haptic and auditory embodiments described hereinabove.

The indicator may be provided as a single unit. Alternatively, the components of the indicator may be provided in different locations in the device. For example, the indicator may comprise a visual indicator component disposed in a surface of the housing of the device (optionally comprising portions inside the housing as well as on the surface of the housing) and a haptic indicator component disposed entirely inside the housing of the device.

Preferably, the aerosol-generating device comprises both a user interface for selecting a mode of operation, and an indicator for indicating the mode of operation. However, an aspect of the present disclosure relates to an aerosol-generating device comprising an indicator for indicating a selected mode of operation, but does not necessarily include the user interface described hereinabove. Another aspect of the present disclosure relates to an aerosol-generating device comprising a user interface for selecting a mode of operation, but does not necessarily include the indicator described hereinabove.

Aspects of the present invention relate to an aerosol-generating device comprising a heating assembly including a first heating unit arranged to heat, but not burn, the aerosol-generating material in use, and a controller to control the first heating unit. The heating assembly is operable in at least a first mode and a second mode. The heating assembly is configured such that the first mode and second mode are selectable by a user before a session of use and/or during a first portion of a session of use, and the selected mode cannot be changed by the user during a second portion of the session of use.

It has been found by the inventors that it may be advantageous to limit the points at which the mode of operation can be selected. The modes of operation of the device may be predetermined to provide the user with an optimized session of use. For example, the modes may be programmed for particular power usage, or to achieve a particular rate of consumption of volatile material from an aerosol-generating article. Changing the mode of operation during a session of use may be found to provide an inferior user experience. Thus, the present aspect which limits when a user can select a mode of operation may better ensure user-satisfaction, better management of aerosol-generating material resources, and/or better management of power storage/usage.

It may be advantageous to prohibit a user from changing the mode of operation once volatile material begins to be liberated from the aerosol-generating article disposed in the device.

As defined hereinabove, a session of use starts when power is first supplied to a heating unit in the heating assembly. The device may be configured such that the user may select a mode of operation before power is supplied to any heating units in the heating assembly.

Preferably, the device is configured such that the user may select a mode of operation during a first portion of the session of use which begins at the start of the session of use.

In a particular embodiment, the first mode of operation is selectable by interacting with the user interface for a first duration, and the second mode is selectable by interacting with the user interface for a second duration. Selection of the second mode may be achieved after selection of the first mode. That is, after selection of the first mode, the user may continue to interact with the user interface until the second duration has been reached, thereby selecting the second mode.

In some embodiments, the session of use begins when the first mode of operation is selected. In the example given above, power begins to be supplied once the user has interacted with the user interface for a first duration.

In a particularly preferred embodiment, the first portion of the session of use during which the user can select the mode of operation ends when a user terminates interaction with the user interface. For example, when the user interface is configured such that the user interacts with the user interface by depressing a portion of the user interface, the first portion of the session of use may end when the user terminates depression of the user interface. Put another way, in this embodiment, the user cannot re-select the mode of operation once the user stops selecting the mode of operation, until the end of the session of use. Preferably, the mode is selectable before each session of use.

In some embodiments, the first portion of the session of use ends at or before the point at which the first heating unit reaches an operating temperature. The second portion during which the user cannot change the selected mode may begin at or after the point at which the first heating unit reaches an operating temperature.

In some embodiments, the first portion of the session of use ends at or before the point at which the first heating unit reaches a maximum operating temperature. The second portion may begin at or after the point at which the first heating unit reaches a maximum operating temperature.

In some embodiments, the first portion of the session of use ends at or before the point at which the device can provide an acceptable first puff to a user. The second portion may begin at or after the point at which the device can provide an acceptable first puff to a user.

In some embodiments, the first portion of the session of use ends at or before the point at which the device indicates to the user that the device is ready for use. The second portion may begin at or after the point at which the device indicates to the user that the device is ready for use.

In some embodiments, the first portion of the session of use ends between 5 and 20 seconds after the beginning of the session of use.

In some embodiments, the second portion of the session of use ends with the end of the session of use.

Another aspect of the present invention is an aerosol-generating system comprising an aerosol-generating device as described herein in combination with an aerosol-generating article. In a preferred embodiment, the aerosol-generating system comprises a tobacco heating product in combination with an aerosol-generating article comprising tobacco. In suitable embodiments the tobacco heating product may comprise the heating assembly and aerosol-generating article described in relation to the figures hereinbelow.

Another aspect of the present invention is a method of providing an aerosol with an aerosol-generating device of the present disclosure. The method comprises controlling the or each heating unit in the heating assembly as described herein.

The invention will now be described with specific reference to the figures.

FIG. 1A shows an induction heating assembly 100 of an aerosol-generating device according to the present invention; FIG. 1B shows a cross section of the induction heating assembly 100 of the device.

The heating assembly 100 has a first or proximal or mouth end 102, and a second or distal end 104. In use, the user will inhale the formed aerosol from the mouth end of the aerosol-generating device. The mouth end may be an open end.

The heating assembly 100 comprises a first induction heating unit 110 and a second induction heating unit 120. The first induction heating unit 110 comprises a first inductor coil 112 and a first heating element 114. The second induction heating unit 120 comprises a second inductor coil 122 and a second heating element 124.

FIGS. 1A and 1B show an aerosol-generating article 130 received within a susceptor 140. The susceptor 140 forms the first induction heating element 114 and the second induction heating element 124. The susceptor 140 may be formed from any material suitable for heating by induction. For example, the susceptor 140 may comprise metal. In some embodiments, the susceptor 140 may comprise non-ferrous metal such as copper, nickel, titanium, aluminum, tin, or zinc, and/or ferrous material such as iron, nickel or cobalt. Additionally or alternatively the susceptor 140 may comprise a semiconductor such as silicon carbide, carbon or graphite.

Each induction heating element present in the aerosol-generating device may have any suitable shape. In the embodiment shown in FIG. 1B, the induction heating elements 114, 124 define a receptacle to surround an aerosol-generating article and heat the aerosol-generating article externally. In other embodiments (not shown), one or more induction heating elements may be substantially elongate, arranged to penetrate an aerosol-generating article and heat the aerosol-generating article internally.

As shown in FIG. 1B, the first induction heating element 114 and second induction heating element 124 may be provided together as a monolithic element 140. That is, in some embodiments, there is no physical distinction between the first 114 and second 124 heating elements. Rather, the differing characteristics between the first and second heating units 110, 120 are defined by separate inductor coils 112, 122 surrounding each induction heating element 114, 124, so that they may be controlled independently from each other. In other embodiments (not depicted), physically distinct inductive heating elements may be employed.

The first and second inductor coils 112, 122 are made from an electrically conducting material. In this example, the first and second inductor coils 112, 122 are made from Litz wire/cable which is wound in a helical fashion to provide helical inductor coils 112, 122. Litz wire comprises a plurality of individual wires which are individually insulated and are twisted together to form a single wire. Litz wires are designed to reduce the skin effect losses in a conductor. In the example induction heating assembly 100, the first and second inductor coils 124, 126 are made from copper Litz wire which has a circular cross section. In other examples the Litz wire can have other shape cross sections, such as rectangular.

The first inductor coil 112 is configured to generate a first varying magnetic field for heating the first induction heating element 114, and the second inductor coil 122 is configured to generate a second varying magnetic field for heating a second section of the susceptor 124. The first inductor coil 112 and the first induction heating element 114 taken together form a first induction heating unit 110. Similarly, the second inductor coil 122 and the second induction heating element 124 taken together form a second induction heating unit 120.

In this example, the first inductor coil 112 is adjacent to the second inductor coil 122 in a direction along the longitudinal axis of the device heating assembly 100 (that is, the first and second inductor coils 112, 122 do not overlap). The susceptor arrangement 140 may comprise a single susceptor. Ends 150 of the first and second inductor coils 112, 122 can be connected to a controller such as a PCB (not shown). In preferred embodiments, the controller comprises a PID controller (proportional integral derivative controller).

The varying magnetic field generates eddy currents within the first inductive heating element 114, thereby rapidly heating the first induction heating element 114 to a maximum operating temperature within a short period of time from supplying the alternative current to the coil 112, for example within 20, 15, 12, 10, 5, or 2 seconds. Arranging the first induction heating unit 110 which is configured to rapidly reach a maximum operating temperature closer to the mouth end 102 of the heating assembly 100 than the second induction heating unit 120 may mean that an acceptable aerosol is provided to a user as soon as possible after initiation of a session of use.

It will be appreciated that the first and second inductor coils 112, 122, in some examples, may have at least one characteristic different from each other. For example, the first inductor coil 112 may have at least one characteristic different from the second inductor coil 122. More specifically, in one example, the first inductor coil 112 may have a different value of inductance than the second inductor coil 122. In FIGS. 1A and 1B, the first and second inductor coils 112, 122 are of different lengths such that the first inductor coil 112 is wound over a smaller section of the susceptor 140 than the second inductor coil 122. Thus, the first inductor coil 112 may comprise a different number of turns than the second inductor coil 122 (assuming that the spacing between individual turns is substantially the same). In yet another example, the first inductor coil 112 may be made from a different material to the second inductor coil 122. In some examples, the first and second inductor coils 112, 122 may be substantially identical.

In this example, the first inductor coil 112 and the second inductor coil 122 are wound in the same direction. However, in another embodiment, the inductor coils 112, 122 may be wound in opposite directions. This can be useful when the inductor coils are active at different times. For example, initially, the first inductor coil 112 may be operating to heat the first induction heating element 114, and at a later time, the second inductor coil 122 may be operating to heat the second induction heating element 124. Winding the coils in opposite directions helps reduce the current induced in the inactive coil when used in conjunction with a particular type of control circuit. In one example, the first inductor coil 112 may be a right-hand helix and the second inductor coil 122 a left-hand helix. In another example, the first inductor coil 112 may be a left-hand helix and the second inductor coil 122 may be a right-hand helix.

The coils 112, 122 may have any suitable geometry. Without wishing to be bound by theory, configuring an induction heating element to be smaller (e.g. smaller pitch helix; fewer revolutions in the helix; shorter overall length of the helix), may increase the rate at which the induction heating element can reach a maximum operating temperature. In some embodiments, the first coil 112 may have a length of less than approximately 20 mm, less than 18 mm, less than 16 mm, or a length of approximately 14 mm, in the longitudinal direction of the heating assembly 100. Preferably, the first coil 112 may have a length shorter than the second coil 124 in the longitudinal direction of the heating assembly 100. Such an arrangement may provide asymmetrical heating of the aerosol-generating article along the length of the aerosol-generating article.

The susceptor 140 of this example is hollow and therefore defines a receptacle within which aerosol-generating material is received. For example, the article 130 can be inserted into the susceptor 140. In this example the susceptor 140 is tubular, with a circular cross section.

The induction heating elements 114 and 124 are arranged to surround the aerosol-generating article 130 and heat the aerosol-generating article 130 externally. The aerosol-generating device is configured such that, when the aerosol-generating article 130 is received within the susceptor 140, the outer surface of the article 130 abuts the inner surface of the susceptor 140. This ensures that the heating is most efficient. The article 130 of this example comprises aerosol-generating material. The aerosol-generating material is positioned within the susceptor 140. The article 130 may also comprise other components such as a filter, wrapping materials and/or a cooling structure.

The heating assembly 100 is not limited to two heating units. In some examples, the heating assembly 100 may comprise three, four, five, six, or more than six heating units. These heating units may each be controllable independent from the other heating units present in the heating assembly 100.

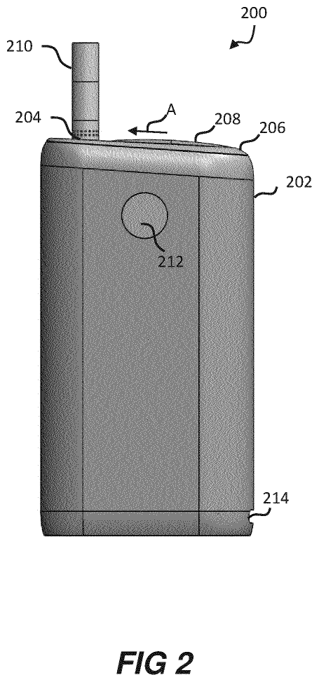

FIG. 2 shows an example of an aerosol provision device 200 for generating aerosol from an aerosol generating medium/material according to aspects of the present invention. In broad outline, the device 200 may be used to heat a replaceable article 210 comprising the aerosol generating medium, to generate an aerosol or other inhalable medium which is inhaled by a user of the device 200.

The device 200 comprises a housing 202 (in the form of an outer cover) which surrounds and houses various components of the device 200. The device 200 has an opening 204 in one end, through which the article 210 may be inserted for heating by a heating assembly. In use, the article 210 may be fully or partially inserted into the heating assembly where it may be heated by one or more components of the heater assembly. The heating assembly typically corresponds to the heating assembly 100 shown in FIGS. 1A and 1B.

The device 200 of this example comprises a first end member 206 which comprises a lid 208 which is moveable relative to the first end member 206 to close the opening 204 when no article 210 is in place. In FIG. 2, the lid 208 is shown in an open configuration, however the cap 208 may move into a closed configuration. For example, a user may cause the lid 208 to slide in the direction of arrow “A”.

The device 200 may also include a user-operable control element 212, such as a button or switch, which operates the device 200 when pressed. For example, a user may turn on the device 200 by operating the switch 212.

The device 200 may also comprise an electrical component, such as a socket/port 214, which can receive a cable to charge a battery of the device 200. For example, the socket 214 may be a charging port, such as a USB charging port. In some examples the socket 214 may be used additionally or alternatively to transfer data between the device 200 and another device, such as a computing device.

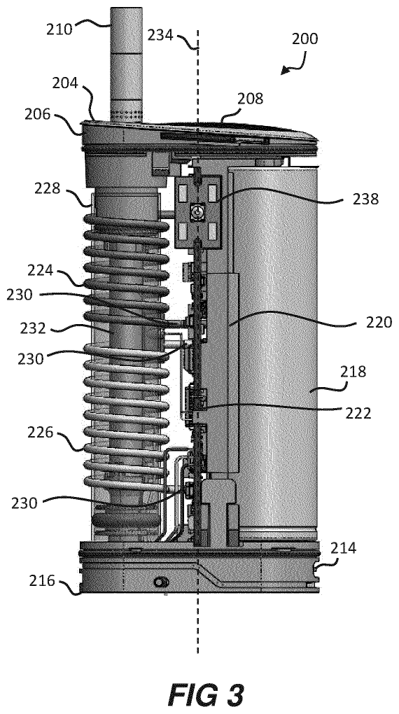

FIG. 3 depicts the device 200 of FIG. 3 with the outer cover 202 removed. The device 200 defines a longitudinal axis 234.

As shown in FIG. 3, the first end member 206 is arranged at one end of the device 200 and a second end member 216 is arranged at an opposite end of the device 200. The first and second end members 206, 216 together at least partially define end surfaces of the device 200. For example, the bottom surface of the second end member 216 at least partially defines a bottom surface of the device 200. Edges of the outer cover 202 may also define a portion of the end surfaces. In this example, the lid 208 also defines a portion of a top surface of the device 200. FIG. 3 also shows a second printed circuit board 238 associated within the control element 212.

The end of the device closest to the opening 204 may be known as the proximal end (or mouth end) of the device 200 because, in use, it is closest to the mouth of the user. In use, a user inserts an article 210 into the opening 204, operates the user control 212 to begin heating the aerosol generating material and draws on the aerosol generated in the device. This causes the aerosol to flow through the device 200 along a flow path towards the proximal end of the device 200.

The other end of the device furthest away from the opening 204 may be known as the distal end of the device 200 because, in use, it is the end furthest away from the mouth of the user. As a user draws on the aerosol generated in the device, the aerosol flows away from the distal end of the device 200.

The device 200 further comprises a power source 218. The power source 218 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 220 which holds the battery 218 in place.

The device further comprises at least one electronics module 222. The electronics module 222 may comprise, for example, a printed circuit board (PCB). The PCB 222 may support at least one controller, such as a processor, and memory. The PCB 222 may also comprise one or more electrical tracks to electrically connect together various electronic components of the device 200. For example, the battery terminals may be electrically connected to the PCB 222 so that power can be distributed throughout the device 200. The socket 214 may also be electrically coupled to the battery via the electrical tracks.

In the example device 200, the heating assembly is an inductive heating assembly and comprises various components to heat the aerosol generating material of the article 210 via an inductive heating process. Induction heating is a process of heating an electrically conducting object (such as a susceptor) by electromagnetic induction. An induction heating assembly may comprise an inductor element, for example, one or more inductor coils, and a device for passing a varying electric current, such as an alternating electric current, through the inductor element. The varying electric current in the inductor element produces a varying magnetic field. The varying magnetic field penetrates a susceptor suitably positioned with respect to the inductor element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductor heater and the susceptor, allowing for enhanced freedom in construction and application.

The induction heating assembly of the example device 200 comprises a susceptor arrangement 232 (herein referred to as “a susceptor”), a first inductor coil 224 and a second inductor coil 226. The first and second inductor coils 224, 226 are made from an electrically conducting material. In this example, the first and second inductor coils 224, 226 are made from Litz wire/cable which is wound in a helical fashion to provide helical inductor coils 224, 226. Litz wire comprises a plurality of individual wires which are individually insulated and are twisted together to form a single wire. Litz wires are designed to reduce the skin effect losses in a conductor. In the example device 200, the first and second inductor coils 224, 226 are made from copper Litz wire which has a substantially circular cross section. In other examples the Litz wire can have other shape cross sections, such as rectangular.

The first inductor coil 224 is configured to generate a first varying magnetic field for heating a first section of the susceptor 232 and the second inductor coil 226 is configured to generate a second varying magnetic field for heating a second section of the susceptor 232. Herein, the first section of the susceptor 232 is referred to as the first susceptor zone 232a or first heating element 232a, and the second section of the susceptor 232 is referred to as the second susceptor zone 232b or second heating element 232b. In this example, the first inductor coil 224 is adjacent to the second inductor coil 226 in a direction along the longitudinal axis 234 of the device 200 (that is, the first and second inductor coils 224, 226 to not overlap). In this example the susceptor arrangement 232 comprises a single susceptor comprising two zones, however in other examples the susceptor arrangement 232 may comprise two or more separate susceptors. Ends 230 of the first and second inductor coils 224, 226 are connected to the PCB 222. The first inductor coil 224 and first susceptor zone 232a may together be referred to as a first induction heating unit. The second inductor coil 226 and the second susceptor zone 232b may together be referred to as a second induction heating unit. It will be appreciated that the first and second inductor coils 224, 226, in some examples, may have at least one characteristic different from each other. For example, the first inductor coil 224 may have at least one characteristic different from the second inductor coil 226. More specifically, in one example, the first inductor coil 224 may have a different value of inductance than the second inductor coil 226. In FIG. 3, the first and second inductor coils 224, 226 are of different lengths such that the first inductor coil 224 is wound over a smaller section of the susceptor 232 than the second inductor coil 226. Thus, the first inductor coil 224 may comprise a different number of turns than the second inductor coil 226 (assuming that the spacing between individual turns is substantially the same). In yet another example, the first inductor coil 224 may be made from a different material to the second inductor coil 226. In some examples, the first and second inductor coils 224, 226 may be substantially identical.

In this example, the inductor coils 224 226 are wound in the same direction as one another. That is, both the first inductor coil 224, and the second inductor coil 226 are left-hand helices. In another example, both inductor coils 224, 226 may be right-hand helices. In yet another example (not shown), the first inductor coil 224 and the second inductor coil 226 are wound in opposite directions. This can be useful when the inductor coils are active at different times. For example, initially, the first inductor coil 224 may be operating to heat a first section of the article 210, and at a later time, the second inductor coil 226 may be operating to heat a second section of the article 210. Winding the coils in opposite directions helps reduce the current induced in the inactive coil when used in conjunction with a particular type of control circuit. In one example where the coils 224, 226 are wound in different directions (not shown) the first inductor coil 224 may be a right-hand helix and the second inductor coil 226 may be a left-hand helix. In another such embodiment, the first inductor coil 224 may be a left-hand helix and the second inductor coil 226 may be a right-hand helix.

The susceptor 232 of this example is hollow and therefore defines a receptacle within which aerosol generating material is received. For example, the article 210 can be inserted into the susceptor 232. In this example the susceptor 232 is tubular, with a circular cross section.

The device 200 of FIG. 3 further comprises an insulating member 228 which may be generally tubular and at least partially surround the susceptor 232. The insulating member 228 may be constructed from any insulating material, such as a plastics material for example. In this particular example, the insulating member is constructed from polyether ether ketone (PEEK). The insulating member 228 may help insulate the various components of the device 200 from the heat generated in the susceptor 232.

The insulating member 228 can also fully or partially support the first and second inductor coils 224, 226. For example, as shown in FIG. 3, the first and second inductor coils 224, 226 are positioned around the insulating member 228 and are in contact with a radially outward surface of the insulating member 228. In some examples the insulating member 228 does not abut the first and second inductor coils 224, 226. For example, a small gap may be present between the outer surface of the insulating member 228 and the inner surface of the first and second inductor coils 224, 226.

In a specific example, the susceptor 232, the insulating member 228, and the first and second inductor coils 224, 226 are coaxial around a central longitudinal axis of the susceptor 232.

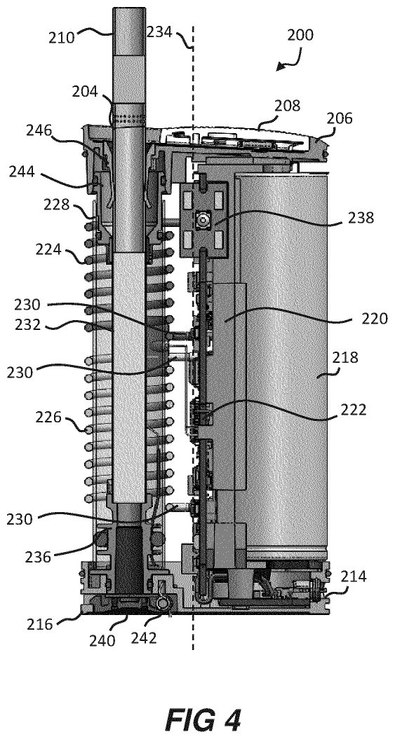

FIG. 4 shows a side view of device 200 in partial cross-section. The outer cover 202 is again not present in this example. The circular cross-sectional shape of the first and second inductor coils 224, 226 is more clearly visible in FIG. 4.

The device 200 further comprises a support 236 which engages one end of the susceptor 232 to hold the susceptor 232 in place. The support 236 is connected to the second end member 216.

The device 200 further comprises a second lid/cap 240 and a spring 242, arranged towards the distal end of the device 200. The spring 242 allows the second lid 240 to be opened, to provide access to the susceptor 232. A user may, for example, open the second lid 240 to clean the susceptor 232 and/or the support 236.

The device 200 further comprises an expansion chamber 244 which extends away from a proximal end of the susceptor 232 towards the opening 204 of the device. Located at least partially within the expansion chamber 244 is a retention clip 246 to abut and hold the article 210 when received within the device 200. The expansion chamber 244 is connected to the end member 206.

FIG. 5 is an exploded view of the device 200 of FIG. 2, with the outer cover 202 again omitted.

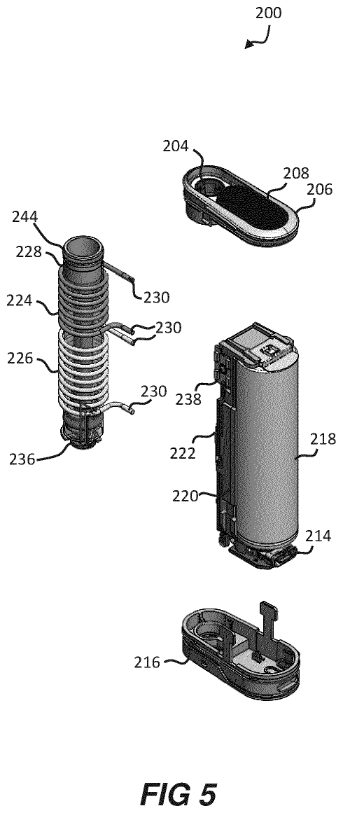

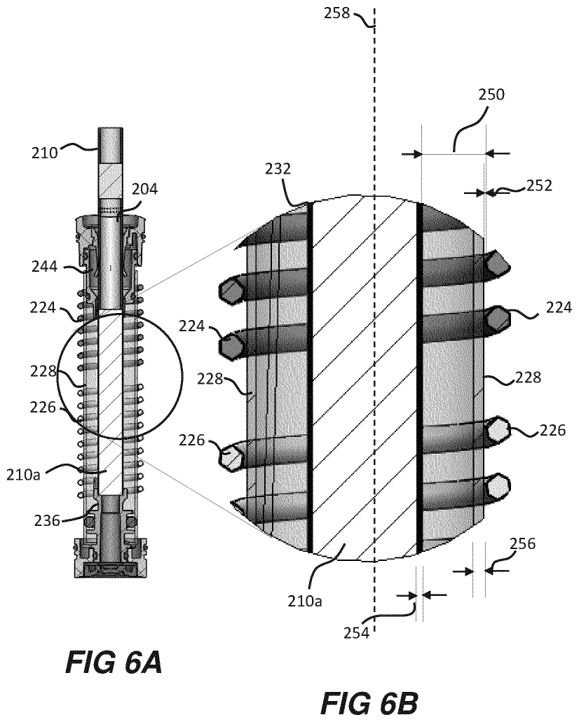

FIG. 6A depicts a cross section of a portion of the device 200 of FIG. 2. FIG. 6B depicts a close-up of a region of FIG. 6A. FIGS. 6A and 6B show the article 210 received within the susceptor 232, where the article 210 is dimensioned so that the outer surface of the article 210 abuts the inner surface of the susceptor 232. This ensures that the heating is most efficient. The article 210 of this example comprises aerosol generating material 210a. The aerosol generating material 210a is positioned within the susceptor 232. The article 210 may also comprise other components such as a filter, wrapping materials and/or a cooling structure.

FIG. 6B shows that the outer surface of the susceptor 232 is spaced apart from the inner surface of the inductor coils 224, 226 by a distance 250, measured in a direction perpendicular to a longitudinal axis 258 of the susceptor 232. In one particular example, the distance 250 is about 3 mm to 4 mm, about 3 mm to 3.5 mm, or about 3.25 mm.

FIG. 6B further shows that the outer surface of the insulating member 228 is spaced apart from the inner surface of the inductor coils 224, 226 by a distance 252, measured in a direction perpendicular to a longitudinal axis 258 of the susceptor 232. In one particular example, the distance 252 is about 0.05 mm. In another example, the distance 252 is substantially 0 mm, such that the inductor coils 224, 226 abut and touch the insulating member 228.

In one example, the susceptor 232 has a wall thickness 254 of about 0.025 mm to 1 mm, or about 0.05 mm.

In one example, the susceptor 232 has a length of about 40 mm to 60 mm, about 40 mm to 45 mm, or about 44.5 mm.

In one example, the insulating member 228 has a wall thickness 256 of about 0.25 mm to 2 mm, 0.25 mm to 1 mm, or about 0.5 mm.

As has been described above, the heating assembly of the example device 200 is an inductive heating assembly comprising various components to heat the aerosol generating material of article 210 via an induction heating process. In particular, the first inductor coil 224 and the second inductor coil 226 are used to heat respective first 232a and second 232b zones of the susceptor 232 in order to heat the aerosol generating material and generate an aerosol. Below, with reference to further figures, the operation of the device 200 in using the first and second inductor coils 224, 226 to inductively heat the susceptor arrangement 232 will be described in detail.

The inductive heating assembly of the device 200 comprises an LC circuit. An LC circuit, has an inductance L provided by an induction element, and a capacitance C provided by a capacitor. In the device 200, the inductance L is provided by the first and second inductor coils 224, 226 and the capacitance C is provided by a plurality of capacitors as will be discussed below. An induction heater circuit comprising an inductance L and a capacitance C may in some cases be represented as an RLC circuit, comprising a resistance R provided by a resistor. In some cases, resistance is provided by the ohmic resistance of parts of the circuit connecting the inductor and the capacitor, and hence the circuit need not necessarily include a resistor as such. Such circuits may exhibit electrical resonance, which occurs at a particular resonant frequency when the imaginary parts of impedances or admittances of circuit elements cancel each other.

One example of an LC circuit is a series circuit where the inductor and capacitor are connected in series. Another example of an LC circuit is a parallel LC circuit where the inductor and capacitor are connected in parallel. Resonance occurs in an LC circuit because the collapsing magnetic field of the inductor generates an electric current in its windings that charges the capacitor, while the discharging capacitor provides an electric current that builds the magnetic field in the inductor. When a parallel LC circuit is driven at the resonant frequency, the dynamic impedance of the circuit is at maximum (as the reactance of the inductor equals the reactance of the capacitor), and circuit current is at a minimum. However, for a parallel LC circuit, the parallel inductor and capacitor loop acts as a current multiplier (effectively multiplying the current within the loop and thus the current passing through the inductor). Allowing the RLC or LC circuit to operate at the resonant frequency for at least some of the time while the circuit is in operation to heat the susceptor may therefore provide for effective and/or efficient inductive heating by providing for the greatest value of the magnetic field penetrating the susceptor.

The LC circuit used by the device 200 to heat the susceptor 232 may make use of one or more transistors acting as a switching arrangement as will be described below. A transistor is a semiconductor device for switching electronic signals. A transistor typically comprises at least three terminals for connection to an electronic circuit. A field effect transistor (FET) is a transistor in which the effect of an applied electric field may be used to vary the effective conductance of the transistor. The field effect transistor may comprise a body, a source terminal S, a drain terminal D, and a gate terminal G. The field effect transistor comprises an active channel comprising a semiconductor through which charge carriers, electrons or holes, may flow between the source S and the drain D. The conductivity of the channel, i.e. the conductivity between the drain D and the source S terminals, is a function of the potential difference between the gate G and source S terminals, for example generated by a potential applied to the gate terminal G. In enhancement mode FETs, the FET may be OFF (i.e. substantially prevent current from passing therethrough) when there is substantially zero gate G to source S voltage, and may be turned ON (i.e. substantially allow current to pass therethrough) when there is a substantially non-zero gate G—source S voltage.

One type of transistor which may be used in circuitry of the device 200 is an n-channel (or n-type) field effect transistor (n-FET). An n-FET is a field effect transistor whose channel comprises an n-type semiconductor, where electrons are the majority carriers and holes are the minority carriers. For example, n-type semiconductors may comprise an intrinsic semiconductor (such as silicon for example) doped with donor impurities (such as phosphorus for example). In n-channel FETs, the drain terminal D is placed at a higher potential than the source terminal S (i.e. there is a positive drain-source voltage, or in other words a negative source-drain voltage). In order to turn an n-channel FET “on” (i.e. to allow current to pass therethrough), a switching potential is applied to the gate terminal G that is higher than the potential at the source terminal S.

Another type of transistor which may be used in the device 200 is a p-channel (or p-type) field effect transistor (p-FET). A p-FET is a field effect transistor whose channel comprises a p-type semiconductor, where holes are the majority carriers and electrons are the minority carriers. For example, p-type semiconductors may comprise an intrinsic semiconductor (such as silicon for example) doped with acceptor impurities (such as boron for example). In p-channel FETs, the source terminal S is placed at a higher potential than the drain terminal D (i.e. there is a negative drain-source voltage, or in other words a positive source-drain voltage). In order to turn a p-channel FET “on” (i.e. to allow current to pass therethrough), a switching potential is applied to the gate terminal G that is lower than the potential at the source terminal S (and which may for example be higher than the potential at the drain terminal D).

In examples, one or more of the FETs used in the device 200 may be a metal-oxide-semiconductor field effect transistor (MOSFET). A MOSFET is a field effect transistor whose gate terminal G is electrically insulated from the semiconductor channel by an insulating layer. In some examples, the gate terminal G may be metal, and the insulating layer may be an oxide (such as silicon dioxide for example), hence “metal-oxide-semiconductor”. However, in other examples, the gate may be made from other materials than metal, such as polysilicon, and/or the insulating layer may be made from other materials than oxide, such as other dielectric materials. Such devices are nonetheless typically referred to as metal-oxide-semiconductor field effect transistors (MOSFETs), and it is to be understood that as used herein the term metal-oxide-semiconductor field effect transistors or MOSFETs is to be interpreted as including such devices.

A MOSFET may be an n-channel (or n-type) MOSFET where the semiconductor is n-type. The n-channel MOSFET (n-MOSFET) may be operated in the same way as described above for the n-channel FET. As another example, a MOSFET may be a p-channel (or p-type) MOSFET, where the semiconductor is p-type. The p-channel MOSFET (p-MOSFET) may be operated in the same way as described above for the p-channel FET. An n-MOSFET typically has a lower source-drain resistance than that of a p-MOSFET. Hence in an “on” state (i.e. where current is passing therethrough), n-MOSFETs generate less heat as compared to p-MOSFETs, and hence may waste less energy in operation than p-MOSFETs. Further, n-MOSFETs typically have shorter switching times (i.e. a characteristic response time from changing the switching potential provided to the gate terminal G to the MOSFET changing whether or not current passes therethrough) as compared to p-MOSFETs. This can allow for higher switching rates and improved switching control.

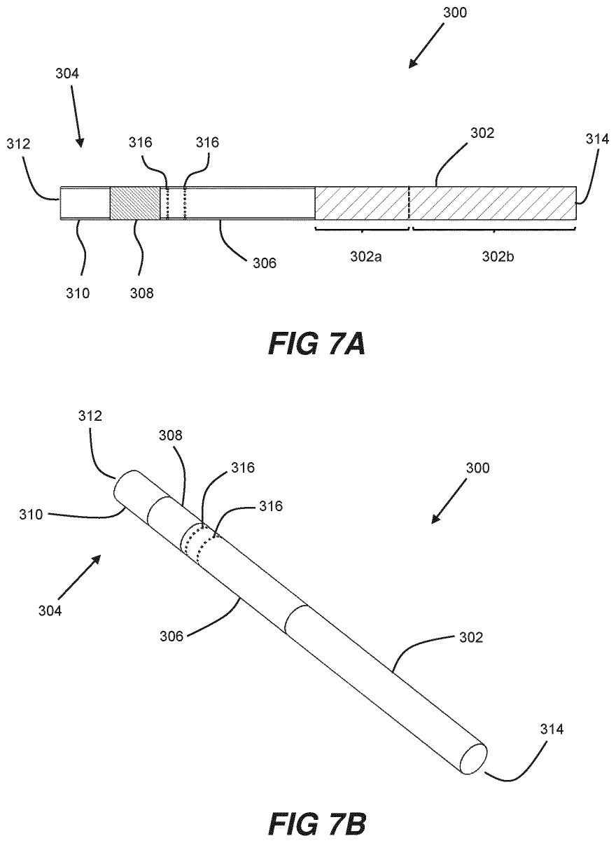

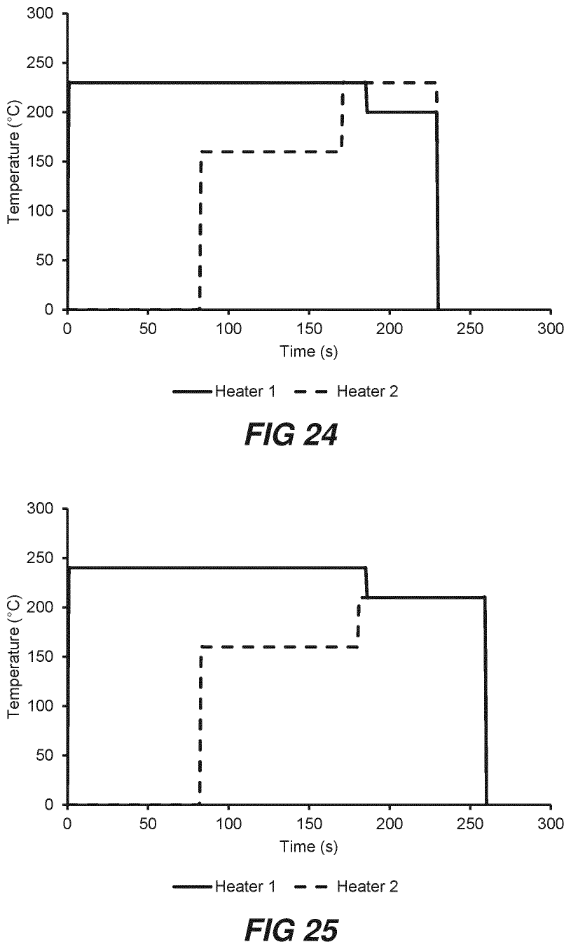

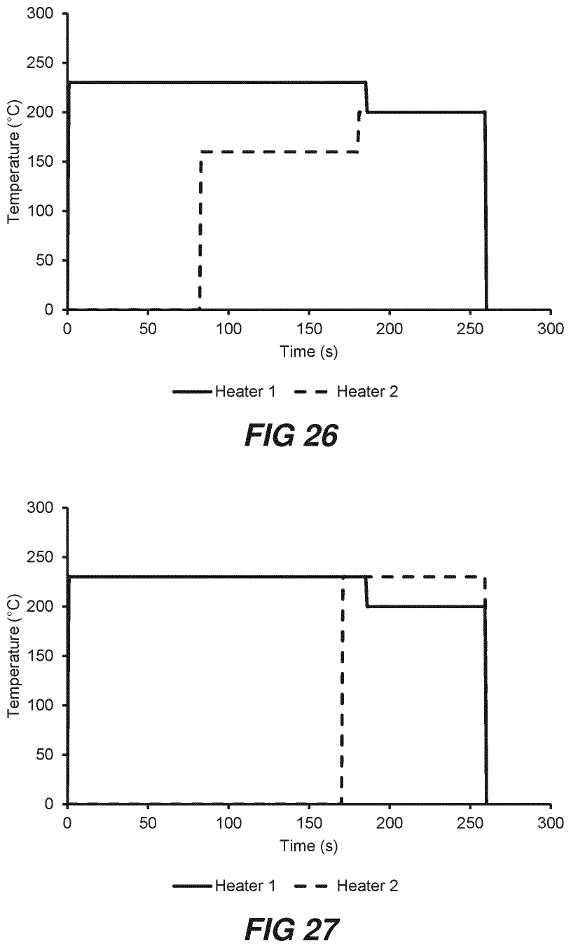

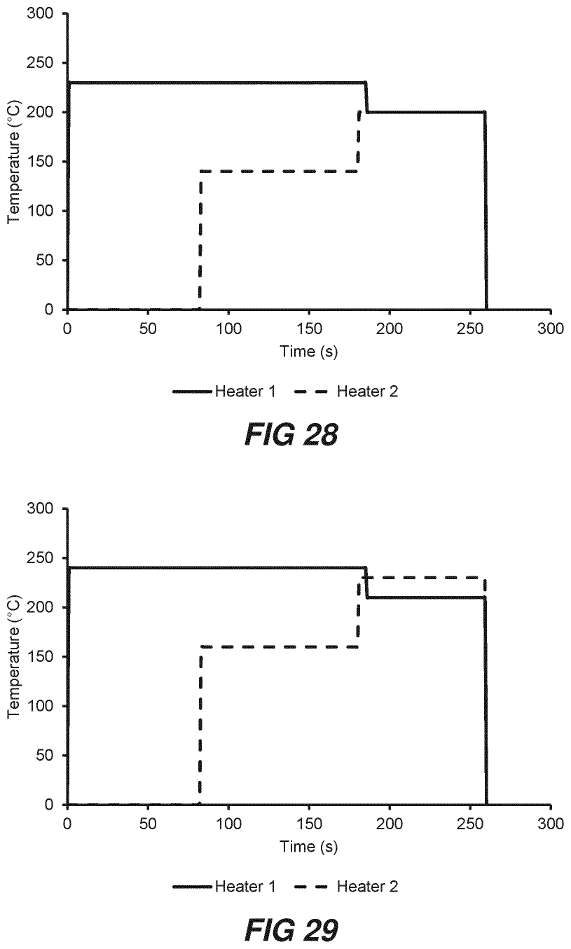

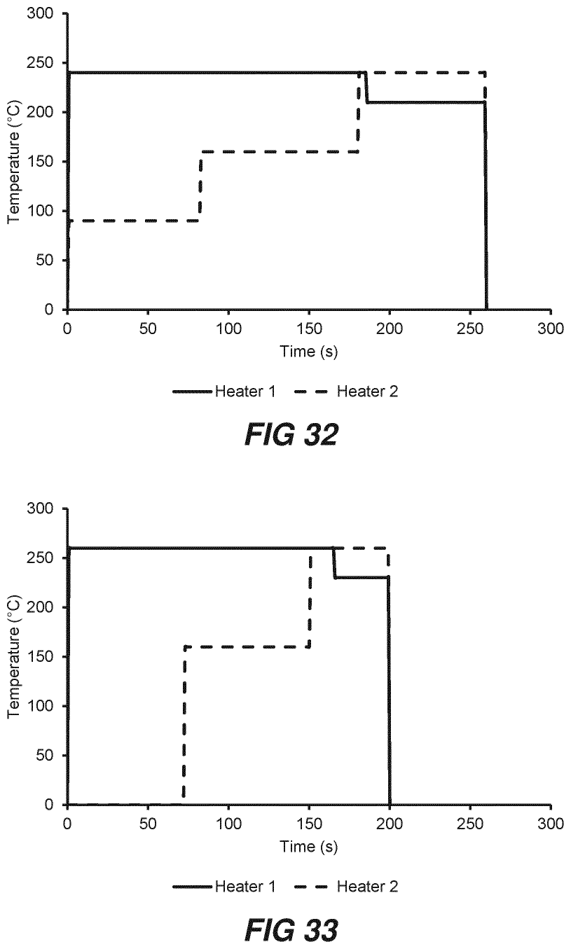

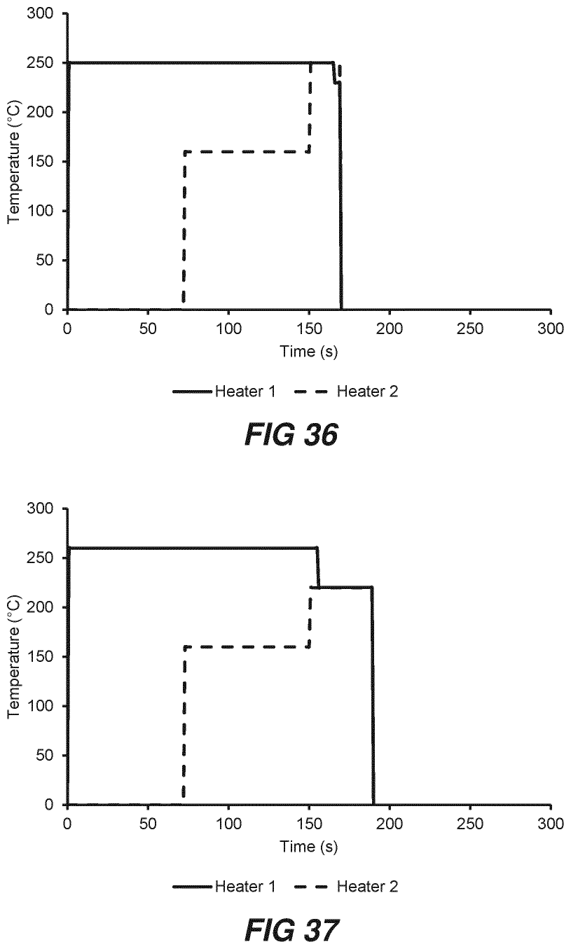

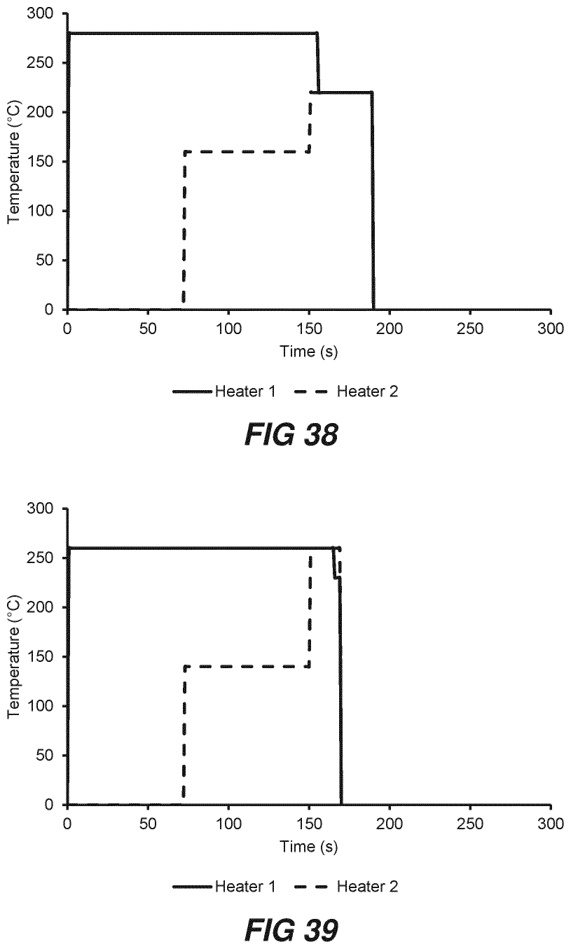

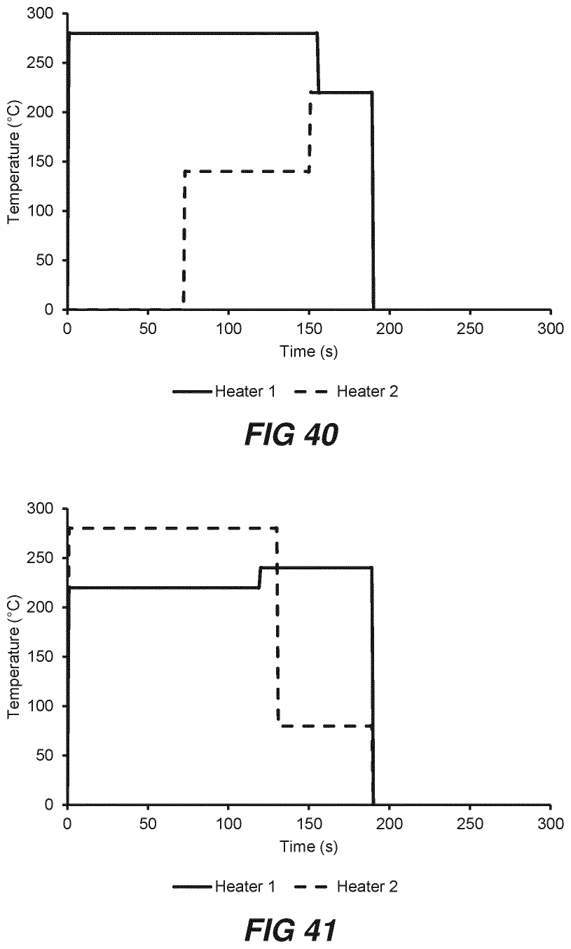

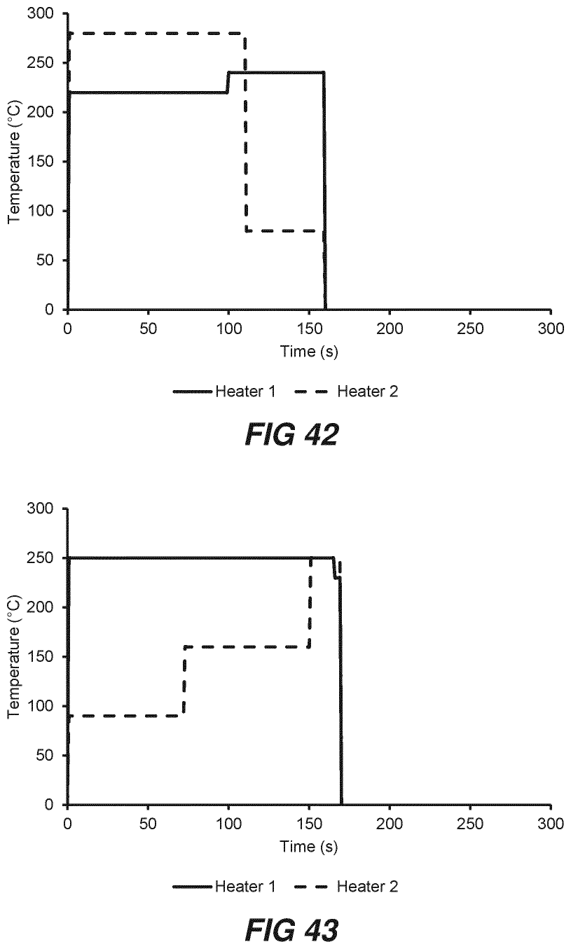

Referring to FIGS. 7A and 7B, there is shown a partially cut-away section view and a perspective view of an example of an aerosol-generating article 300. The aerosol-generating article 300 shown in FIGS. 7A and 7B corresponds to the aerosol-generating article 130 shown in FIGS. 1A and B, and the aerosol-generating article 210 shown in FIGS. 2 to 4 and 6A. In describing FIGS. 7A to 48E, reference is made to components corresponding to, or methods using, the heating assembly 100 shown in FIGS. 1A and 1B. Unless specified otherwise, FIGS. 7A to 48E are also applicable to the aspect depicted in FIGS. 2 to 6B.

The aerosol-generating article 300 may be any shape suitable for use with an aerosol-generating device. The aerosol-generating article 300 may be in the form of or provided as part of a cartridge or cassette or rod which can be inserted into the apparatus. In the embodiment shown in FIGS. 1A and 1B, 2 to 4 and 6A, the aerosol-generating article 300 is in the form of a substantially cylindrical rod that includes a body of smokable material 302 and a filter assembly 304 in the form of a rod. The filter assembly 304 includes three segments, a cooling segment 306, a filter segment 308 and a mouth end segment 310. The article 300 has a first end 312, also known as a mouth end or a proximal end and a second end 314, also known as a distal end. The body of aerosol-generating material 302 is located towards the distal end 314 of the article 300. In one example, the cooling segment 306 is located adjacent the body of aerosol-generating material 302 between the body of aerosol-generating material 302 and the filter segment 308, such that the cooling segment 306 is in an abutting relationship with the aerosol-generating material 302 and the filter segment 308. In other examples, there may be a separation between the body of aerosol-generating material 302 and the cooling segment 306 and between the body of aerosol-generating material 302 and the filter segment 308. The filter segment 308 is located in between the cooling segment 306 and the mouth end segment 310. The mouth end segment 310 is located towards the proximal end 312 of the article 300, adjacent the filter segment 308. In one example, the filter segment 308 is in an abutting relationship with the mouth end segment 310. In one embodiment, the total length of the filter assembly 304 is between 37 mm and 45 mm, more preferably, the total length of the filter assembly 304 is 41 mm.

In use, portions 302a and 302b of the body of aerosol-generating material 302 may correspond to the first induction heating element 114 and second induction heating element 124 of the portion 100 shown in FIG. 1B respectively.

The body of smokable material may have a plurality of portions 302a, 302b which correspond to the plurality of induction heating elements present in the aerosol-generating device. For example, the aerosol-generating article 300 may have a first portion 302a which corresponds to the first induction heating element 114 and a second portion 302b which corresponds to the second induction heating element 124. These portions 302a, 302b may exhibit temperature profiles which are different from each other during a session of use; the temperature profiles of the portions 302a, 302b may derive from the temperature profiles of the first induction heating element 114 and second induction heating element 124 respectively.

Where there is a plurality of portions 302a, 302b of a body of aerosol-generating material 302, any number of the substrate portions 302a, 302b may have substantially the same composition. In a particular example, all of the portions 302a, 302b of the substrate have substantially the same composition. In one embodiment, body of aerosol-generating material 302 is a unitary, continuous body and there is no physical separation between the first and second portions 302a, 302b, and the first and second portions have substantially the same composition.

In one embodiment, the body of aerosol-generating material 302 comprises tobacco. However, in other respective embodiments, the body of smokable material 302 may consist of tobacco, may consist substantially entirely of tobacco, may comprise tobacco and aerosol-generating material other than tobacco, may comprise aerosol-generating material other than tobacco, or may be free of tobacco. The aerosol-generating material may include an aerosol generating agent, such as glycerol.

In a particular embodiment, the aerosol-generating material may comprise one or more tobacco components, filler components, binders and aerosol generating agents.

The filler component may be any suitable inorganic filler material. Suitable inorganic filler materials include, but are not limited to: calcium carbonate (i.e. chalk), perlite, vermiculite, diatomaceous earth, colloidal silica, magnesium oxide, magnesium sulphate, magnesium carbonate, and suitable inorganic sorbents, such as molecular sieves. Calcium carbonate is particularly suitable. In some cases, the filler comprises an organic material such as wood pulp, cellulose and cellulose derivatives.

The binder may be any suitable binder. In some embodiments, the binder comprises one or more of an alginate, celluloses or modified celluloses, polysaccharides, starches or modified starches, and natural gums.

Suitable binders include, but are not limited to: alginate salts comprising any suitable cation, such as sodium alginate, calcium alginate, and potassium alginate; celluloses or modified celluloses, such as hydroxypropyl cellulose and carboxymethylcellulose; starches or modified starches; polysaccharides such as pectin salts comprising any suitable cation, such as sodium, potassium, calcium or magnesium pectate; xanthan gum, guar gum, and any other suitable natural gums.

A binder may be included in the aerosol-generating material in any suitable quantity and concentration.

The “aerosol-generating agent” is an agent that promotes the generation of an aerosol. An aerosol-generating agent may promote the generation of an aerosol by promoting an initial vaporisation and/or the condensation of a gas to an inhalable solid and/or liquid aerosol. In some embodiments, an aerosol-generating agent may improve the delivery of flavor from the aerosol-generating article.

In general, any suitable aerosol-generating agent or agents may be included in the aerosol-generating material. Suitable aerosol-generating agent include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate.

In a particular embodiment, the aerosol-generating material comprises a tobacco component in an amount of from 60 to 90% by weight of the tobacco composition, a filler component in an amount of 0 to 20% by weight of the tobacco composition, and an aerosol generating agent in an amount of from 10 to 20% by weight of the tobacco composition. The tobacco component may comprise paper reconstituted tobacco in an amount of from 70 to 100% by weight of the tobacco component.

In one example, the body of aerosol-generating material 302 is between 34 mm and 50 mm in length, more preferably, the body of aerosol-generating material 302 is between 38 mm and 46 mm in length, more preferably still, the body of aerosol-generating material 302 is 42 mm in length.

In one example, the total length of the article 300 is between 71 mm and 95 mm, more preferably, total length of the article 300 is between 79 mm and 87 mm, more preferably still, total length of the article 300 is 83 mm.

An axial end of the body of aerosol-generating material 302 is visible at the distal end 314 of the article 300. However, in other embodiments, the distal end 314 of the article 300 may comprise an end member (not shown) covering the axial end of the body of aerosol-generating material 302.

The body of aerosol-generating material 302 is joined to the filter assembly 304 by annular tipping paper (not shown), which is located substantially around the circumference of the filter assembly 304 to surround the filter assembly 304 and extends partially along the length of the body of aerosol-generating material 302. In one example, the tipping paper is made of 58GSM standard tipping base paper. In one example has a length of between 42 mm and 50 mm, and more preferably, the tipping paper has a length of 46 mm.

In one example, the cooling segment 306 is an annular tube and is located around and defines an air gap within the cooling segment. The air gap provides a chamber for heated volatilized components generated from the body of aerosol-generating material 302 to flow. The cooling segment 306 is hollow to provide a chamber for aerosol accumulation yet rigid enough to withstand axial compressive forces and bending moments that might arise during manufacture and whilst the article 300 is in use during insertion into the device 100. In one example, the thickness of the wall of the cooling segment 306 is approximately 0.29 mm.

The cooling segment 306 provides a physical displacement between the aerosol-generating material 302 and the filter segment 308. The physical displacement provided by the cooling segment 306 will provide a thermal gradient across the length of the cooling segment 306. In one example the cooling segment 306 is configured to provide a temperature differential of at least 40° C. between a heated volatilized component entering a first end of the cooling segment 306 and a heated volatilized component exiting a second end of the cooling segment 306. In one example the cooling segment 306 is configured to provide a temperature differential of at least 60° C. between a heated volatilized component entering a first end of the cooling segment 306 and a heated volatilized component exiting a second end of the cooling segment 306. This temperature differential across the length of the cooling element 306 protects the temperature sensitive filter segment 308 from the high temperatures of the aerosol-generating material 302 when it is heated by the heating assembly 100 of the device aerosol-generating device. If the physical displacement was not provided between the filter segment 308 and the body of aerosol-generating material 302 and the heating elements 114, 124 of the heating assembly 100, then the temperature sensitive filter segment may 308 become damaged in use, so it would not perform its required functions as effectively.

In one example the length of the cooling segment 306 is at least 15 mm. In one example, the length of the cooling segment 306 is between 20 mm and 30 mm, more particularly 23 mm to 27 mm, more particularly 25 mm to 27 mm and more particularly 25 mm.

The cooling segment 306 is made of paper, which means that it is comprised of a material that does not generate compounds of concern, for example, toxic compounds when in use adjacent to the heater assembly 100 of the aerosol-generating device. In one example, the cooling segment 306 is manufactured from a spirally wound paper tube which provides a hollow internal chamber yet maintains mechanical rigidity. Spirally wound paper tubes are able to meet the tight dimensional accuracy requirements of high-speed manufacturing processes with respect to tube length, outer diameter, roundness and straightness.

In another example, the cooling segment 306 is a recess created from stiff plug wrap or tipping paper. The stiff plug wrap or tipping paper is manufactured to have a rigidity that is sufficient to withstand the axial compressive forces and bending moments that might arise during manufacture and whilst the article 300 is in use during insertion into the device 100.

For each of the examples of the cooling segment 306, the dimensional accuracy of the cooling segment is sufficient to meet the dimensional accuracy requirements of high-speed manufacturing process.

The filter segment 308 may be formed of any filter material sufficient to remove one or more volatilized compounds from heated volatilized components from the smokable material. In one example the filter segment 308 is made of a mono-acetate material, such as cellulose acetate. The filter segment 308 provides cooling and irritation-reduction from the heated volatilized components without depleting the quantity of the heated volatilized components to an unsatisfactory level for a user.

The density of the cellulose acetate tow material of the filter segment 308 controls the pressure drop across the filter segment 308, which in turn controls the draw resistance of the article 300. Therefore the selection of the material of the filter segment 308 is important in controlling the resistance to draw of the article 300. In addition, the filter segment 308 performs a filtration function in the article 300.

In one example, the filter segment 308 is made of a 8Y15 grade of filter tow material, which provides a filtration effect on the heated volatilized material, whilst also reducing the size of condensed aerosol droplets which result from the heated volatilized material which consequentially reduces the irritation and throat impact of the heated volatilized material to satisfactory levels.

The presence of the filter segment 308 provides an insulating effect by providing further cooling to the heated volatilized components that exit the cooling segment 306. This further cooling effect reduces the contact temperature of the user's lips on the surface of the filter segment 308.

One or more flavor s may be added to the filter segment 308 in the form of either direct injection of flavored liquids into the filter segment 308 or by embedding or arranging one or more flavored breakable capsules or other flavor carriers within the cellulose acetate tow of the filter segment 308.

In one example, the filter segment 308 is between 6 mm to 10 mm in length, more preferably 8 mm.

The mouth end segment 310 is an annular tube and is located around and defines an air gap within the mouth end segment 310. The air gap provides a chamber for heated volatilized components that flow from the filter segment 308. The mouth end segment 310 is hollow to provide a chamber for aerosol accumulation yet rigid enough to withstand axial compressive forces and bending moments that might arise during manufacture and whilst the article is in use during insertion into the device 100. In one example, the thickness of the wall of the mouth end segment 310 is approximately 0.29 mm.

In one example, the length of the mouth end segment 310 is between 6 mm to 10 mm and more preferably 8 mm. In one example, the thickness of the mouth end segment is 0.29 mm.

The mouth end segment 310 may be manufactured from a spirally wound paper tube which provides a hollow internal chamber yet maintains critical mechanical rigidity. Spirally wound paper tubes are able to meet the tight dimensional accuracy requirements of high-speed manufacturing processes with respect to tube length, outer diameter, roundness and straightness.

The mouth end segment 310 provides the function of preventing any liquid condensate that accumulates at the exit of the filter segment 308 from coming into direct contact with a user.

It should be appreciated that, in one example, the mouth end segment 310 and the cooling segment 306 may be formed of a single tube and the filter segment 308 is located within that tube separating the mouth end segment 310 and the cooling segment 306.

A ventilation region 316 is provided in the article 300 to enable air to flow into the interior of the article 300 from the exterior of the article 300. In one example the ventilation region 316 takes the form of one or more ventilation holes 316 formed through the outer layer of the article 300. The ventilation holes may be located in the cooling segment 306 to aid with the cooling of the article 300. In one example, the ventilation region 316 comprises one or more rows of holes, and preferably, each row of holes is arranged circumferentially around the article 300 in a cross-section that is substantially perpendicular to a longitudinal axis of the article 300.

In one example, there are between one to four rows of ventilation holes to provide ventilation for the article 300. Each row of ventilation holes may have between 12 to 36 ventilation holes 316. The ventilation holes 316 may, for example, be between 100 to 500 μm in diameter. In one example, an axial separation between rows of ventilation holes 316 is between 0.25 mm and 0.75 mm, more preferably, an axial separation between rows of ventilation holes 316 is 0.5 mm.

In one example, the ventilation holes 316 are of uniform size. In another example, the ventilation holes 316 vary in size. The ventilation holes can be made using any suitable technique, for example, one or more of the following techniques: laser technology, mechanical perforation of the cooling segment 306 or pre-perforation of the cooling segment 306 before it is formed into the article 300. The ventilation holes 316 are positioned so as to provide effective cooling to the article 300.

In one example, the rows of ventilation holes 316 are located at least 11 mm from the proximal end 312 of the article, more preferably the ventilation holes are located between 17 mm and 20 mm from the proximal end 312 of the article 300. The location of the ventilation holes 316 is positioned such that user does not block the ventilation holes 316 when the article 300 is in use.

Advantageously, providing the rows of ventilation holes between 17 mm and 20 mm from the proximal end 312 of the article 300 enables the ventilation holes 316 to be located outside of the device 100, when the article 300 is fully inserted in the device 100, as can be seen in FIG. 1. By locating the ventilation holes outside of the apparatus, non-heated air is able to enter the article 300 through the ventilation holes from outside the device 100 to aid with the cooling of the article 300.

The length of the cooling segment 306 is such that the cooling segment 306 will be partially inserted into the device 100, when the article 300 is fully inserted into the device 100. The length of the cooling segment 306 provides a first function of providing a physical gap between the heater arrangement of the device 100 and the heat sensitive filter arrangement 308, and a second function of enabling the ventilation holes 316 to be located in the cooling segment, whilst also being located outside of the device 100, when the article 300 is fully inserted into the device 100. As can be seen from FIG. 1, the majority of the cooling element 306 is located within the device 100. However, there is a portion of the cooling element 306 that extends out of the device 100. It is in this portion of the cooling element 306 that extends out of the device 100 in which the ventilation holes 316 are located.

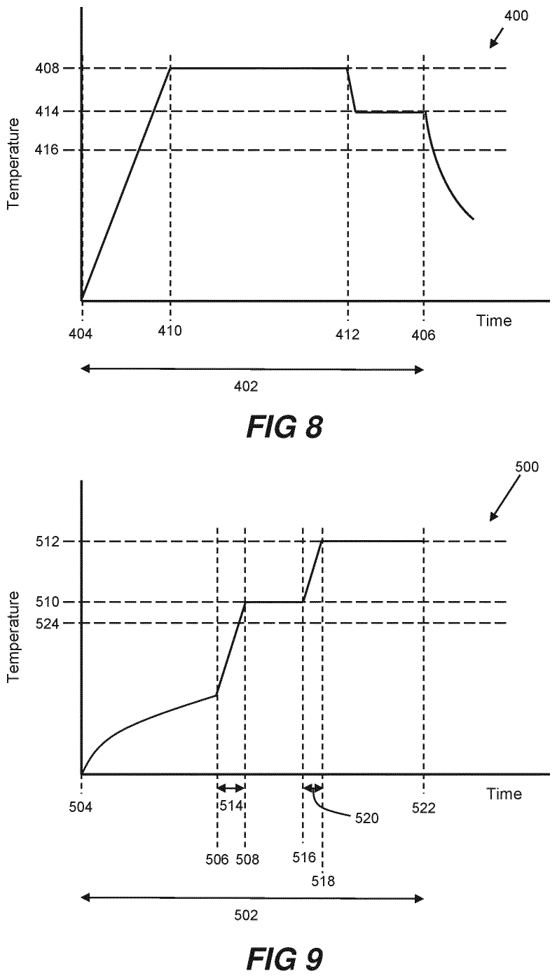

FIG. 8 depicts a temperature profile 400 of a first heating element in an aerosol-generating device, such as the first inductive heating element 114 shown in FIG. 1B, during an exemplary session of use 402. The following is also specifically disclosed with reference to susceptor zone 232a. The temperature profile 400 suitably refers to the temperature profile of the first inductive heating element 114 in any mode of operation of the heating assembly. The temperature profile 400 of the first heating element 114 is measured by a suitable temperature sensor disposed at the first heating element 114. Suitable temperature sensors include thermocouples, thermopiles or resistance temperature detectors (RTDs, also referred to as resistance thermometers). In a particular embodiment, the device comprises at least one RTD. In a preferred embodiment, the device comprises thermocouples arranged on each heating element 114, 124 present in the aerosol-generating device. The temperature data measured by the or each temperature sensor may be communicated to a controller. Further, it may communicated to the controller when a heating element 114, 124 has reached a prescribed temperature, such that the controller may change the supply of power to elements within the aerosol-generating device accordingly. Preferably, the controller comprises a PID controller, which uses a control loop feedback mechanism to control the temperature of the heating elements based on data supplied from one or more temperature sensors disposed in the device. In a preferred embodiment, the controller comprises a PID controller configured to control the temperature of each heating element based on temperature data supplied from thermocouples disposed at each of the heating elements.

The session of use 402 begins when the device is activated 404 and the controller controls the device to supply energy to at least the first induction heating unit 110. The device may be activated by a user by, for example, actuating a push button, or inhaling from the device. Actuating means for use with an aerosol-generating device are known to the person skilled in the art. In the context of a heater assembly comprising induction heating means, the session of use begins when the controller instructs a varying electrical current to be supplied to an inductor (such as first and second coils 112, 122) and thus a varying magnetic field to be supplied to the induction heating element, generating a rise in temperature of the induction heating element. As mentioned hereinabove, this may conveniently be referred to as “supplying energy to the induction heating unit”.

The end of the session of use session of use 406 occurs when the controller instructs elements in the device to stop supplying energy to all heating units present in the aerosol-generating device. In the context of a heater assembly comprising induction heating units, the session of use ends when varying electrical current ceases to be supplied to any of the induction heating elements provided in the heating assembly, such that any varying magnetic field ceases to be supplied to the induction heating elements.

At the beginning of the smoking session 402 the temperature of the first heating element rapidly increases until it reaches the maximum operating temperature 408. The time taken 410 to reach the maximum operating temperature 408 may be referred to as the “ramp-up” period, and has a duration of less than 20 seconds according to the present invention.

The temperature of the first heating element may optionally drop from the maximum operating temperature 408 to a lower temperature 414 later in the session of use 412. If the temperature drops from the maximum operating temperature 408 later in the session of use 412, it is preferred that the temperature to which the first heating element drops 414 is an operating temperature. The operating temperature to which the first heating element drops 414 may suitable be referred to as the “second operating temperature” 414. Preferably, the temperature of the first heating element does not drop below the lowest operating temperature 416 of the first heating element until the end 406 of the session of use 402. The first heating element preferably remains at or above the second operating temperature 414 until the end 406 of the session of use 402.

In embodiments wherein the heating assembly is operable in a plurality of modes, the temperature of the first heating element may drop from the maximum operating temperature 408 to a second operating temperature 414 in at least one of the modes. Preferably, the temperature of the first heating element drops from the maximum operating temperature 408 to a second operating temperature 414 in all of the operable modes. For the avoidance of doubt, the maximum operating temperature 408 and second operating temperature 414 of the first heating element may differ from mode to mode.

In some examples, the second operating temperature 414 is from 180 to 240° C. Where the heating assembly is operable in a plurality of modes, the second operating temperature 414 in at least one mode of operation may be from 180 to 240° C. Preferably, the second operating temperature 414 in all modes of operating may be from 180 to 240° C. More preferably still, the second operating temperature 414 is at least 220° C. In some preferred examples, the first heating element remains at or above the second operating temperature 414 until the end of the session of use in all modes of operation. Without wishing to be bound by theory, configuring the heating assembly such that the first heating element does not drop below 220° C. until the end of the session of use 220 may at least partially prevent condensation from occurring in the first portion of the aerosol-generating article during the session of use, and/or also reduce resistance to draw provided by the first portion of the aerosol-generating article.

There is a ratio between the maximum operating temperature 408 of the first heating element and the second operating temperature 414 of the first heating element. In embodiments wherein the heating assembly is operable in a plurality of modes, there is a ratio between the maximum operating temperature 408 of the first heating element and the second operating temperature 414 of the first heating element in each mode of operation. For example, there is a ratio between the first-mode maximum operating temperature of the first heating element (FMMOTₕ₁) and the first-mode second operating temperature of the first heating element (FMSOTₕ₁).

In some examples, the ratio FMMOTₕ₁:FMSOTₕ₁ is substantially the same as the ratio SMMOTₕ₁:SMSOTₕ₁. Preferably, the ratio FMMOTₕ₁:FMSOTₕ₁ is different from the ratio SMMOTₕ₁:SMSOTₕ₁.

In some examples, the ratio FMMOTₕ₁:FMSOTₕ₁ and/or the ratio SMMOTₕ₁:SMSOTₕ₁ is from 1.05:1 to 1.4:1, or 1.1:1 to 1.4:1, or 1.1:1 to 1.3:1.

In preferred examples, the ratio FMMOTₕ₁:FMSOTₕ₁ is from 1:1 to 1.2:1. In some preferred examples, the ratio SMMOTₕ₁:SMSOTₕ₁ is from 1.2:1 to 1.3:1. In other preferred examples, the SMMOTₕ₁:SMSOTₕ₁ is from or 1.05:1 to 1.2:1. A lower SMMOTₕ₁:SMSOTₕ₁ ratio may help to reduce the amount of undesired condensate generated in the device during use.

In embodiments, the first heating element may remain at or substantially close to the highest operating temperature for up to least 25%, 50%, or 75% of the session. For example, the first heating element may remain at its maximum operating temperature for a first duration of the session of use, then drop to and remain at the second operating temperature for a second duration of the session of use. The first duration may be at least 25%, 50%, or 75% of the session. The first duration may be longer or shorter than the second duration. Preferably, in at least one mode of operation, the first duration is longer than the second duration. In this example, the ratio of the first duration to the second duration may be from 1.1:1 to 7:1, from 1.5:1 to 5:1, from 2:1 to 3:1, or approximately 2.5:1.

In a particular embodiment, the device is operable in a plurality of modes, and the ratios listed above apply to the first mode of operation. In the second mode of operation, the first duration may be longer or shorter than the second duration. Preferably, the second duration is longer than the first duration. Thus, one preferred embodiment of the present invention is a device which is configured such that in a first mode of operation, the first duration is longer than the second duration, but in the second mode of operation, the second duration is longer than the first duration. In one embodiment, in the second mode of operation, the ratio of the second duration to the first duration may be from 1.1:1 to 5:1, from 1.2 to 2:1 or from 1.3:1 to 1.4:1. In another embodiment, in the second mode of operation, the ratio of the second duration to the first duration may be from 2:1 to 12:1, from 2.5:1 to 11:1. In particular, the ratio may be from 3:1 to 4:1; alternatively, the ratio may be from 8:1 to 10:1. This embodiment may be particularly suitable for reducing the amount of condensate formed in the device during a session of use.

The inventors have identified that operating the first heating element at its maximum operating temperature for a greater proportion of the session of use may help in reducing the amount of condensate which collects in the device during use. This effect may be particularly noticeable in so-called “boost” modes of operation where the heating unit operates at a higher maximum operating temperature during a shorter session of use.

The maximum operating temperature 408 is preferably from approximately 200° C. to 300° C., or 210° C. to 290° C., or 220° C. to 280° C., or, 230° C. to 270° C., or 240° C. to 260° C.

FIG. 9 depicts a temperature profile 500 of a second heating element when present in an aerosol-generating device, such as the second inductive heating element 124 shown in FIG. 1B, during an exemplary session of use 502. The following is also specifically disclosed with reference to susceptor zone 232b. Session of use 502 corresponds to session of use 402 shown in FIG. 8. The temperature profile 500 suitably refers to the temperature profile of the second inductive heating element 124 in any mode of operation of the heating assembly.

The session of use 502 begins when the device is activated 504 and energy is supplied to at least the first induction heating unit. In this example, the controller is configured not to supply energy to the second induction heating unit at the start of the session of use 502. Nevertheless, the temperature at the second induction heating element will likely rise somewhat due to thermal “bleed”—conduction, convection and/or radiation of thermal energy from the first heating element 114 to the second heating element 124.

At a first programmed time point 506 after the beginning of the session of use, the controller instructs energy to be supplied to the second heating unit 120 and the temperature of the second heating element 124 rises rapidly until the time point 508 at which a predetermined first operating temperature 510 is reached, then the controller controls the second heating unit 120 (the coil 226) such that the second heating element 124 remains at substantially this temperature for a further period of time. The predetermined first operating temperature 510 is preferably lower than the maximum operating temperature 512 of the second heating element 124. In other embodiments (not shown), the first predetermined operating temperature is the maximum operating temperature; that is, the second heating element 124 is directly heated to its maximum operating temperature upon activation of the second heating unit 120.

In some embodiments, the predetermined first operating temperature 510 is from 150° C. to 200° C. The predetermined first operating temperature 510 may be greater than 150° C., 160° C., 170° C., 180° C., or 190° C. The predetermined first operating temperature 510 may be less than 200° C., 190° C., 180° C., 170° C., or 160° C. Preferably, the predetermined first operating temperature 510 is from 150° C. to 170° C. A lower first operating temperature 510 may help to reduce the amount of undesirable condensate which collects in the device.

In embodiments wherein the heating assembly is operable in a plurality of modes, the heating assembly may be configured such that the second heating element 124 rises to a first operating temperature 510, maintains the first operating temperature 510, then subsequently rises to the maximum operating temperature 512, in at least one mode. Preferably, the heating assembly is configured such that the second heating element 124 rises to a first operating temperature 510, maintains the first operating temperature 510, then subsequently rises to the maximum operating temperature 512 in all operable modes.

The first programmed time point 506 at which power is first supplied to the second heating unit 120 is preferably at least approximately 10 seconds, 20 seconds, 30 seconds, 40 seconds, 50 seconds, or 60 seconds after activation of the device 504. For embodiments wherein the heating assembly is operable in a plurality of modes, the first programmed time point 506 is at least approximately 10 seconds, 20 seconds, 30 seconds, 40 seconds, 50 seconds, 60 seconds, 70 seconds, or 80 seconds after activation of the device 504 in at least one mode. Preferably, the first programmed time point 506 is at least approximately 10 seconds, 20 seconds, 30 seconds, 40 seconds, 50 seconds, 60 seconds, 70 seconds, or 80 seconds after activation of the device 504 in all operable modes. The first programmed time point 506 may be the same in each mode, or it may differ between modes. Preferably, the first programmed time point 506 differs between the modes. In particular, it is preferred that the first programmed time point 506 is at a later point in the session of use in the first mode than in the second mode.

In some embodiments, the heating assembly 100 may be configured such that the second induction unit 120 rises to the predetermined operating temperature 510 within 10 seconds, or 5 seconds, 4 seconds, 3 seconds or 2 seconds of the programmed time point 506 for increasing the temperature of the second induction heating element 124 to the first predetermined operating temperature 510. Put another way, the period 514 between the two time points 506, 508 may have a duration of 10 seconds or less, 5 seconds or less, 4 seconds or less, 3 seconds or less, or 2 seconds or less. Preferably, the period 514 has a duration of 2 seconds or less.

The second heating element 124 may be kept at the predetermined first operating temperature 510 for a predetermined period of time until a second programmed time point 516 at which the controller controls the second heating unit such that the second heating element 124 rises to its maximum operating temperature 512. At this second programmed time point 516 the temperature of the second heating element 124 rises rapidly until the time point 518 at which the maximum operating temperature 512 is reached. Then, the controller controls the second heating unit such that the second heating element 124 remains at substantially this temperature for a further period of time.

There is a ratio between the first operating temperature 410 of the second heating element 124 and the maximum operating temperature 412 of the second heating element 124. In embodiments wherein the heating assembly is operable in a plurality of modes, there is a ratio between the first operating temperature 310 of the second heating element 124 and the maximum operating temperature 412 of the second heating element 124 in each mode of operation. For example, there is a ratio between the first-mode first operating temperature of the second heating element (FMFOTₕ₂) and the first-mode maximum operating temperature of the second heating element (FMMOTₕ₂).

In some examples, the ratio FMFOTₕ₂:FMMOTₕ₂ is substantially the same as the ratio SMFOTₕ₂:SMMOTₕ₂. Preferably, the ratio FMFOTₕ₂:FMMOTₕ₂ is different from the ratio SMFOTₕ₂:SMMOTₕ₂.

In some examples, the ratio FMFOTₕ₂:FMMOTₕ₂ and/or the ratio SMFOTₕ₂:SMMOTₕ₂ is from 1:1.1 to 1:2, or 1:1.2 to 1:2 or, 1:1.3 to 1:1.9, or 1:1.4 to 1:1.8, or 1:1.5 to 1:1.7.

In preferred examples, the ratio FMFOTₕ₂:FMMOTₕ₂ is from 1:1.1 to 1:1.6, or 1:1.3 to 1:1.6, or most preferably, 1:1.5 to 1:1.6 or 1:1.4 to 1:1.5. In preferred examples, the ratio SMFOTₕ₂:SMMOT ₕ₂ is from 1:1.6 to 1:2, or 1:1.6 to 1.9, or 1:1.6 to 1.8, or most preferably, 1:1.6 to 1:1.7 or 1:1.5 to 1:1.6.

The second programmed time point 516 at which the controller controls the second heating unit such that the second heating element 124 rises to its maximum operating temperature 512 is preferably at least approximately 10 seconds, 20 seconds, 30 seconds, 40 seconds, 50 seconds, or 60 seconds after activation of the device 504.

In some embodiments wherein the heating assembly 100 is operable in a plurality of modes, the second programmed time point 416 is at least approximately 10 seconds, 20 seconds, 30 seconds, 40 seconds, 50 seconds, or 60 seconds after activation of the device 404 in at least one mode. Preferably, the second programmed time point 416 is at least approximately 10 seconds, 20 seconds, 30 seconds, 40 seconds, 50 seconds, or 60 seconds after activation of the device 404 in all operable modes. The second programmed time point 416 may be the same in each mode, or it may differ between modes. Preferably, the second programmed time point 416 differs between the modes. In particular, it is preferred that the second programmed time point 416 is at a later point in the session of use in the first mode than in the second mode.

In some embodiments, the heating assembly 100 may be configured such that the second induction element 124 rises from the first predetermined operating temperature 510 to the maximum operating temperature 512 within 10 seconds, or 5 seconds, 4 seconds, 3 seconds or 2 seconds of the programmed time point 516 for increasing the temperature of the second induction heating element 124 to the maximum operating temperature 512. Put another way, the period 520 between the two time points 516, 518 may have a duration of 10 seconds or less, 5 seconds or less, 4 seconds or less, 3 seconds or less, or 2 seconds or less. Preferably, the period 520 has a duration of 2 seconds or less.

The temperature of the second heating element in the period from timepoint 516 to timepoint 518 may rise at a rate of at least 50° C. per second, or 100° C. per second, or 150° C. per second.

In some embodiments the heating assembly 100 may be configured such that the second induction heating element 124 reaches the maximum operating temperature 512 after at least approximately 30 seconds, 40 seconds, 50 seconds, 60 seconds, 80 seconds, 100 seconds, 120, or 140 seconds from activation of the device 504. Preferably, the heating assembly 100 is configured such that the second induction heating element 124 reaches the maximum operating temperature 512 after at least approximately 140 seconds after activation of the device 504.

In some embodiments, the heating assembly 100 may be configured such that the second induction heating element 124 reaches the maximum operating temperature 512 after at least approximately 10 seconds, 20 seconds, 30 seconds, 50 seconds, 50 seconds, 60 seconds, 80 seconds, 100 seconds, 120, or 140 seconds from the first induction heating element 122 reaching its maximum operating temperature 308. Preferably the heating assembly 100 is configured such that the second induction heating element 124 reaches its maximum operating temperature 512 after at least approximately 120 seconds from the first induction heating element 122 reaching its maximum operating temperature 308. Put another way, with reference to FIGS. 8 and 9, time point 518 is preferably at least 120 seconds later than time point 410 during the smoking session 402, 502.

For embodiments wherein the heating assembly is operable in a plurality of modes, the second induction heating element 124 may reach the maximum operating temperature 512 after at least approximately 10 seconds, 20 seconds, 30 seconds, 40 seconds, 50 seconds, 60 seconds, 80 seconds, 100 seconds, or 140 seconds from the first induction heating element 114 reaches its maximum operating temperature 308 in at least one mode. Preferably, the second induction heating element 124 reaches the maximum operating temperature 412 after at least approximately 10 seconds, 20 seconds, 30 seconds, 40 seconds, 50 seconds, 60 seconds, 80 seconds, 100 seconds, or 140 seconds from the first induction heating element 114 reaching its maximum operating temperature 308 in all operable modes. The time taken for the second induction heating element 124 to reach the maximum operating temperature 512 may be the same in each mode, or it may differ between modes. Preferably, the time taken is longer in the first mode than in the second mode.

The second heating element 124 may be kept at its maximum operating temperature 512 for a predetermined period of time until the end of the smoking session 522, at which point the controller controls the heating assembly such that energy ceases to be supplied to all heating elements present in the aerosol-generating device. Preferably, after the temperature of the second heating element 124 has reached an operating temperature (roughly around the first predetermined time point 506), the temperature of the second heating element 124 does not drop below the lowest operating temperature 524 of the second heating element 124 until the end of the smoking session 502.

The second heating element 124 may be held at the first operating temperature 510 for a first duration, and at its maximum operating temperature 512 for a second duration. The second duration may be at least 25%, 50%, or 75% of the session. In some embodiments, the second duration is less than 50%, 45%, 40%, 35%, 30%, or 25% of the session. In particular, the second duration may be less than 35% of the session of use. The inventors have identified that reducing the proportion of the session of use at which the second heating unit is held at its maximum operating temperature may help to reduce the amount of undesirable condensate which collects in the device.

The first duration may be longer or shorter than the second duration. In some embodiments, in at least one mode of operation, the second duration is longer than the second duration. In one example, the ratio of the first duration to second duration may be from 1:1.01 to 1:2, or 1:1.01 to 1:1.1.5, or 1:1.01 to 1:1.01 to 1:1.1. In another example, the ratio of the first duration to second duration may be from 1:1.01 to 1:20, 1:2 to 1:15, 1:3 to 1:10, or 1:5 to 1:9.

In other embodiments, in at least one mode of operation, the first duration is longer than the second duration. In one example, the ratio of the first duration to second duration may be from 1.01:1 to 5:1, or 1.05:1 to 4:1, or 1.1 to 2:1. The inventors have identified that configuring the heating assembly such that the first duration is longer than the second duration may help to reduce the amount of undesirable condensate which collects in the device.

In a particular embodiment, the device is operable in a plurality of modes, and the second duration is longer in both the first mode and the second mode. In the first mode, the ratio of the first duration to second duration may be from 1:1.01 to 1:2, or 1:1.01 to 1:1.1.5, or 1:1.01 to 1:1.01 to 1:1.1. In the second mode of operation, the ratio of the second duration to the first duration may be from 1:1.01 to 1:20, 1:2 to 1:15, 1:3 to 1:10, or 1:5 to 1:9.

In some embodiments, in the first mode, the ratio of the first duration to second duration may be from 1.01:1 to 2:1, or 1.05:1 to 1.5:1. In the second mode of operation, the ratio of the second duration to the first duration may be from 1.01:1 to 5:1, or 1.2:1 to 4:1, or 1.5:1 to 3:1.

In embodiments wherein the first heating element 122 drops from a maximum operating temperature 308 to a lower temperature later in the smoking session, the second heating element 124 may reach its maximum operating temperature 512 before the temperature drop of the first heating element 122, after the temperature drop of the first heating element 122, or concurrent with the temperature drop of the first heating element 122. In a preferred embodiment, the second heating element 124 reaches its maximum operating temperature 512 before the first heating element 122 drops from its maximum operating temperature 308 to a lower temperature.

In some embodiments, the maximum operating temperature 308 of the first heating element 122 is substantially the same as that of the second heating element 124. In other embodiments the maximum operating temperatures 308, 512 of the first and second heating elements 122, 124 may differ. For example, the maximum operating temperature 308 of the first heating element 122 may be greater than that of the second heating element 124, or the maximum operating temperature 512 of the second heating element 124 may be greater than that of the first heating element 122. In one preferred embodiment, the maximum operating temperature 308 of the first heating element 122 is greater than the maximum operating temperature 512 of the second heating element 124. In another preferred embodiment, the maximum operating temperature 308 of the first heating element 122 is substantially the same as that of the second heating element 124.

For periods during which a heating element remains at a substantially constant temperature, there may be minor fluctuations in the temperature around the target temperature defined by the controller. In some embodiments, the fluctuation is less than approximately ±10° C., or ±5° C., or ±4° C., or ±3° C., or ±2° C., or ±1° C. Preferably the fluctuation is less than approximately ±3° C. for at least the first heating element, at least the second heating element, or both the first heating element and second element.

In some embodiments, the heating assembly 100 is configured such that the first heating element 114 has an average temperature across the entire session of use of from approximately 180° C. to 280° C., preferably from approximately 200° C. to 270° C., more preferably from approximately 220° C. to 260° C., still more preferably from approximately 230° C. to 250° C., or most preferably from 235° C. to 245° C. Without wishing to be bound by theory, it is believed that configuring the heating assembly such that the first, mouth-end heating unit 120 has such an average temperature may reduce the filtering and/or condensing effect of the aerosol-generating material arranged near the first heating element 114 during a session of use.

In some embodiments, the heating assembly 100 is configured such that the second heating element 124 has an average temperature across the entire session of use of from approximately 140° C. to 240° C., preferably from approximately 150° C. to 230° C., more preferably from approximately 160° C. to 220° C., still more preferably from approximately 160° C. to 210° C., still more preferably from approximately 160° C. to 200° C., or most preferably from approximately 170° C. to 195° C.

In some embodiments, the heating assembly 100 is configured such that the second heating element 124 has a programmed average temperature across the entire session of use of from approximately 70° C. to 220° C., approximately 80° C. to 200° C., approximately 90° C. to 180° C., approximately 100° C. to 160° C., or approximately 110 to 140° C.

For embodiments wherein the heating assembly is operable in a plurality of modes, the average temperatures of the first heating element 114 and second heating element 124 may be the same for each mode, or differ between each mode. Preferably, the average temperatures of each heating element differ between each mode.

The heating assembly 100 may be configured such that in the first mode, the first heating element 114 has an average temperature across the entire first-mode session of use of from approximately 180° C. to 280° C., preferably from approximately 200° C. to 270° C., more preferably from approximately 220° C. to 260° C., still more preferably from approximately 230° C. to 250° C., or most preferably from 235° C. to 245° C. In other embodiments, the first heating element 114 has an average temperature across the entire first-mode session of use of from approximately 200° C. to 250° C., 210° C. to 240° C., or 215 to 230° C.

The heating assembly 100 may be configured such that in the first mode, the second heating element 124 has an average temperature across the entire first-mode session of use of from approximately 140° C. to 240° C., preferably from approximately 150° C. to 230° C., more preferably from approximately 160° C. to 220° C., still more preferably from approximately 170° C. to 210° C., still more preferably from approximately 180° C. to 200° C., or most preferably from approximately 185° C. to 195° C.

In some embodiments, the heating assembly is configured such that in the first mode, the second heating element 124 has a programmed average temperature across the entire first-mode session of use of from approximately 70° C. to 160° C., 100° C. to 150° C., or 120° C. to 140° C.

The heating assembly 100 may be configured such that in the second mode, the first heating element 114 has an average temperature across the entire second-mode session of use of from approximately 180° C. to 280° C., preferably from approximately 200° C. to 280° C., more preferably from approximately 220° C. to 270° C., still more preferably from approximately 230° C. to 260° C., or most preferably from 240° C. to 250° C.

The heating assembly 100 may be configured such that in the second mode, the second heating element 124 has an average temperature across the entire second-mode session of use of from approximately 140° C. to 240° C., preferably from approximately 150° C. to 20° C., more preferably from approximately 160° C. to 220° C., still more preferably from approximately 170° C. to 210° C., still more preferably from approximately 180° C. to 200° C., or most preferably from approximately 185° C. to 195° C.

In some embodiments, the heating assembly 100 is configured such that in the second mode, the second heating element 124 has a programmed average temperature across the entire second-mode session of use of from approximately 70° C. to 160° C., 100° C. to 150° C., or 110° C. to 140° C.

Preferably the average temperature of the first and/or second heating element 114, 124 across an entire session of use in the second mode is higher than in the first mode. For example, the first heating element 114 and/or the second heating element 124 may have an average temperature across the entire second-mode session of use which is 1 to 100° C. higher than the average temperature across the entire first-mode session of use, preferably 1 to 50° C., more preferably 1 to 25° C., or most preferably 1 to 10° C.

In one embodiment, the heating assembly 100 is configured such that the programmed average temperature of the first heating element 114 is higher in the second mode than in the first mode, and the programmed average temperature of the second heating element 124 is lower in the second mode than in the first mode. In a further embodiment, the maximum operating temperature of the second heating unit in the second mode is higher than in the first mode. The inventors have identified that the configuration used in these embodiments may help to reduce the amount of undesirable condensate which collects in the device in use.

The configuration of the heating assembly 100 may also be defined by the average temperature of the entire heating assembly over a period of time. The average temperature of an entire heating assembly is calculated by summing the average temperature of each heating unit which operates in the heating assembly over the period of time, and dividing that sum by the number of heating units which operate in the heating assembly over the period of time. For example, in one example, the heating assembly may contain two heating units which operate over a session of use. The first heating unit may have an average temperature over the entire session of use of approximately 240° C., and the second heating unit may have an average temperature over the entire session of use of approximately 190° C. The average temperature of the entire heating assembly over the entire session of use in this example would be 215° C.

In some embodiments, the heating assembly 100 is configured such that the heating assembly 100 has an average temperature across the entire session of use of from approximately 180° C. to 270° C., preferably from approximately 190° C. to 260° C., more preferably from 200° C. to 250° C., and most preferably from approximately 210° C. to 230° C.

In some embodiments, the heating assembly 100 is configured such that the heating assembly 100 has a programmed average temperature across the entire session of use of from approximately 70° C. to 260° C., 100° C. to 230° C., 150° C. to 210° C., or 170° C. to 200° C.

For embodiments wherein the heating assembly 100 is operable in a plurality of modes, the average temperature of the heating assembly 100 may be the same for each mode, or differ between each mode. Preferably, the average temperature of the heating assembly differs between each mode.

The heating assembly 100 may be configured such that in the first mode, the heating assembly 100 has an average temperature across the entire first-mode session of use of from approximately 160° C. to 260° C., preferably from approximately 160° C. to 250° C., still more preferably from approximately 170° C. to 240° C., still more preferably from approximately 190° C. to 230° C., or most preferably from approximately 210° C. to 220° C.

In some embodiments, the heating assembly 100 is configured such that in the first mode, the heating assembly 100 has a programmed average temperature of from approximately 70° C. to 250° C., 100° C. to 220° C., 150° C. to 200° C., or 170° C. to 190° C.

The heating assembly may be configured such that in the second mode, the heating assembly 100 has an average temperature across the entire second-mode session of use of from approximately 180° C. to 280° C., preferably from approximately 190° C. to 270° C., more preferably from approximately 200° C. to 260° C., still more preferably from approximately 210° C. to 250° C., or most preferably from 220° C. to 230° C.

In some embodiments, the heating assembly 100 is configured such that in the second mode, the heating assembly 100 has a programmed average temperature of from approximately 90° C. to 270° C., 10° C., or 170° C. to 200° C.

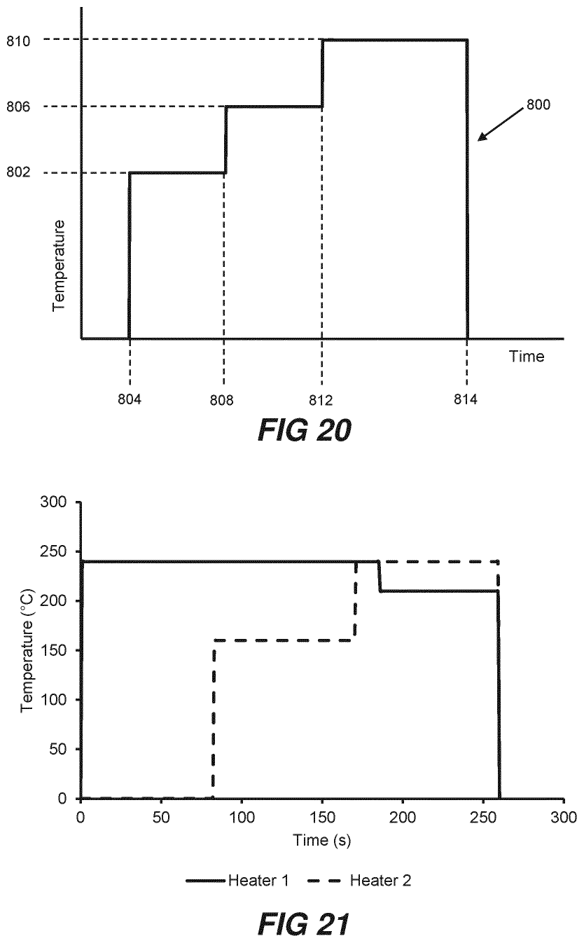

FIGS. 8 and 9 discussed hereinabove reflect the measured or observed temperature profile of heating unit(s) present in the heating assembly 100 and/or the device 200. FIG. 20 reflects a programmed heating profile of any heating unit(s) present in the heating assembly 100 and/or the device 200. Any programmed heating profile of any heating unit present in the heating assembly of the present device may be depicted by the general programmed heating profile as shown in FIG. 20.

A programmed heating profile 800 includes a first temperature, Temperature A 802. Temperature A 802 is the first temperature which the heating unit is programmed to reach during a given session of use, at Timepoint A 804. Timepoint A 804 may conveniently be defined in terms of the number of seconds elapsed from the start of a session of use, i.e. from the point at which power is first supplied to at least one heating unit present in the heating assembly.

Optionally, a programmed heating profile 800 may include a second temperature, Temperature B 806. Temperature B 806 is a temperature different to Temperature A 802. In some embodiments, the heating unit is programmed to reach Temperature B 806 during a given session of use at Timepoint B 808. Timepoint B 808 occurs temporally after Timepoint A 804.

From Timepoint A 804 to Timepoint B 808, the heating unit is programmed to have substantially the same temperature, Temperature A 802. However, in some embodiments, there may be variation about Temperature A 802 in this period. For example, the heating unit may have a temperature within 10° C. of Temperature A 802 during this period, preferably within 5° C. of Temperature A 802 during this period. Such profiles are still considered to correspond to the profile shown generally in FIG. 15. In other embodiments, there is substantially no variation from Temperature A 802 during this period.

Even though FIG. 20 depicts Temperature B 806 being higher than Temperature A 802, the programmed heating profiles of the present disclosure are not so limited: Temperature B 806 may be higher or lower than Temperature A 802 for any given heating profile.

Preferably, a programmed heating profile 800 includes a second temperature, Temperature B 806.

Optionally, a programmed heating profile 800 may include a third temperature, Temperature C 810. Temperature C 810 is a temperature different to Temperature B. In some embodiments, the heating unit is programmed to reach to Temperature C 810 during a given session of use at Timepoint C 812. Timepoint C 812 occurs temporally after Timepoint B 808 and thus Timepoint A 802.

Temperature C 810 may or may not be the same temperature as Temperature A 802.

Even though FIG. 20 depicts Temperature C 810 being higher than Temperature B 806 and Temperature A 802, the programmed temperature profiles of the present disclosure are not so limited: Temperature C 810 may be higher or lower than Temperature A 802 for any given heating profile; Temperature C 810 may be higher or lower than Temperature B 806 for any given heating profile.

The programmed heating profile 800 includes a Final Timepoint 814, the point at which energy stops being supplied to the heating unit for the rest of the session of use. It may be that the Final Timepoint 814 is concurrent with the end of the session of use.

Surprisingly, it has been found that the Temperatures 802, 806, 810 and Timepoints 804, 808, 812, 814 of the programmed heating profile of the heating unit(s) may be modulated to reduce the accumulation of condensation in a device 100. In particular, configuring the device such that Timepoint B 808 occurs after 50% of the session of use has elapsed, preferably after 75% of the session of use has elapsed, may reduce the amount of condensate which collects in the device in use. In embodiments wherein the heating assembly comprises at least two heating units, the heating assembly is preferably configured such that the first and second heating units have substantially the same maximum operating temperature. The inventors have identified that this configuration may also advantageously reduce the accumulation of condensation in the device.

Table 1 lists some parameters for a variety of possible programmed heating profiles for heating units in the present device. Suitable ranges of temperatures for Temperature A 802 and Temperature B 806 are given; preferred heating units and modes of operation associated with each profile are also given.

In some embodiments, the heating assembly is configured such that at least one of the heating units present has a programmed heating profile as depicted in FIG. 20 having a Temperature A 802 and optionally a Temperature B 806, wherein Temperature A 802 and Temperature B 806 are selected from the ranges given in Table 1. In particular embodiments, the heating assembly is configured such that at least two heating units in the heating assembly have programmed heating profiles selected from Table 1. Further, in some embodiments, the heating assembly is configured such that each heating unit present in the heating assembly has a programmed heating profile selected from Table 1.

In Table 1, where values are given in the Temperature B column for any given profile number, that profile preferably includes Temperature B 806 falling within that range. Where a cell contains “-” in the Temperature B column, that profile preferably does not include Temperature B 806 or Temperature C 810.

Each profile has a programmed average temperature. Preferably, each profile recited in Table 1 has a programmed average temperature within the range set out in the column headed “Prog. T̅ (° C.)”.

Each heating profile may suitably be applied to any heating unit present in the heating assembly for any mode of operation. Preferably, though, profiles specifying “1” in the “Heater” column are applied to the first heating unit in the heating assembly; profiles specifying “2” are preferably applied to the second heating unit in the heating assembly, where present.

Similarly, profiles specifying “1” in the “Mode” column are preferably applied to a heating unit in the heating assembly for a first mode of operation; profiles specifying “2” are preferably applied to a heating unit in the heating assembly for a second mode of operation, conveniently referred to as a “boost” mode.

In particularly preferred embodiments, the heating assembly comprises two heating units, the heating assembly being configured such that in at least one mode of operation, the heating units have programmed heating profiles selected from a pair of heating profiles banded by double lines in Table 1.

In a further preferred embodiment, the heating assembly is configured to operate in at least a first mode of operation and a second mode of operation, wherein in the first mode of operation the heating units have programmed heating profiles selected from a pair of heating profiles banded by double lines in Table 1 indicated as suitable for use in a first mode of operation, and in the second mode of operation the heating units have programmed heating profiles selected from a pair of heating profiles banded by double lines in Table 1 indicated as suitable for use in a second mode of operation.

For profiles wherein Temperature A 802 is the highest temperature, Temperature A 802 will correspond to the FMMOT and SMMOT for the first and second modes of operation respectively. For profiles wherein Temperature B 806 is the highest temperature, Temperature B 806 will correspond to the FMMOT and SMMOT for the first and second modes of operation respectively. For profiles wherein Temperature C 810 is the highest temperature, Temperature C 880 will correspond to the FMMOT and SMMOT for the first and second modes of operation respectively.

Where Temperature A 802 is lower than Temperature B 806, Temperature A 802 will correspond to the FMMOT an SMFOT for the first and second modes of operation respectively.

Where Temperature B 806 is lower than Temperature A 802, Temperature B 806 will correspond to the FMSOT and SMSOT for the first and second modes of operation respectively.

For programmed temperature profiles which are preferably applied to the first heating unit, Temperature A 802 generally corresponds to FMMOTₕ₁ and SMMOTₕ₁ in first and second modes respectively, and Temperature B 806 generally corresponds to FMSOTₕ₁ and SMSOTₕ₁ in first and second modes respectively.

For programmed temperature profiles which are preferably applied to the second heating unit, Temperature A 802 generally corresponds to FMMOTₕ₂ and SMFOTₕ₂ in first and second modes respectively, and Temperature B 806 generally corresponds to FMMOTₕ₂ and SMMOTₕ₂ in first and second modes respectively unless the profile includes a Temperature C 810 which is higher than Temperature B 806, in which case Temperature C 810 generally corresponds to FMMOTₕ₂ and SMMOTₕ₂ in first and second modes respectively.

Where neither of the programmed heating profiles in the preferred banded combinations include an operating temperature within the range of from 245° C. to 340° C., the profile numbers in that banded combination are marked with “^{†}”.

TABLE 1

| Profile | Temp. A | Temp. B | Prog. T̅ | | |
|---|---|---|---|---|---|
| No. | (° C.) | (° C.) | (° C.) | Heater | Mode |
| 1 | 240-260 | 210-230 | 235-255 | 1 | 1 |
| 2 | 150-170 | 240-260 | 235-255 | 2 | 1 |
| 3 | 270-290 | 210-230 | 190-210 | 1 | 2 |
| 4 | 150-170 | 250-270 | 190-210 | 2 | 2 |
| 5 | 240-260 | 210-230 | 250-270 | 1 | 1 |
| 6 | 150-170 | 240-260 | 250-270 | 2 | 1 |
| 7 | 270-290 | 210-230 | 180-200 | 1 | 2 |
| 8 | 150-170 | 250-270 | 180-200 | 2 | 2 |
| 9 | 230-250 | 200-220 | 250-270 | 1 | 1 |
| 10 | 150-170 | 230-250 | 250-270 | 2 | 1 |
| 11 | 230-250 | 200-220 | 220-240 | 1 | 1 |
| 12 | 150-170 | 230-250 | 220-240 | 2 | 1 |
| 13^{†} | 220-240 | 190-210 | 250-270 | 1 | 1 |
| 14^{†} | 150-170 | 220-240 | 250-270 | 2 | 1 |
| 15^{†} | 220-240 | 190-210 | 220-240 | 1 | 1 |
| 16^{†} | 150-170 | 220-240 | 220-240 | 2 | 1 |
| 17 | 230-250 | 200-220 | 250-270 | 1 | 1 |
| 18 | 150-170 | 200-220 | 250-270 | 2 | 1 |
| 19^{†} | 220-240 | 190-210 | 250-270 | 1 | 1 |
| 20^{†} | 150-170 | 190-210 | 250-270 | 2 | 1 |
| 21^{†} | 220-240 | 190-210 | 250-270 | 1 | 1 |
| 22^{†} | 220-240 | — | 220-240 | 2 | 1 |
| 23^{†} | 220-240 | 190-210 | 250-270 | 1 | 1 |
| 24^{†} | 130-150 | 190-210 | 250-270 | 2 | 1 |
| 25 | 230-250 | 200-220 | 250-270 | 1 | 1 |
| 26 | 150-170 | 220-240 | 250-270 | 2 | 1 |
| 27 | 225-245 | 200-220 | 250-270 | 1 | 1 |
| 28 | 150-170 | 225-245 | 250-270 | 2 | 1 |
| 29 | 230-250 | 200-220 | 250-270 | 1 | 1 |
| 30 | 80-100 | 230-250 | 250-270 | 2 | 1 |
| 31 | 230-250 | 200-220 | 250-270 | 1 | 1 |
| 32* | 80-100 | 150-170 | 250-270 | 2 | 1 |
| 33 | 250-270 | 220-240 | 190-210 | 1 | 2 |
| 34 | 150-170 | 250-270 | 190-210 | 2 | 2 |
| 35 | 240-260 | 210-230 | 190-210 | 1 | 2 |
| 36 | 150-170 | 240-260 | 190-210 | 2 | 2 |
| 37 | 250-270 | 220-240 | 160-180 | 1 | 2 |
| 38 | 150-170 | 250-270 | 160-180 | 2 | 2 |
| 39 | 240-260 | 220-240 | 160-180 | 1 | 2 |
| 40 | 150-170 | 240-260 | 160-180 | 2 | 2 |
| 41 | 250-270 | 210-230 | 180-200 | 1 | 2 |
| 42 | 150-170 | 210-230 | 180-200 | 2 | 2 |
| 43 | 270-290 | 210-230 | 180-200 | 1 | 2 |
| 44 | 150-170 | 210-230 | 180-200 | 2 | 2 |
| 45 | 250-270 | 220-240 | 160-180 | 1 | 2 |
| 46 | 130-150 | 250-270 | 160-180 | 2 | 2 |
| 47 | 270-290 | 210-230 | 180-200 | 1 | 2 |
| 48 | 130-150 | 210-230 | 180-200 | 2 | 2 |
| 49 | 210-230 | 230-250 | 180-200 | 1 | 2 |
| 50 | 270-290 | 70-90 | 180-200 | 2 | 2 |
| 51 | 210-230 | 230-250 | 150-170 | 1 | 2 |
| 52 | 270-290 | 150-170 | 150-170 | 2 | 2 |
| 53 | 240-260 | 220-240 | 160-180 | 1 | 2 |
| 54* | 80-100 | 150-170 | 160-180 | 2 | 2 |

Any of the programmed temperature profiles 1 to 54 may or may not include a Temperature C 510. Profiles 32 and 54 (indicated with an asterisk) preferably include a Temperature C 510. For profile 32, Temperature C 510 is preferably from 230° C. to 250° C. For profile 54, Temperature C 510 is preferably from 240° C. to 260° C. Programmed temperature profiles 1 to 31 and profiles 33 to 53 preferably do not include a Temperature C 510.

In some embodiments, the heating assembly is configured such that at least one of the heating units present has a programmed heating profile as depicted in FIG. 15 having a Temperature A 502 and optionally a Temperature B 506 occurring at Timepoint A 504 and Timepoint B 508 respectively, and a Final Timepoint 514, the timepoints being selected from Table 2. In particular embodiments, the heating assembly is configured such that at least two heating units in the heating assembly have programmed heating profiles selected from Table 2. Further, in some embodiments, the heating assembly is configured such that each heating unit present in the heating assembly has a programmed heating profile selected from Table 2.

In Table 2, where values are given in the Time B column for any given profile number, that profile preferably includes Timepoint B 508 falling within that range. Where a cell contains “-” in the Time B column, that profile preferably does not include Timepoint B 508 or Timepoint C 512.

TABLE 2

| Profile | Time A | Time B | End Time |
|---|---|---|---|
| No. | (s) | (s) | (s) |
| 1 | 0-10 | 130-150 | 235-255 |
| 2 | 50-70 | 115-135 | 235-255 |
| 3 | 0-10 | 70-90 | 190-210 |
| 4 | 50-70 | 65-85 | 190-210 |
| 5 | 0-10 | 175-195 | 250-270 |
| 6 | 70-90 | 160-180 | 250-270 |
| 7 | 0-10 | 70-90 | 180-200 |
| 8 | 50-70 | 65-85 | 180-200 |
| 9 | 0-10 | 175-195 | 250-270 |
| 10 | 70-90 | 160-180 | 250-270 |
| 11 | 0-10 | 175-195 | 220-240 |
| 12 | 70-90 | 160-180 | 220-240 |
| 13 | 0-10 | 175-195 | 250-270 |
| 14 | 70-90 | 160-180 | 250-270 |
| 15 | 0-10 | 175-195 | 220-240 |
| 16 | 70-90 | 160-180 | 220-240 |
| 17 | 0-10 | 175-195 | 250-270 |
| 18 | 70-90 | 170-190 | 250-270 |
| 19 | 0-10 | 175-195 | 250-270 |
| 20 | 70-90 | 170-190 | 250-270 |
| 21 | 0-10 | 175-195 | 250-270 |
| 22 | 160-180 | — | 220-240 |
| 23 | 0-10 | 175-195 | 250-270 |
| 24 | 70-90 | 170-190 | 250-270 |
| 25 | 0-10 | 175-195 | 250-270 |
| 26 | 70-90 | 170-190 | 250-270 |
| 27 | 0-10 | 175-195 | 250-270 |
| 28 | 70-90 | 170-190 | 250-270 |
| 29 | 0-10 | 175-195 | 250-270 |
| 30 | 0-10 | 170-190 | 250-270 |
| 31 | 0-10 | 175-195 | 250-270 |
| 32 | 0-10 | 70-90 | 250-270 |
| 33 | 0-10 | 155-175 | 190-210 |
| 34 | 60-80 | 140-160 | 190-210 |
| 35 | 0-10 | 155-175 | 190-210 |
| 36 | 60-80 | 140-160 | 190-210 |
| 37 | 0-10 | 155-175 | 160-180 |
| 38 | 60-80 | 140-160 | 160-180 |
| 39 | 0-10 | 155-175 | 160-180 |
| 40 | 60-80 | 140-160 | 160-180 |
| 41 | 0-10 | 145-165 | 180-200 |
| 42 | 60-80 | 140-160 | 180-200 |
| 43 | 0-10 | 145-165 | 180-200 |
| 44 | 60-80 | 140-160 | 180-200 |
| 45 | 0-10 | 155-175 | 160-180 |
| 46 | 60-80 | 140-160 | 160-180 |
| 47 | 0-10 | 145-165 | 180-200 |
| 48 | 60-80 | 140-160 | 180-200 |
| 49 | 0-10 | 110-130 | 180-200 |
| 50 | 0-10 | 120-140 | 180-200 |
| 51 | 0-10 | 90-110 | 150-170 |
| 52 | 0-10 | 60-80 | 150-170 |
| 53 | 0-10 | 155-175 | 160-180 |
| 54 | 0-10 | 60-80 | 160-180 |

In preferred embodiments, the numbered profiles of Table 1 correspond to those of Table 2, such that a heating unit is programmed to reach the temperatures recited in Table 1 at the timepoints recited in Table 2.

Temperature Profile Examples

Fifty-four programmed heating profiles were assessed and are summarized in Table 3. The profiles were tested on an aerosol-generating device according to an example according to aspects of the present invention wherein the heating assembly contained two heating units. The heating units were arranged such that the first heating unit was disposed closer to the mouth end of the heating assembly than the second heating unit. The assembly was configured such that the heating units had different programmed heating profiles; the heating profiles of the heating assembly were paired as the profiles are paired within the double lines shown in Table 3. The column titled “End (s)” refers to the final end point; the column titled “T̅ (° C.)” refers to the programmed average temperature of each profile.

Reference examples wherein neither of the heating units present in the heating assembly were programmed to have a maximum operating temperature of from 245° C. to 340° C. are marked with “^{†}”.

TABLE 3

| | Temp. | Time | Temp. | Time | | | | |
|---|---|---|---|---|---|---|---|---|
| Profile | A | A | B | B | End | T̅ | Heat- | |
| No. | (° C.) | (s) | (° C.) | (s) | (s) | (° C.) | er | Mode |
| 1 | 250 | 0 | 220 | 141 | 245 | 237 | 1 | 1^{st} |
| 2 | 160 | 61 | 250 | 126 | 245 | 163 | 2 | 1^{st} |
| 3 | 280 | 0 | 220 | 80 | 200 | 243 | 1 | 2^{nd} |
| 4 | 160 | 60 | 260 | 75 | 200 | 172 | 2 | 2^{nd} |
| 5 | 250 | 0 | 220 | 185 | 260 | 240 | 1 | 1^{st} |
| 6 | 160 | 82 | 250 | 170 | 260 | 139 | 2 | 1^{st} |
| 7 | 280 | 0 | 220 | 80 | 190 | 243 | 1 | 2^{nd} |
| 8 | 160 | 60 | 260 | 75 | 190 | 169 | 2 | 2^{nd} |
| 9^{†} | 240 | 0 | 210 | 185 | 260 | 230 | 1 | 1^{st} |
| 10^{†} | 160 | 82 | 240 | 170 | 260 | 136 | 2 | 1^{st} |
| 11^{†} | 240 | 0 | 210 | 185 | 230 | 232 | 1 | 1^{st} |
| 12^{†} | 160 | 82 | 240 | 170 | 230 | 122 | 2 | 1^{st} |
| 13^{†} | 230 | 0 | 200 | 185 | 260 | 220 | 1 | 1^{st} |
| 14^{†} | 160 | 82 | 230 | 170 | 260 | 132 | 2 | 1^{st} |
| 15^{†} | 230 | 0 | 200 | 185 | 230 | 222 | 1 | 1^{st} |
| 16^{†} | 160 | 82 | 230 | 170 | 230 | 120 | 2 | 1^{st} |
| 17^{†} | 240 | 0 | 210 | 185 | 260 | 230 | 1 | 1^{st} |
| 18^{†} | 160 | 82 | 210 | 180 | 260 | 124 | 2 | 1^{st} |
| 19^{†} | 230 | 0 | 200 | 185 | 260 | 220 | 1 | 1^{st} |
| 20^{†} | 160 | 82 | 200 | 180 | 260 | 121 | 2 | 1^{st} |
| 21^{†} | 230 | 0 | 200 | 185 | 260 | 220 | 1 | 1^{st} |
| 22^{†} | 230 | 170 | — | — | 230 | 78 | 2 | 1^{st} |
| 23^{†} | 230 | 0 | 200 | 185 | 260 | 220 | 1 | 1^{st} |
| 24^{†} | 140 | 82 | 200 | 180 | 260 | 113 | 2 | 1^{st} |
| 25^{†} | 240 | 0 | 210 | 185 | 260 | 230 | 1 | 1^{st} |
| 26^{†} | 160 | 82 | 230 | 180 | 260 | 130 | 2 | 1^{st} |
| 27^{†} | 235 | 0 | 210 | 185 | 260 | 226 | 1 | 1^{st} |
| 28^{†} | 160 | 82 | 235 | 180 | 260 | 131 | 2 | 1^{st} |
| 29^{†} | 240 | 0 | 210 | 185 | 260 | 230 | 1 | 1^{st} |
| 30^{†} | 90 | 0 | 240 | 180 | 260 | 135 | 2 | 1^{st} |
| 31^{†} | 240 | 0 | 210 | 185 | 260 | 230 | 1 | 1^{st} |
| 32*^{†} | 90 | 0 | 160 | 82 | 260 | 161 | 2 | 1^{st} |
| 33 | 260 | 0 | 230 | 165 | 200 | 252 | 1 | 2^{nd} |
| 34 | 160 | 72 | 260 | 150 | 200 | 125 | 2 | 2^{nd} |
| 35 | 250 | 0 | 220 | 165 | 200 | 242 | 1 | 2^{nd} |
| 36 | 160 | 72 | 250 | 150 | 200 | 123 | 2 | 2^{nd} |
| 37 | 260 | 0 | 230 | 165 | 170 | 256 | 1 | 2^{nd} |
| 38 | 160 | 72 | 260 | 150 | 170 | 102 | 2 | 2^{nd} |
| 39 | 250 | 0 | 230 | 165 | 170 | 247 | 1 | 2^{nd} |
| 40 | 160 | 72 | 250 | 150 | 170 | 101 | 2 | 2^{nd} |
| 41 | 260 | 0 | 220 | 155 | 190 | 250 | 1 | 2^{nd} |
| 42 | 160 | 72 | 220 | 150 | 190 | 110 | 2 | 2^{nd} |
| 43 | 280 | 0 | 220 | 155 | 190 | 266 | 1 | 2^{nd} |
| 44 | 160 | 72 | 220 | 150 | 190 | 110 | 2 | 2^{nd} |
| 45 | 260 | 0 | 230 | 165 | 170 | 256 | 1 | 2^{nd} |
| 46 | 140 | 72 | 260 | 150 | 170 | 93 | 2 | 2^{nd} |
| 47 | 280 | 0 | 220 | 155 | 190 | 266 | 1 | 2^{nd} |
| 48 | 140 | 72 | 220 | 150 | 190 | 102 | 2 | 2^{nd} |
| 49 | 220 | 0 | 240 | 119 | 190 | 225 | 1 | 2^{nd} |
| 50 | 280 | 0 | 80 | 130 | 190 | 215 | 2 | 2^{nd} |
| 51 | 220 | 0 | 240 | 99 | 160 | 225 | 1 | 2^{nd} |
| 52 | 280 | 0 | 160 | 72 | 160 | 216 | 2 | 2^{nd} |
| 53 | 250 | 0 | 230 | 165 | 170 | 247 | 1 | 2^{nd} |
| 54* | 90 | 0 | 160 | 72 | 170 | 139 | 2 | 2^{nd} |

*Programmed heating profile no. 32 included a Temperature C. of 240° C. at Timepoint C of 181 seconds; programmed heating profile no. 54 included a Temperature C. of 250° C. at Timepoint C. of 151 seconds.

Of the 54 programmed heating profiles assessed, the inventors have identified that profiles 13, 14, 27, 28, 35, 36, 39, 40 are particularly useful for reducing the amount of undesirable condensation observed inside the device.

The ratios between the operating temperatures are given in Table 4.

TABLE 4

| Profile No. | FMMOTₕ₁:FMSOTₕ₁ | SMMOTₕ₁:SMSOTₕ₁ | FMFOTₕ₂:FMMOTₕ₂ | SMFOTₕ₂:SMMOTₕ₂ |
|---|---|---|---|---|
| 1 | 1.14:1 | | | |
| 2 | | | 1:1.56 | |
| 3 | | 1.27:1 | | |
| 4 | | | | 1:1.63 |
| 5 | 1.14:1 | | | |
| 6 | | | 1:1.56 | |
| 7 | | 1.27:1 | | |
| 8 | | | | 1:1.63 |
| 9^{†} | 1.14:1 | | | |
| 10^{†} | | | 1:1.50 | |
| 11^{†} | 1.14:1 | | | |
| 12^{†} | | | 1:1.50 | |
| 13^{†} | 1.15:1 | | | |
| 14^{†} | | | 1:1.44 | |
| 15^{†} | 1.15:1 | | | |
| 16^{†} | | | 1:1.44 | |
| 17^{†} | 1.14:1 | | | |
| 18^{†} | | | 1:1.31 | |
| 19^{†} | 1.15:1 | | | |
| 20^{†} | | | 1:1.25 | |
| 21^{†} | 1.15:1 | | | |
| 22^{†} | | | | |
| 23^{†} | 1.15:1 | | | |
| 24^{†} | | | 1:1.43 | |
| 25^{†} | 1.14:1 | | | |
| 26^{†} | | | 1:1.44 | |
| 27^{†} | 1.14:1 | | | |
| 28^{†} | | | 1:1.47 | |
| 29^{†} | 1.14:1 | | | |
| 30^{†} | | | 1:2.67 | |
| 31^{†} | 1.14:1 | | | |
| 32*^{†} | | | 1:2.67 | |
| 33 | | 1.13:1 | | |
| 34 | | | | 1:1.63 |
| 35 | | 1.14:1 | | |
| 36 | | | | 1:1.56 |
| 37 | | 1.13:1 | | |
| 38 | | | | 1:1.63 |
| 39 | | 1.09:1 | | |
| 40 | | | | 1:1.56 |
| 41 | | 1.18:1 | | |
| 42 | | | | 1:1.38 |
| 43 | | 1.27:1 | | |
| 44 | | | | 1:1.38 |
| 45 | | 1.13:1 | | |
| 46 | | | | 1:1.86 |
| 47 | | 1.27:1 | | |
| 48 | | | | 1:1.57 |
| 49 | | 0.92:1 | | |
| 50 | | | | 1:0.29 |
| 51 | | 0.92:1 | | |
| 52 | | | | 1:0.57 |
| 53 | | 1.09:1 | | |
| 54* | | | | 1:2.78 |

Particular profiles of Table 3 and Table 4 will now be described in detail.

### Example 1

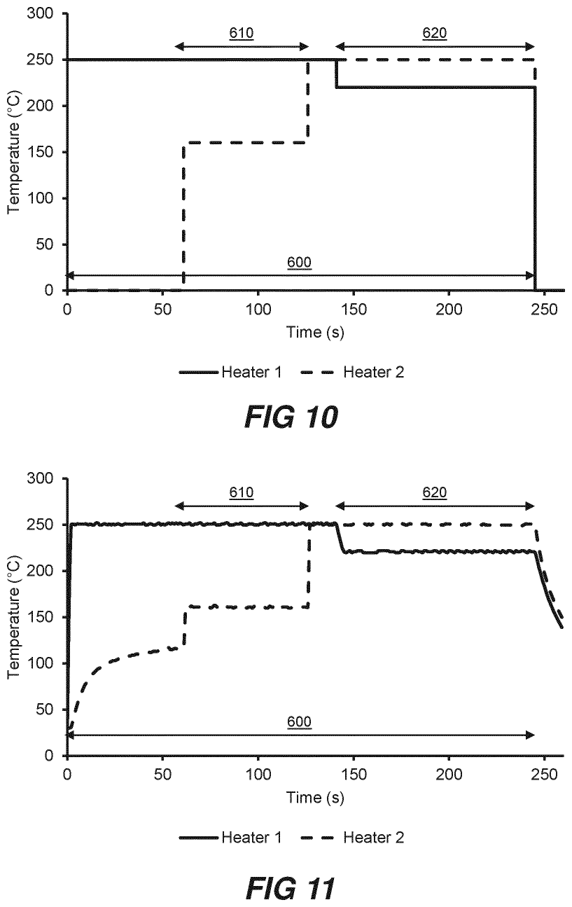

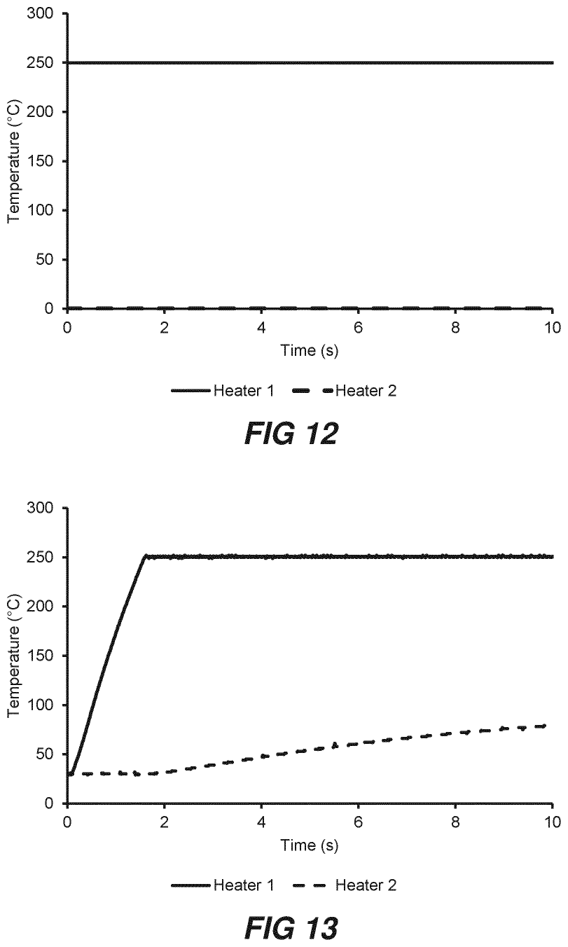

An aerosol-generating device containing the heating assembly 100 shown in FIGS. 1A and 1B was monitored during a session of use in a first mode of operation. FIGS. 10 and 12 show the programmed heating profile of the first heating unit 110 (solid line) and the second heating unit 120 (dashed line). The programmed heating profiles correspond to profiles 1 and 2 respectively from Table 3.

The heating assembly 100 was programmed such that the first heating unit 110 should reach a maximum operating temperature of 250° C. as quickly as possible. The heating assembly 100 was programmed such that the first heating unit 110 would remain at a temperature of 250° C. for the first 140 seconds of the session of use, then drop to a temperature of 220° C. for the remainder of the session of use.

The heating assembly 100 was programmed such that the first heating unit 110 should have an average temperature across the entire session of use of 237° C.

The heating assembly 100 was programmed such that the second heating unit 120 would reach an operating temperature of 160° C. approximately 60 seconds after the start of the session of use. The heating assembly 100 was programmed such that the second heating unit 120 would subsequently rise to a maximum heating temperature of 250° C. approximately 125 seconds after the start of the session of use, and remain at that temperature until the end of the session of use, 245 seconds after the start of the session of use.

The heating assembly 100 was programmed such that the second heating unit 120 should have an average temperature across the entire session of use of 163° C.

The device was configured that the session of use 600 would comprise a first portion 610, starting approximately 60 seconds after the start of the session 600 and ending approximately 125 seconds after the start of the session 600, during which the first heating unit 110 should have a sustained temperature of 250° C. for a duration of approximately 65 seconds, and the second heating unit 120 should have a lower sustained temperature of 160° C. for 65 seconds.

The device was further configured that the session of use 600 would comprise a second portion 620, starting approximately 140 seconds after the start of the session 600 and ending approximately 245 seconds after the start of the session 600 (i.e. the end of the session 600), during which the first heating unit 110 should have a sustained temperature of 220° C. for a duration of approximately 105 seconds, and the second heating unit 120 should have a higher sustained temperature of 250° C. for 105 seconds.

FIGS. 11 and 13 show the measured temperature profiles of the first heating element 114 (solid line) and second heating element 124 (dotted line) during the session of use 600 in the first mode. Measurements were obtained from thermocouples disposed on each heating element.

As can be seen most clearly in FIG. 13, the first heating element 114 reached a maximum operating temperature of 250° C. within 2 seconds of the start of the session of use 600. The first heating element reached the maximum operating temperature at a rate of approximately 140° C. per second. The first heating element 114 remained at this maximum operating temperature until 140 seconds of the session of use 600 had elapsed, at which point the temperature of the first heating element dropped rapidly to 220° C. The first heating element remained at approximately 220° C. until the end of the session of use 600, at which point the first heating element 114 cooled rapidly.

The first heating element 114 was calculated to have an average observed temperature of approximately 237° C. across the entire session of use 600.

The second heating element 124 gradually increased in temperature from the start of the session of use 600. This was attributed to thermal “bleed”—conduction, convection and/or radiation of thermal energy from the first heating element 114 to the second heating element 124. The temperature of the second heating element 124 rose rapidly to 160° C. approximately 60 seconds into the session of use 600, corresponding to the programmed heating profile of the second heating element 124. The second heating element 124 remained at this temperature until approximately 125 seconds of the session of use 600 had elapsed, and then the temperature rose rapidly to 250° C. The second heating element 124 remained at this temperature until the end of the session of use 600, at which point the second heating element 124 cooled rapidly.

The second heating element 124 was calculated to have an average observed temperature of approximately 188° C. across the entire session of use 600.

As can be seen in FIGS. 10 and 11, first and second portions 610, 620 of the session of use 600 as programmed and as observed are approximately the same.

The data obtained from this example is presented in Table 5 below.

TABLE 5

| Time (s) | ^{h1}T^{Pr} (° C.) | ^{h1}T^{Ob} (° C.) | ^{h2}T^{Pr} (° C.) | ^{h2}T^{Ob} (° C.) |
|---|---|---|---|---|
| 0 | 250 | 30 | 0 | 30 |
| 1 | 250 | 173 | 0 | 30 |
| 2 | 250 | 250 | 0 | 31 |
| 3 | 250 | 251 | 0 | 39 |
| 4 | 250 | 250 | 0 | 47 |
| 5 | 250 | 251 | 0 | 54 |
| 6 | 250 | 251 | 0 | 61 |
| 7 | 250 | 251 | 0 | 66 |
| 8 | 250 | 251 | 0 | 71 |
| 9 | 250 | 251 | 0 | 76 |
| 10 | 250 | 251 | 0 | 79 |
| 11 | 250 | 250 | 0 | 82 |
| 12 | 250 | 251 | 0 | 85 |
| 13 | 250 | 250 | 0 | 88 |
| 14 | 250 | 250 | 0 | 90 |
| 15 | 250 | 252 | 0 | 92 |
| 16 | 250 | 252 | 0 | 94 |
| 17 | 250 | 250 | 0 | 95 |
| 18 | 250 | 250 | 0 | 96 |
| 19 | 250 | 251 | 0 | 98 |
| 20 | 250 | 251 | 0 | 99 |
| 21 | 250 | 250 | 0 | 100 |
| 22 | 250 | 251 | 0 | 101 |
| 23 | 250 | 250 | 0 | 102 |
| 24 | 250 | 251 | 0 | 103 |
| 25 | 250 | 250 | 0 | 103 |
| 26 | 250 | 251 | 0 | 104 |
| 27 | 250 | 251 | 0 | 105 |
| 28 | 250 | 250 | 0 | 105 |
| 29 | 250 | 250 | 0 | 106 |
| 30 | 250 | 251 | 0 | 107 |
| 31 | 250 | 251 | 0 | 107 |
| 32 | 250 | 251 | 0 | 108 |
| 33 | 250 | 251 | 0 | 108 |
| 34 | 250 | 251 | 0 | 109 |
| 35 | 250 | 251 | 0 | 109 |
| 36 | 250 | 251 | 0 | 110 |
| 37 | 250 | 251 | 0 | 110 |
| 38 | 250 | 251 | 0 | 110 |
| 39 | 250 | 251 | 0 | 111 |
| 40 | 250 | 252 | 0 | 111 |
| 41 | 250 | 250 | 0 | 111 |
| 42 | 250 | 250 | 0 | 112 |
| 43 | 250 | 251 | 0 | 112 |
| 44 | 250 | 251 | 0 | 112 |
| 45 | 250 | 250 | 0 | 113 |
| 46 | 250 | 250 | 0 | 113 |
| 47 | 250 | 251 | 0 | 113 |
| 48 | 250 | 252 | 0 | 114 |
| 49 | 250 | 250 | 0 | 114 |
| 50 | 250 | 251 | 0 | 114 |
| 51 | 250 | 250 | 0 | 114 |
| 52 | 250 | 251 | 0 | 115 |
| 53 | 250 | 252 | 0 | 117 |
| 54 | 250 | 251 | 0 | 115 |
| 55 | 250 | 252 | 0 | 115 |
| 56 | 250 | 251 | 0 | 116 |
| 57 | 250 | 252 | 0 | 116 |
| 58 | 250 | 251 | 0 | 116 |
| 59 | 250 | 252 | 0 | 116 |
| 60 | 250 | 251 | 0 | 116 |
| 61 | 250 | 250 | 0 | 117 |
| 62 | 250 | 251 | 160 | 161 |
| 63 | 250 | 251 | 160 | 161 |
| 64 | 250 | 252 | 160 | 161 |
| 65 | 250 | 250 | 160 | 162 |
| 66 | 250 | 250 | 160 | 161 |
| 67 | 250 | 251 | 160 | 161 |
| 68 | 250 | 251 | 160 | 161 |
| 69 | 250 | 252 | 160 | 161 |
| 70 | 250 | 252 | 160 | 161 |
| 71 | 250 | 250 | 160 | 161 |
| 72 | 250 | 250 | 160 | 161 |
| 73 | 250 | 251 | 160 | 161 |
| 74 | 250 | 251 | 160 | 162 |
| 75 | 250 | 251 | 160 | 160 |
| 76 | 250 | 251 | 160 | 161 |
| 77 | 250 | 252 | 160 | 163 |
| 78 | 250 | 250 | 160 | 162 |
| 79 | 250 | 250 | 160 | 160 |
| 80 | 250 | 250 | 160 | 161 |
| 81 | 250 | 251 | 160 | 160 |
| 82 | 250 | 251 | 160 | 161 |
| 83 | 250 | 252 | 160 | 162 |
| 84 | 250 | 252 | 160 | 161 |
| 85 | 250 | 250 | 160 | 161 |
| 86 | 250 | 250 | 160 | 161 |
| 87 | 250 | 250 | 160 | 160 |
| 88 | 250 | 251 | 160 | 161 |
| 89 | 250 | 251 | 160 | 160 |
| 90 | 250 | 251 | 160 | 161 |
| 91 | 250 | 252 | 160 | 161 |
| 92 | 250 | 250 | 160 | 162 |
| 93 | 250 | 250 | 160 | 161 |
| 94 | 250 | 250 | 160 | 160 |
| 95 | 250 | 251 | 160 | 161 |
| 96 | 250 | 251 | 160 | 161 |
| 97 | 250 | 251 | 160 | 160 |
| 98 | 250 | 250 | 160 | 162 |
| 99 | 250 | 250 | 160 | 161 |
| 100 | 250 | 250 | 160 | 160 |
| 101 | 250 | 251 | 160 | 160 |
| 102 | 250 | 251 | 160 | 161 |
| 103 | 250 | 252 | 160 | 161 |
| 104 | 250 | 252 | 160 | 160 |
| 105 | 250 | 250 | 160 | 160 |
| 106 | 250 | 251 | 160 | 162 |
| 107 | 250 | 251 | 160 | 161 |
| 108 | 250 | 251 | 160 | 161 |
| 109 | 250 | 251 | 160 | 162 |
| 110 | 250 | 250 | 160 | 160 |
| 111 | 250 | 250 | 160 | 162 |
| 112 | 250 | 251 | 160 | 161 |
| 113 | 250 | 251 | 160 | 161 |
| 114 | 250 | 252 | 160 | 161 |
| 115 | 250 | 250 | 160 | 161 |
| 116 | 250 | 251 | 160 | 160 |
| 117 | 250 | 251 | 160 | 160 |
| 118 | 250 | 252 | 160 | 161 |
| 119 | 250 | 250 | 160 | 161 |
| 120 | 250 | 250 | 160 | 161 |
| 121 | 250 | 251 | 160 | 161 |
| 122 | 250 | 251 | 160 | 161 |
| 123 | 250 | 252 | 160 | 161 |
| 124 | 250 | 252 | 160 | 161 |
| 125 | 250 | 250 | 160 | 161 |
| 126 | 250 | 251 | 160 | 161 |
| 127 | 250 | 251 | 250 | 250 |
| 128 | 250 | 250 | 250 | 250 |
| 129 | 250 | 252 | 250 | 250 |
| 130 | 250 | 251 | 250 | 251 |
| 131 | 250 | 252 | 250 | 250 |
| 132 | 250 | 251 | 250 | 251 |
| 133 | 250 | 252 | 250 | 251 |
| 134 | 250 | 250 | 250 | 250 |
| 135 | 250 | 251 | 250 | 251 |
| 136 | 250 | 252 | 250 | 251 |
| 137 | 250 | 250 | 250 | 251 |
| 138 | 250 | 251 | 250 | 250 |
| 139 | 250 | 251 | 250 | 250 |
| 140 | 250 | 252 | 250 | 251 |
| 141 | 250 | 250 | 250 | 250 |
| 142 | 220 | 241 | 250 | 251 |
| 143 | 220 | 233 | 250 | 251 |
| 144 | 220 | 225 | 250 | 251 |
| 145 | 220 | 221 | 250 | 250 |
| 146 | 220 | 220 | 250 | 250 |
| 147 | 220 | 221 | 250 | 250 |
| 148 | 220 | 222 | 250 | 250 |
| 149 | 220 | 220 | 250 | 250 |
| 150 | 220 | 221 | 250 | 251 |
| 151 | 220 | 221 | 250 | 251 |
| 152 | 220 | 222 | 250 | 251 |
| 153 | 220 | 222 | 250 | 250 |
| 154 | 220 | 222 | 250 | 250 |
| 155 | 220 | 220 | 250 | 251 |
| 156 | 220 | 220 | 250 | 251 |
| 157 | 220 | 220 | 250 | 250 |
| 158 | 220 | 220 | 250 | 251 |
| 159 | 220 | 220 | 250 | 250 |
| 160 | 220 | 220 | 250 | 251 |
| 161 | 220 | 220 | 250 | 251 |
| 162 | 220 | 220 | 250 | 250 |
| 163 | 220 | 222 | 250 | 251 |
| 164 | 220 | 222 | 250 | 250 |
| 165 | 220 | 222 | 250 | 251 |
| 166 | 220 | 222 | 250 | 250 |
| 167 | 220 | 222 | 250 | 251 |
| 168 | 220 | 222 | 250 | 251 |
| 169 | 220 | 221 | 250 | 250 |
| 170 | 220 | 221 | 250 | 251 |
| 171 | 220 | 221 | 250 | 250 |
| 172 | 220 | 220 | 250 | 251 |
| 173 | 220 | 220 | 250 | 251 |
| 174 | 220 | 220 | 250 | 250 |
| 175 | 220 | 222 | 250 | 251 |
| 176 | 220 | 222 | 250 | 251 |
| 177 | 220 | 221 | 250 | 250 |
| 178 | 220 | 221 | 250 | 250 |
| 179 | 220 | 221 | 250 | 251 |
| 180 | 220 | 221 | 250 | 251 |
| 181 | 220 | 220 | 250 | 250 |
| 182 | 220 | 222 | 250 | 251 |
| 183 | 220 | 222 | 250 | 251 |
| 184 | 220 | 221 | 250 | 251 |
| 185 | 220 | 221 | 250 | 250 |
| 186 | 220 | 220 | 250 | 251 |
| 187 | 220 | 222 | 250 | 251 |
| 188 | 220 | 222 | 250 | 251 |
| 189 | 220 | 221 | 250 | 250 |
| 190 | 220 | 221 | 250 | 250 |
| 191 | 220 | 221 | 250 | 252 |
| 192 | 220 | 222 | 250 | 251 |
| 193 | 220 | 222 | 250 | 251 |
| 194 | 220 | 221 | 250 | 251 |
| 195 | 220 | 220 | 250 | 250 |
| 196 | 220 | 222 | 250 | 250 |
| 197 | 220 | 222 | 250 | 250 |
| 198 | 220 | 221 | 250 | 251 |
| 199 | 220 | 220 | 250 | 251 |
| 200 | 220 | 222 | 250 | 251 |
| 201 | 220 | 222 | 250 | 251 |
| 202 | 220 | 221 | 250 | 251 |
| 203 | 220 | 220 | 250 | 250 |
| 204 | 220 | 222 | 250 | 250 |
| 205 | 220 | 222 | 250 | 250 |
| 206 | 220 | 221 | 250 | 250 |
| 207 | 220 | 221 | 250 | 250 |
| 208 | 220 | 220 | 250 | 251 |
| 209 | 220 | 222 | 250 | 250 |
| 210 | 220 | 221 | 250 | 251 |
| 211 | 220 | 221 | 250 | 251 |
| 212 | 220 | 220 | 250 | 251 |
| 213 | 220 | 222 | 250 | 251 |
| 214 | 220 | 221 | 250 | 251 |
| 215 | 220 | 221 | 250 | 251 |
| 216 | 220 | 222 | 250 | 251 |
| 217 | 220 | 222 | 250 | 250 |
| 218 | 220 | 221 | 250 | 251 |
| 219 | 220 | 220 | 250 | 250 |
| 220 | 220 | 222 | 250 | 250 |
| 221 | 220 | 221 | 250 | 250 |
| 222 | 220 | 221 | 250 | 250 |
| 223 | 220 | 220 | 250 | 250 |
| 224 | 220 | 222 | 250 | 250 |
| 225 | 220 | 221 | 250 | 250 |
| 226 | 220 | 221 | 250 | 250 |
| 227 | 220 | 220 | 250 | 250 |
| 228 | 220 | 222 | 250 | 250 |
| 229 | 220 | 221 | 250 | 250 |
| 230 | 220 | 220 | 250 | 250 |
| 231 | 220 | 222 | 250 | 250 |
| 232 | 220 | 222 | 250 | 250 |
| 233 | 220 | 221 | 250 | 250 |
| 234 | 220 | 220 | 250 | 250 |
| 235 | 220 | 222 | 250 | 250 |
| 236 | 220 | 221 | 250 | 250 |
| 237 | 220 | 221 | 250 | 250 |
| 238 | 220 | 222 | 250 | 249 |
| 239 | 220 | 222 | 250 | 250 |
| 240 | 220 | 221 | 250 | 251 |
| 241 | 220 | 220 | 250 | 251 |
| 242 | 220 | 222 | 250 | 251 |
| 243 | 220 | 221 | 250 | 251 |
| 244 | 220 | 221 | 250 | 251 |
| 245 | 220 | 220 | 250 | 251 |

The deviation of the observed temperature from the programmed temperature at each timepoint is set out in Table 6. Each of the deviation values is given in degrees Celsius (° C.). Values surrounded by solid vertical lines “|” indicate the modulus or absolute value of the deviation. The sum of each deviation is given at the end of Table 6.

TABLE 6

| Time (s) | ^{h1}T^{Ob} − ^{h1}T^{Pr} | \|^{h1}T^{Ob} − ^{h1}T^{Pr}\| | ^{h2}T^{Ob} − ^{h2}T^{Pr} | \|^{h2}T^{Ob} − ^{h2}T^{Pr}\| |
|---|---|---|---|---|
| 0 | −220 | 220 | 30 | 30 |
| 1 | −77 | 77 | 30 | 30 |
| 2 | 0 | 0 | 31 | 31 |
| 3 | 1 | 1 | 39 | 39 |
| 4 | 0 | 0 | 47 | 47 |
| 5 | 1 | 1 | 54 | 54 |
| 6 | 1 | 1 | 61 | 61 |
| 7 | 1 | 1 | 66 | 66 |
| 8 | 1 | 1 | 71 | 71 |
| 9 | 1 | 1 | 76 | 76 |
| 10 | 1 | 1 | 79 | 79 |
| 11 | 0 | 0 | 82 | 82 |
| 12 | 1 | 1 | 85 | 85 |
| 13 | 0 | 0 | 88 | 88 |
| 14 | 0 | 0 | 90 | 90 |
| 15 | 2 | 2 | 92 | 92 |
| 16 | 2 | 2 | 94 | 94 |
| 17 | 0 | 0 | 95 | 95 |
| 18 | 0 | 0 | 96 | 96 |
| 19 | 1 | 1 | 98 | 98 |
| 20 | 1 | 1 | 99 | 99 |
| 21 | 0 | 0 | 100 | 100 |
| 22 | 1 | 1 | 101 | 101 |
| 23 | 0 | 0 | 102 | 102 |
| 24 | 1 | 1 | 103 | 103 |
| 25 | 0 | 0 | 103 | 103 |
| 26 | 1 | 1 | 104 | 104 |
| 27 | 1 | 1 | 105 | 105 |
| 28 | 0 | 0 | 105 | 105 |
| 29 | 0 | 0 | 106 | 106 |
| 30 | 1 | 1 | 107 | 107 |
| 31 | 1 | 1 | 107 | 107 |
| 32 | 1 | 1 | 108 | 108 |
| 33 | 1 | 1 | 108 | 108 |
| 34 | 1 | 1 | 109 | 109 |
| 35 | 1 | 1 | 109 | 109 |
| 36 | 1 | 1 | 110 | 110 |
| 37 | 1 | 1 | 110 | 110 |
| 38 | 1 | 1 | 110 | 110 |
| 39 | 1 | 1 | 111 | 111 |
| 40 | 2 | 2 | 111 | 111 |
| 41 | 0 | 0 | 111 | 111 |
| 42 | 0 | 0 | 112 | 112 |
| 43 | 1 | 1 | 112 | 112 |
| 44 | 1 | 1 | 112 | 112 |
| 45 | 0 | 0 | 113 | 113 |
| 46 | 0 | 0 | 113 | 113 |
| 47 | 1 | 1 | 113 | 113 |
| 48 | 2 | 2 | 114 | 114 |
| 49 | 0 | 0 | 114 | 114 |
| 50 | 1 | 1 | 114 | 114 |
| 51 | 0 | 0 | 114 | 114 |
| 52 | 1 | 1 | 115 | 115 |
| 53 | 2 | 2 | 117 | 117 |
| 54 | 1 | 1 | 115 | 115 |
| 55 | 2 | 2 | 115 | 115 |
| 56 | 1 | 1 | 116 | 116 |
| 57 | 2 | 2 | 116 | 116 |
| 58 | 1 | 1 | 116 | 116 |
| 59 | 2 | 2 | 116 | 116 |
| 60 | 1 | 1 | 116 | 116 |
| 61 | 0 | 0 | 117 | 117 |
| 62 | 1 | 1 | 1 | 1 |
| 63 | 1 | 1 | 1 | 1 |
| 64 | 2 | 2 | 1 | 1 |
| 65 | 0 | 0 | 2 | 2 |
| 66 | 0 | 0 | 1 | 1 |
| 67 | 1 | 1 | 1 | 1 |
| 68 | 1 | 1 | 1 | 1 |
| 69 | 2 | 2 | 1 | 1 |
| 70 | 2 | 2 | 1 | 1 |
| 71 | 0 | 0 | 1 | 1 |
| 72 | 0 | 0 | 1 | 1 |
| 73 | 1 | 1 | 1 | 1 |
| 74 | 1 | 1 | 2 | 2 |
| 75 | 1 | 1 | 0 | 0 |
| 76 | 1 | 1 | 1 | 1 |
| 77 | 2 | 2 | 3 | 3 |
| 78 | 0 | 0 | 2 | 2 |
| 79 | 0 | 0 | 0 | 0 |
| 80 | 0 | 0 | 1 | 1 |
| 81 | 1 | 1 | 0 | 0 |
| 82 | 1 | 1 | 1 | 1 |
| 83 | 2 | 2 | 2 | 2 |
| 84 | 2 | 2 | 1 | 1 |
| 85 | 0 | 0 | 1 | 1 |
| 86 | 0 | 0 | 1 | 1 |
| 87 | 0 | 0 | 0 | 0 |
| 88 | 1 | 1 | 1 | 1 |
| 89 | 1 | 1 | 0 | 0 |
| 90 | 1 | 1 | 1 | 1 |
| 91 | 2 | 2 | 1 | 1 |
| 92 | 0 | 0 | 2 | 2 |
| 93 | 0 | 0 | 1 | 1 |
| 94 | 0 | 0 | 0 | 0 |
| 95 | 1 | 1 | 1 | 1 |
| 96 | 1 | 1 | 1 | 1 |
| 97 | 1 | 1 | 0 | 0 |
| 98 | 0 | 0 | 2 | 2 |
| 99 | 0 | 0 | 1 | 1 |
| 100 | 0 | 0 | 0 | 0 |
| 101 | 1 | 1 | 0 | 0 |
| 102 | 1 | 1 | 1 | 1 |
| 103 | 2 | 2 | 1 | 1 |
| 104 | 2 | 2 | 0 | 0 |
| 105 | 0 | 0 | 0 | 0 |
| 106 | 1 | 1 | 2 | 2 |
| 107 | 1 | 1 | 1 | 1 |
| 108 | 1 | 1 | 1 | 1 |
| 109 | 1 | 1 | 2 | 2 |
| 110 | 0 | 0 | 0 | 0 |
| 111 | 0 | 0 | 2 | 2 |
| 112 | 1 | 1 | 1 | 1 |
| 113 | 1 | 1 | 1 | 1 |
| 114 | 2 | 2 | 1 | 1 |
| 115 | 0 | 0 | 1 | 1 |
| 116 | 1 | 1 | 0 | 0 |
| 117 | 1 | 1 | 0 | 0 |
| 118 | 2 | 2 | 1 | 1 |
| 119 | 0 | 0 | 1 | 1 |
| 120 | 0 | 0 | 1 | 1 |
| 121 | 1 | 1 | 1 | 1 |
| 122 | 1 | 1 | 1 | 1 |
| 123 | 2 | 2 | 1 | 1 |
| 124 | 2 | 2 | 1 | 1 |
| 125 | 0 | 0 | 1 | 1 |
| 126 | 1 | 1 | 1 | 1 |
| 127 | 1 | 1 | 0 | 0 |
| 128 | 0 | 0 | 0 | 0 |
| 129 | 2 | 2 | 0 | 0 |
| 130 | 1 | 1 | 1 | 1 |
| 131 | 2 | 2 | 0 | 0 |
| 132 | 1 | 1 | 1 | 1 |
| 133 | 2 | 2 | 1 | 1 |
| 134 | 0 | 0 | 0 | 0 |
| 135 | 1 | 1 | 1 | 1 |
| 136 | 2 | 2 | 1 | 1 |
| 137 | 0 | 0 | 1 | 1 |
| 138 | 1 | 1 | 0 | 0 |
| 139 | 1 | 1 | 0 | 0 |
| 140 | 2 | 2 | 1 | 1 |
| 141 | 0 | 0 | 0 | 0 |
| 142 | 21 | 21 | 1 | 1 |
| 143 | 13 | 13 | 1 | 1 |
| 144 | 5 | 5 | 1 | 1 |
| 145 | 1 | 1 | 0 | 0 |
| 146 | 0 | 0 | 0 | 0 |
| 147 | 1 | 1 | 0 | 0 |
| 148 | 2 | 2 | 0 | 0 |
| 149 | 0 | 0 | 0 | 0 |
| 150 | 1 | 1 | 1 | 1 |
| 151 | 1 | 1 | 1 | 1 |
| 152 | 2 | 2 | 1 | 1 |
| 153 | 2 | 2 | 0 | 0 |
| 154 | 2 | 2 | 0 | 0 |
| 155 | 0 | 0 | 1 | 1 |
| 156 | 0 | 0 | 1 | 1 |
| 157 | 0 | 0 | 0 | 0 |
| 158 | 0 | 0 | 1 | 1 |
| 159 | 0 | 0 | 0 | 0 |
| 160 | 0 | 0 | 1 | 1 |
| 161 | 0 | 0 | 1 | 1 |
| 162 | 0 | 0 | 0 | 0 |
| 163 | 2 | 2 | 1 | 1 |
| 164 | 2 | 2 | 0 | 0 |
| 165 | 2 | 2 | 1 | 1 |
| 166 | 2 | 2 | 0 | 0 |
| 167 | 2 | 2 | 1 | 1 |
| 168 | 2 | 2 | 1 | 1 |
| 169 | 1 | 1 | 0 | 0 |
| 170 | 1 | 1 | 1 | 1 |
| 171 | 1 | 1 | 0 | 0 |
| 172 | 0 | 0 | 1 | 1 |
| 173 | 0 | 0 | 1 | 1 |
| 174 | 0 | 0 | 0 | 0 |
| 175 | 2 | 2 | 1 | 1 |
| 176 | 2 | 2 | 1 | 1 |
| 177 | 1 | 1 | 0 | 0 |
| 178 | 1 | 1 | 0 | 0 |
| 179 | 1 | 1 | 1 | 1 |
| 180 | 1 | 1 | 1 | 1 |
| 181 | 0 | 0 | 0 | 0 |
| 182 | 2 | 2 | 1 | 1 |
| 183 | 2 | 2 | 1 | 1 |
| 184 | 1 | 1 | 1 | 1 |
| 185 | 1 | 1 | 0 | 0 |
| 186 | 0 | 0 | 1 | 1 |
| 187 | 2 | 2 | 1 | 1 |
| 188 | 2 | 2 | 1 | 1 |
| 189 | 1 | 1 | 0 | 0 |
| 190 | 1 | 1 | 0 | 0 |
| 191 | 1 | 1 | 2 | 2 |
| 192 | 2 | 2 | 1 | 1 |
| 193 | 2 | 2 | 1 | 1 |
| 194 | 1 | 1 | 1 | 1 |
| 195 | 0 | 0 | 0 | 0 |
| 196 | 2 | 2 | 0 | 0 |
| 197 | 2 | 2 | 0 | 0 |
| 198 | 1 | 1 | 1 | 1 |
| 199 | 0 | 0 | 1 | 1 |
| 200 | 2 | 2 | 1 | 1 |
| 201 | 2 | 2 | 1 | 1 |
| 202 | 1 | 1 | 1 | 1 |
| 203 | 0 | 0 | 0 | 0 |
| 204 | 2 | 2 | 0 | 0 |
| 205 | 2 | 2 | 0 | 0 |
| 206 | 1 | 1 | 0 | 0 |
| 207 | 1 | 1 | 0 | 0 |
| 208 | 0 | 0 | 1 | 1 |
| 209 | 2 | 2 | 0 | 0 |
| 210 | 1 | 1 | 1 | 1 |
| 211 | 1 | 1 | 1 | 1 |
| 212 | 0 | 0 | 1 | 1 |
| 213 | 2 | 2 | 1 | 1 |
| 214 | 1 | 1 | 1 | 1 |
| 215 | 1 | 1 | 1 | 1 |
| 216 | 2 | 2 | 1 | 1 |
| 217 | 2 | 2 | 0 | 0 |
| 218 | 1 | 1 | 1 | 1 |
| 219 | 0 | 0 | 0 | 0 |
| 220 | 2 | 2 | 0 | 0 |
| 221 | 1 | 1 | 0 | 0 |
| 222 | 1 | 1 | 0 | 0 |
| 223 | 0 | 0 | 0 | 0 |
| 224 | 2 | 2 | 0 | 0 |
| 225 | 1 | 1 | 0 | 0 |
| 226 | 1 | 1 | 0 | 0 |
| 227 | 0 | 0 | 0 | 0 |
| 228 | 2 | 2 | 0 | 0 |
| 229 | 1 | 1 | 0 | 0 |
| 230 | 0 | 0 | 0 | 0 |
| 231 | 2 | 2 | 0 | 0 |
| 232 | 2 | 2 | 0 | 0 |
| 233 | 1 | 1 | 0 | 0 |
| 234 | 0 | 0 | 0 | 0 |
| 235 | 2 | 2 | 0 | 0 |
| 236 | 1 | 1 | 0 | 0 |
| 237 | 1 | 1 | 0 | 0 |
| 238 | 2 | 2 | −1 | 1 |
| 239 | 2 | 2 | 0 | 0 |
| 240 | 1 | 1 | 1 | 1 |
| 241 | 0 | 0 | 1 | 1 |
| 242 | 2 | 2 | 1 | 1 |
| 243 | 1 | 1 | 1 | 1 |
| 244 | 1 | 1 | 1 | 1 |
| 245 | 0 | 0 | 1 | 1 |
| ${\sum }_{i = 1}^{n}$ | −27 | 567 | 6154 | 6156 |

As set out above, ^{hj}MAE is calculated according to the following formula:

$${}^{hj} MAE = \frac{1}{n} {\sum }_{i = 1}^{n} \vert {}_{}^{hj}{T}{}_{i}^{Ob} - {}_{}^{hj}{T}{}_{i}^{Pr} \vert$$

In this example, n=246. Accordingly, ^{h1}MAE in the first mode is calculated to be 2.30° C. as follows:

^{h1}MAE= 1/246·567=2.30(2 d.p.)

^{h2}MAE in the first mode is calculated to be 25.02° C. as follows:

^{h2}MAE= 1/246·6156=25.02(2 d.p.)

### Example 2

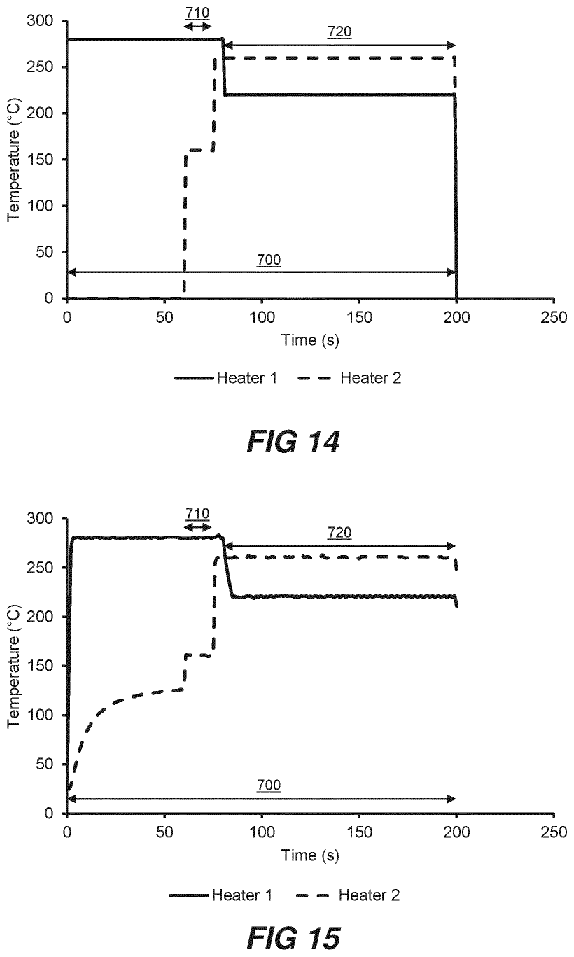

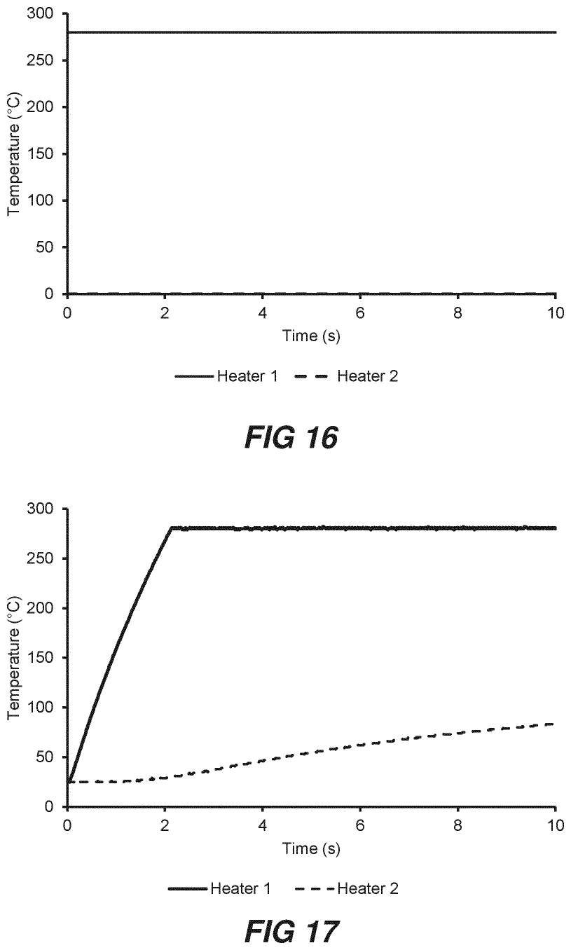

An aerosol-generating device containing the heating assembly 100 shown in FIGS. 1A and 1B was monitored during a session of use in a second mode of operation. FIGS. 14 and 16 show the programmed heating profile of the first heating unit 110 (solid line) and the second heating unit 120 (dashed line). The programmed heating profiles correspond to profiles 3 and 4 from Table 3 respectively.

The heating assembly 100 was programmed such that the first heating unit 110 should reach a maximum operating temperature of 280° C. as quickly as possible. The heating assembly 100 was programmed such that the first heating unit 110 would remain at a temperature of 280° C. for the first 80 seconds of the session of use, then drop to a temperature of 220° C. for the remainder of the session of use.

The heating assembly 100 was programmed such that the first heating unit 110 should have an average temperature across the entire session of use of 243° C.

The heating assembly 100 was programmed such that the second heating unit 120 would reach an operating temperature of 160° C. approximately 60 seconds after the start of the session of use. The heating assembly 100 was programmed such that the second heating unit 120 would subsequently rise to a maximum heating temperature of 260° C. approximately 75 seconds after the start of the session of use, and remain at that temperature until the end of the session of use, 180 seconds after the start of the session of use.

The heating assembly 100 was programmed such that the second heating unit 120 should have an average temperature across the entire session of use of 172° C.

The device was configured that the session of use 700 would comprise a first portion 710, starting approximately 60 seconds after the start of the session 700 and ending approximately 75 seconds after the start of the session 700, during which the first heating unit 110 should have a sustained temperature of 280° C. for a duration of approximately 15 seconds, and the second heating unit 120 should have a lower sustained temperature of 160° C. for 15 seconds.

The device was further configured that the session of use 700 would comprise a second portion 720, starting approximately 80 seconds after the start of the session 700 and ending approximately 200 seconds after the start of the session 700 (i.e. the end of the session 700), during which the first heating unit 110 should have a sustained temperature of 220° C. for a duration of approximately 120 seconds, and the second heating unit 120 should have a higher sustained temperature of 260° C. for 120 seconds.

FIGS. 15 and 17 show the measured temperature profiles of the first heating element 114 (solid line) and second heating element 124 (dotted line) during the session of use 700 in the second mode. Measurements were obtained from thermocouples disposed on each heating element.

As can be seen most clearly in FIG. 17, the first heating element 114 reached a maximum operating temperature of 280° C. within approximately 2 seconds of the start of the session of use 700. The first heating element reached the maximum operating temperature at a rate of approximately 120° C. per second. The first heating element 114 remained at this maximum operating temperature until 80 seconds of the session of use 700 had elapsed, at which point the temperature of the first heating element dropped rapidly to 220° C. The first heating element remained at approximately 220° C. until the end of the session of use 700, at which point the first heating element 114 cooled rapidly.

The first heating element 114 was calculated to have an average observed temperature of approximately 243° C. across the entire session of use 700.

The second heating element 124 gradually increased in temperature from the start of the session of use 700. This was attributed to thermal “bleed”—conduction, convection and/or radiation of thermal energy from the first heating element 114 to the second heating element 124. The temperature of the second heating element 124 rose rapidly to 160° C. approximately 60 seconds into the session of use 700, corresponding to the programmed heating profile of the second heating element 124. The second heating element 124 remained at this temperature until approximately 75 seconds of the session of use 700 had elapsed, and then the temperature rose rapidly to 260° C. The second heating element 124 remained at this temperature until the end of the session of use 700, at which point the second heating element 124 cooled rapidly.

The second heating element 124 was calculated to have an average observed temperature of approximately 206° C. across the entire session of use 700.

As can be seen in FIGS. 14 and 15, first and second portions 710, 720 of the session of use 700 as programmed and as observed are approximately the same.

The data obtained from this example is shown in Table 7.

TABLE 7

| Time (s) | ^{h1}T^{Pr} (° C.) | ^{h1}T^{Ob} (° C.) | ^{h2}T^{Pr} (° C.) | ^{h2}T^{Ob} (° C.) |
|---|---|---|---|---|
| 0 | 280 | 25 | 0 | 280 |
| 1 | 280 | 159 | 0 | 280 |
| 2 | 280 | 268 | 0 | 280 |
| 3 | 280 | 280 | 0 | 280 |
| 4 | 280 | 280 | 0 | 280 |
| 5 | 280 | 281 | 0 | 280 |
| 6 | 280 | 281 | 0 | 280 |
| 7 | 280 | 280 | 0 | 280 |
| 8 | 280 | 281 | 0 | 280 |
| 9 | 280 | 280 | 0 | 280 |
| 10 | 280 | 280 | 0 | 280 |
| 11 | 280 | 281 | 0 | 280 |
| 12 | 280 | 280 | 0 | 280 |
| 13 | 280 | 280 | 0 | 280 |
| 14 | 280 | 281 | 0 | 280 |
| 15 | 280 | 281 | 0 | 280 |
| 16 | 280 | 281 | 0 | 280 |
| 17 | 280 | 280 | 0 | 280 |
| 18 | 280 | 281 | 0 | 280 |
| 19 | 280 | 280 | 0 | 280 |
| 20 | 280 | 280 | 0 | 280 |
| 21 | 280 | 280 | 0 | 280 |
| 22 | 280 | 280 | 0 | 280 |
| 23 | 280 | 281 | 0 | 280 |
| 24 | 280 | 281 | 0 | 280 |
| 25 | 280 | 280 | 0 | 280 |
| 26 | 280 | 280 | 0 | 280 |
| 27 | 280 | 280 | 0 | 280 |
| 28 | 280 | 280 | 0 | 280 |
| 29 | 280 | 280 | 0 | 280 |
| 30 | 280 | 280 | 0 | 280 |
| 31 | 280 | 281 | 0 | 280 |
| 32 | 280 | 281 | 0 | 280 |
| 33 | 280 | 280 | 0 | 280 |
| 34 | 280 | 280 | 0 | 280 |
| 35 | 280 | 281 | 0 | 280 |
| 36 | 280 | 280 | 0 | 280 |
| 37 | 280 | 281 | 0 | 280 |
| 38 | 280 | 280 | 0 | 280 |
| 39 | 280 | 281 | 0 | 280 |
| 40 | 280 | 280 | 0 | 280 |
| 41 | 280 | 281 | 0 | 280 |
| 42 | 280 | 281 | 0 | 280 |
| 43 | 280 | 280 | 0 | 280 |
| 44 | 280 | 281 | 0 | 280 |
| 45 | 280 | 281 | 0 | 280 |
| 46 | 280 | 281 | 0 | 280 |
| 47 | 280 | 280 | 0 | 280 |
| 48 | 280 | 280 | 0 | 280 |
| 49 | 280 | 280 | 0 | 280 |
| 50 | 280 | 281 | 0 | 280 |
| 51 | 280 | 281 | 0 | 280 |
| 52 | 280 | 281 | 0 | 280 |
| 53 | 280 | 281 | 0 | 280 |
| 54 | 280 | 281 | 0 | 280 |
| 55 | 280 | 281 | 0 | 280 |
| 56 | 280 | 281 | 0 | 280 |
| 57 | 280 | 281 | 0 | 280 |
| 58 | 280 | 280 | 0 | 280 |
| 59 | 280 | 280 | 0 | 280 |
| 60 | 280 | 280 | 0 | 280 |
| 61 | 280 | 280 | 160 | 280 |
| 62 | 280 | 280 | 160 | 280 |
| 63 | 280 | 280 | 160 | 280 |
| 64 | 280 | 280 | 160 | 280 |
| 65 | 280 | 281 | 160 | 280 |
| 66 | 280 | 280 | 160 | 280 |
| 67 | 280 | 280 | 160 | 280 |
| 68 | 280 | 281 | 160 | 280 |
| 69 | 280 | 281 | 160 | 280 |
| 70 | 280 | 280 | 160 | 280 |
| 71 | 280 | 281 | 160 | 280 |
| 72 | 280 | 281 | 160 | 280 |
| 73 | 280 | 281 | 160 | 280 |
| 74 | 280 | 280 | 160 | 280 |
| 75 | 280 | 281 | 160 | 280 |
| 76 | 280 | 281 | 260 | 280 |
| 77 | 280 | 282 | 260 | 280 |
| 78 | 280 | 283 | 260 | 280 |
| 79 | 280 | 280 | 260 | 280 |
| 80 | 280 | 280 | 260 | 280 |
| 81 | 220 | 263 | 260 | 220 |
| 82 | 220 | 249 | 260 | 220 |
| 83 | 220 | 238 | 260 | 220 |
| 84 | 220 | 228 | 260 | 220 |
| 85 | 220 | 220 | 260 | 220 |
| 86 | 220 | 221 | 260 | 220 |
| 87 | 220 | 220 | 260 | 220 |
| 88 | 220 | 220 | 260 | 220 |
| 89 | 220 | 220 | 260 | 220 |
| 90 | 220 | 220 | 260 | 220 |
| 91 | 220 | 220 | 260 | 220 |
| 92 | 220 | 221 | 260 | 220 |
| 93 | 220 | 221 | 260 | 220 |
| 94 | 220 | 221 | 260 | 220 |
| 95 | 220 | 220 | 260 | 220 |
| 96 | 220 | 219 | 260 | 220 |
| 97 | 220 | 221 | 260 | 220 |
| 98 | 220 | 220 | 260 | 220 |
| 99 | 220 | 221 | 260 | 220 |
| 100 | 220 | 221 | 260 | 220 |
| 101 | 220 | 220 | 260 | 220 |
| 102 | 220 | 221 | 260 | 220 |
| 103 | 220 | 220 | 260 | 220 |
| 104 | 220 | 221 | 260 | 220 |
| 105 | 220 | 221 | 260 | 220 |
| 106 | 220 | 220 | 260 | 220 |
| 107 | 220 | 221 | 260 | 220 |
| 108 | 220 | 221 | 260 | 220 |
| 109 | 220 | 221 | 260 | 220 |
| 110 | 220 | 222 | 260 | 220 |
| 111 | 220 | 221 | 260 | 220 |
| 112 | 220 | 222 | 260 | 220 |
| 113 | 220 | 221 | 260 | 220 |
| 114 | 220 | 221 | 260 | 220 |
| 115 | 220 | 221 | 260 | 220 |
| 116 | 220 | 221 | 260 | 220 |
| 117 | 220 | 220 | 260 | 220 |
| 118 | 220 | 221 | 260 | 220 |
| 119 | 220 | 220 | 260 | 220 |
| 120 | 220 | 221 | 260 | 220 |
| 121 | 220 | 221 | 260 | 220 |
| 122 | 220 | 221 | 260 | 220 |
| 123 | 220 | 221 | 260 | 220 |
| 124 | 220 | 220 | 260 | 220 |
| 125 | 220 | 221 | 260 | 220 |
| 126 | 220 | 220 | 260 | 220 |
| 127 | 220 | 221 | 260 | 220 |
| 128 | 220 | 221 | 260 | 220 |
| 129 | 220 | 220 | 260 | 220 |
| 130 | 220 | 221 | 260 | 220 |
| 131 | 220 | 220 | 260 | 220 |
| 132 | 220 | 220 | 260 | 220 |
| 133 | 220 | 221 | 260 | 220 |
| 134 | 220 | 221 | 260 | 220 |
| 135 | 220 | 221 | 260 | 220 |
| 136 | 220 | 221 | 260 | 220 |
| 137 | 220 | 220 | 260 | 220 |
| 138 | 220 | 221 | 260 | 220 |
| 139 | 220 | 222 | 260 | 220 |
| 140 | 220 | 220 | 260 | 220 |
| 141 | 220 | 221 | 260 | 220 |
| 142 | 220 | 222 | 260 | 220 |
| 143 | 220 | 220 | 260 | 220 |
| 144 | 220 | 221 | 260 | 220 |
| 145 | 220 | 221 | 260 | 220 |
| 146 | 220 | 221 | 260 | 220 |
| 147 | 220 | 221 | 260 | 220 |
| 148 | 220 | 220 | 260 | 220 |
| 149 | 220 | 221 | 260 | 220 |
| 150 | 220 | 222 | 260 | 220 |
| 151 | 220 | 220 | 260 | 220 |
| 152 | 220 | 221 | 260 | 220 |
| 153 | 220 | 221 | 260 | 220 |
| 154 | 220 | 220 | 260 | 220 |
| 155 | 220 | 221 | 260 | 220 |
| 156 | 220 | 221 | 260 | 220 |
| 157 | 220 | 220 | 260 | 220 |
| 158 | 220 | 221 | 260 | 220 |
| 159 | 220 | 221 | 260 | 220 |
| 160 | 220 | 221 | 260 | 220 |
| 161 | 220 | 221 | 260 | 220 |
| 162 | 220 | 220 | 260 | 220 |
| 163 | 220 | 221 | 260 | 220 |
| 164 | 220 | 221 | 260 | 220 |
| 165 | 220 | 220 | 260 | 220 |
| 166 | 220 | 221 | 260 | 220 |
| 167 | 220 | 221 | 260 | 220 |
| 168 | 220 | 220 | 260 | 220 |
| 169 | 220 | 221 | 260 | 220 |
| 170 | 220 | 221 | 260 | 220 |
| 171 | 220 | 220 | 260 | 220 |
| 172 | 220 | 221 | 260 | 220 |
| 173 | 220 | 222 | 260 | 220 |
| 174 | 220 | 220 | 260 | 220 |
| 175 | 220 | 221 | 260 | 220 |
| 176 | 220 | 221 | 260 | 220 |
| 177 | 220 | 220 | 260 | 220 |
| 178 | 220 | 221 | 260 | 220 |
| 179 | 220 | 221 | 260 | 220 |
| 180 | 220 | 220 | 260 | 220 |
| 181 | 220 | 221 | 260 | 220 |
| 182 | 220 | 221 | 260 | 220 |
| 183 | 220 | 220 | 260 | 220 |
| 184 | 220 | 221 | 260 | 220 |
| 185 | 220 | 222 | 260 | 220 |
| 186 | 220 | 220 | 260 | 220 |
| 187 | 220 | 221 | 260 | 220 |
| 188 | 220 | 221 | 260 | 220 |
| 189 | 220 | 220 | 260 | 220 |
| 190 | 220 | 221 | 260 | 220 |
| 191 | 220 | 221 | 260 | 220 |
| 192 | 220 | 220 | 260 | 220 |
| 193 | 220 | 221 | 260 | 220 |
| 194 | 220 | 221 | 260 | 220 |
| 195 | 220 | 220 | 260 | 220 |
| 196 | 220 | 221 | 260 | 220 |
| 197 | 220 | 221 | 260 | 220 |
| 198 | 220 | 220 | 260 | 220 |
| 199 | 220 | 221 | 260 | 220 |

The deviation of the observed temperature from the programmed temperature at each timepoint is set out in Table 8. Each of the deviation values is given in degrees Celsius (° C.). Values surrounded by solid vertical lines “|” indicate the modulus or absolute value of the deviation. The sum of each deviation is given at the end of Table 8.

TABLE 8

| Time (s) | ^{h1}T^{Ob} − ^{h1}T^{Pr} | \|^{h1}T^{Ob} − ^{h1}T^{Pr}\| | ^{h2}T^{Ob} − ^{h2}T^{Pr} | \|^{h2}T^{Ob} − ^{h2}T^{Pr}\| |
|---|---|---|---|---|
| 0 | −255 | 255 | 25 | 25 |
| 1 | −121 | 121 | 25 | 25 |
| 2 | −12 | 12 | 29 | 29 |
| 3 | 0 | 0 | 37 | 37 |
| 4 | 0 | 0 | 46 | 46 |
| 5 | 1 | 1 | 54 | 54 |
| 6 | 1 | 1 | 62 | 62 |
| 7 | 0 | 0 | 68 | 68 |
| 8 | 1 | 1 | 74 | 74 |
| 9 | 0 | 0 | 79 | 79 |
| 10 | 0 | 0 | 83 | 83 |
| 11 | 1 | 1 | 87 | 87 |
| 12 | 0 | 0 | 90 | 90 |
| 13 | 0 | 0 | 96 | 96 |
| 14 | 1 | 1 | 96 | 96 |
| 15 | 1 | 1 | 99 | 99 |
| 16 | 1 | 1 | 101 | 101 |
| 17 | 0 | 0 | 103 | 103 |
| 18 | 1 | 1 | 104 | 104 |
| 19 | 0 | 0 | 106 | 106 |
| 20 | 0 | 0 | 107 | 107 |
| 21 | 0 | 0 | 108 | 108 |
| 22 | 0 | 0 | 110 | 110 |
| 23 | 1 | 1 | 111 | 111 |
| 24 | 1 | 1 | 112 | 112 |
| 25 | 0 | 0 | 113 | 113 |
| 26 | 0 | 0 | 114 | 114 |
| 27 | 0 | 0 | 115 | 115 |
| 28 | 0 | 0 | 115 | 115 |
| 29 | 0 | 0 | 116 | 116 |
| 30 | 0 | 0 | 117 | 117 |
| 31 | 1 | 1 | 117 | 117 |
| 32 | 1 | 1 | 118 | 118 |
| 33 | 0 | 0 | 118 | 118 |
| 34 | 0 | 0 | 119 | 119 |
| 35 | 1 | 1 | 119 | 119 |
| 36 | 0 | 0 | 120 | 120 |
| 37 | 1 | 1 | 120 | 120 |
| 38 | 0 | 0 | 121 | 121 |
| 39 | 1 | 1 | 121 | 121 |
| 40 | 0 | 0 | 121 | 121 |
| 41 | 1 | 1 | 121 | 121 |
| 42 | 1 | 1 | 122 | 122 |
| 43 | 0 | 0 | 122 | 122 |
| 44 | 1 | 1 | 122 | 122 |
| 45 | 1 | 1 | 123 | 123 |
| 46 | 1 | 1 | 123 | 123 |
| 47 | 0 | 0 | 123 | 123 |
| 48 | 0 | 0 | 124 | 124 |
| 49 | 0 | 0 | 124 | 124 |
| 50 | 1 | 1 | 124 | 124 |
| 51 | 1 | 1 | 124 | 124 |
| 52 | 1 | 1 | 124 | 124 |
| 53 | 1 | 1 | 124 | 124 |
| 54 | 1 | 1 | 125 | 125 |
| 55 | 1 | 1 | 125 | 125 |
| 56 | 1 | 1 | 125 | 125 |
| 57 | 1 | 1 | 125 | 125 |
| 58 | 0 | 0 | 126 | 126 |
| 59 | 0 | 0 | 126 | 126 |
| 60 | 0 | 0 | 126 | 126 |
| 61 | 0 | 0 | 1 | 1 |
| 62 | 0 | 0 | 1 | 1 |
| 63 | 0 | 0 | 1 | 1 |
| 64 | 0 | 0 | 1 | 1 |
| 65 | 1 | 1 | 1 | 1 |
| 66 | 0 | 0 | 2 | 2 |
| 67 | 0 | 0 | 1 | 1 |
| 68 | 1 | 1 | 0 | 0 |
| 69 | 1 | 1 | 1 | 1 |
| 70 | 0 | 0 | 1 | 1 |
| 71 | 1 | 1 | 1 | 1 |
| 72 | 1 | 1 | 0 | 0 |
| 73 | 1 | 1 | 0 | 0 |
| 74 | 0 | 0 | 2 | 2 |
| 75 | 1 | 1 | 1 | 1 |
| 76 | 1 | 1 | −6 | 6 |
| 77 | 2 | 2 | 0 | 0 |
| 78 | 3 | 3 | 0 | 0 |
| 79 | 0 | 0 | 1 | 1 |
| 80 | 0 | 0 | 2 | 2 |
| 81 | 43 | 43 | 0 | 0 |
| 82 | 29 | 29 | 1 | 1 |
| 83 | 18 | 18 | 0 | 0 |
| 84 | 8 | 8 | 0 | 0 |
| 85 | 0 | 0 | 0 | 0 |
| 86 | 1 | 1 | 1 | 1 |
| 87 | 0 | 0 | 0 | 0 |
| 88 | 0 | 0 | 0 | 0 |
| 89 | 0 | 0 | 1 | 1 |
| 90 | 0 | 0 | 2 | 2 |
| 91 | 0 | 0 | 0 | 0 |
| 92 | 1 | 1 | 0 | 0 |
| 93 | 1 | 1 | 2 | 2 |
| 94 | 1 | 1 | 1 | 1 |
| 95 | 0 | 0 | 1 | 1 |
| 96 | −1 | 1 | 1 | 1 |
| 97 | 1 | 1 | 1 | 1 |
| 98 | 0 | 0 | 0 | 0 |
| 99 | 1 | 1 | 0 | 0 |
| 100 | 1 | 1 | 0 | 0 |
| 101 | 0 | 0 | 1 | 1 |
| 102 | 1 | 1 | 1 | 1 |
| 103 | 0 | 0 | 0 | 0 |
| 104 | 1 | 1 | 0 | 0 |
| 105 | 1 | 1 | 1 | 1 |
| 106 | 0 | 0 | 1 | 1 |
| 107 | 1 | 1 | 0 | 0 |
| 108 | 1 | 1 | 1 | 1 |
| 109 | 1 | 1 | 0 | 0 |
| 110 | 2 | 2 | 1 | 1 |
| 111 | 1 | 1 | 0 | 0 |
| 112 | 2 | 2 | 1 | 1 |
| 113 | 1 | 1 | 0 | 0 |
| 114 | 1 | 1 | 1 | 1 |
| 115 | 1 | 1 | 0 | 0 |
| 116 | 1 | 1 | 1 | 1 |
| 117 | 0 | 0 | 0 | 0 |
| 118 | 1 | 1 | 1 | 1 |
| 119 | 0 | 0 | 1 | 1 |
| 120 | 1 | 1 | 0 | 0 |
| 121 | 1 | 1 | 2 | 2 |
| 122 | 1 | 1 | 0 | 0 |
| 123 | 1 | 1 | 1 | 1 |
| 124 | 0 | 0 | 1 | 1 |
| 125 | 1 | 1 | 0 | 0 |
| 126 | 0 | 0 | 0 | 0 |
| 127 | 1 | 1 | 1 | 1 |
| 128 | 1 | 1 | 0 | 0 |
| 129 | 0 | 0 | 0 | 0 |
| 130 | 1 | 1 | 0 | 0 |
| 131 | 0 | 0 | 3 | 3 |
| 132 | 0 | 0 | 1 | 1 |
| 133 | 1 | 1 | 0 | 0 |
| 134 | 1 | 1 | 0 | 0 |
| 135 | 1 | 1 | 1 | 1 |
| 136 | 1 | 1 | 1 | 1 |
| 137 | 0 | 0 | 1 | 1 |
| 138 | 1 | 1 | 0 | 0 |
| 139 | 2 | 2 | 1 | 1 |
| 140 | 0 | 0 | 0 | 0 |
| 141 | 1 | 1 | 1 | 1 |
| 142 | 2 | 2 | 1 | 1 |
| 143 | 0 | 0 | 1 | 1 |
| 144 | 1 | 1 | 0 | 0 |
| 145 | 1 | 1 | 0 | 0 |
| 146 | 1 | 1 | 0 | 0 |
| 147 | 1 | 1 | 0 | 0 |
| 148 | 0 | 0 | 0 | 0 |
| 149 | 1 | 1 | 1 | 1 |
| 150 | 2 | 2 | −1 | 1 |
| 151 | 0 | 0 | 1 | 1 |
| 152 | 1 | 1 | 1 | 1 |
| 153 | 1 | 1 | 1 | 1 |
| 154 | 0 | 0 | 1 | 1 |
| 155 | 1 | 1 | 1 | 1 |
| 156 | 1 | 1 | 1 | 1 |
| 157 | 0 | 0 | 1 | 1 |
| 158 | 1 | 1 | 1 | 1 |
| 159 | 1 | 1 | 1 | 1 |
| 160 | 1 | 1 | 1 | 1 |
| 161 | 1 | 1 | 1 | 1 |
| 162 | 0 | 0 | 1 | 1 |
| 163 | 1 | 1 | 1 | 1 |
| 164 | 1 | 1 | 1 | 1 |
| 165 | 0 | 0 | 1 | 1 |
| 166 | 1 | 1 | 1 | 1 |
| 167 | 1 | 1 | 1 | 1 |
| 168 | 0 | 0 | 1 | 1 |
| 169 | 1 | 1 | 1 | 1 |
| 170 | 1 | 1 | 1 | 1 |
| 171 | 0 | 0 | 1 | 1 |
| 172 | 1 | 1 | 1 | 1 |
| 173 | 2 | 2 | 0 | 0 |
| 174 | 0 | 0 | 0 | 0 |
| 175 | 1 | 1 | 0 | 0 |
| 176 | 1 | 1 | 0 | 0 |
| 177 | 0 | 0 | 0 | 0 |
| 178 | 1 | 1 | 0 | 0 |
| 179 | 1 | 1 | 0 | 0 |
| 180 | 0 | 0 | 1 | 1 |
| 181 | 1 | 1 | 1 | 1 |
| 182 | 1 | 1 | 1 | 1 |
| 183 | 0 | 0 | 1 | 1 |
| 184 | 1 | 1 | 1 | 1 |
| 185 | 2 | 2 | 1 | 1 |
| 186 | 0 | 0 | 0 | 0 |
| 187 | 1 | 1 | 0 | 0 |
| 188 | 1 | 1 | 0 | 0 |
| 189 | 0 | 0 | 1 | 1 |
| 190 | 1 | 1 | 1 | 1 |
| 191 | 1 | 1 | 1 | 1 |
| 192 | 0 | 0 | 1 | 1 |
| 193 | 1 | 1 | 0 | 0 |
| 194 | 1 | 1 | 0 | 0 |
| 195 | 0 | 0 | 0 | 0 |
| 196 | 1 | 1 | 1 | 1 |
| 197 | 1 | 1 | 1 | 1 |
| 198 | 0 | 0 | 1 | 1 |
| 199 | 1 | 1 | 2 | 2 |
| ${\sum }_{i = 1}^{n}$ | −167 | 611 | 6460 | 6474 |

As set out above, ^{hj}MAE is calculated according to the following formula:

$${}^{hj} MAE = \frac{1}{n} {\sum }_{i = 1}^{n} \vert {}_{}^{hj}{T}{}_{i}^{Ob} - {}_{}^{hj}{T}{}_{i}^{Pr} \vert$$

In this example, n=200. Accordingly, ^{h1}MAE in the second mode is calculated to be 3.06° C. as follows:

^{h1}MAE= 1/200·611=3.06(2 d.p.)

^{h2}MAE in the second mode is calculated to be 32.37° C. as follows:

^{h2}MAE= 1/200·6474=32.37(2 d.p.)

There will necessarily be a lag between the programmed heating profile of a heating unit and the observed temperature profile. However, as shown in this example, this lag is minimized in the aerosol-generating device of the present invention.

### Example 3

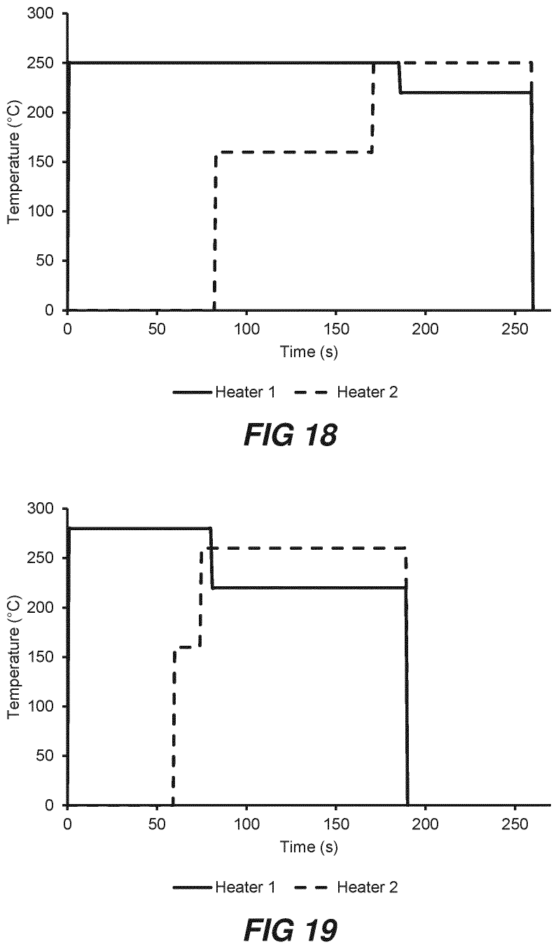

An aerosol-generating device containing the heating assembly 100 shown in FIG. 1 was monitored during another session of use in a first mode of operation. FIG. 18 shows the programmed heating profile of the first heating unit 110 (solid line) and the second heating unit 120 (dashed line). The programmed heating profiles correspond to profiles 5 and 6 from Table 3 respectively.

The heating assembly 100 was programmed such that the first heating unit 110 should reach a maximum operating temperature of 250° C. as quickly as possible. The heating assembly 100 was programmed such that the first heating unit 110 would remain at a temperature of 250° C. for the first 185 seconds of the session of use, then drop to a temperature of 220° C. for the remainder of the session of use.

The heating assembly 100 was programmed such that the first heating unit 110 should have an average temperature across the entire session of use of 240° C.

The heating assembly 100 was programmed such that the second heating unit 120 would reach an operating temperature of 160° C. approximately 82 seconds after the start of the session of use. The heating assembly 100 was programmed such that the second heating unit 120 would subsequently rise to a maximum heating temperature of 250° C. approximately 170 seconds after the start of the session of use, and remain at that temperature until the end of the session of use, 260 seconds after the start of the session of use.

The heating assembly 100 was programmed such that the second heating unit 120 should have an average temperature across the entire session of use of 139° C.

The device was configured such that the session of use would comprise a first portion starting approximately 82 seconds after the start of the session and ending approximately 170 seconds after the start of the session, during which the first heating unit 110 should have a sustained temperature of 250° C. for a duration of approximately 88 seconds, and the second heating unit 120 should have a lower sustained temperature of 160° C. for 88 seconds.

The device was configured such that the session of use would comprise a second portion starting approximately 185 seconds after the start of the session and ending approximately 260 seconds after the start of the session (i.e. the end of the session), during which the first heating unit 110 should have a sustained temperature of 220° C. for a duration of approximately 75 seconds, and the second heating unit 120 should have a higher sustained temperature of 250° C. for 75 seconds.

An aerosol-generating device containing the heating assembly 100 shown in FIG. 1 was monitored during another session of use in a second mode of operation. FIG. 19 shows the programmed heating profile of the first heating unit 110 (solid line) and the second heating unit 120 (dashed line). The programmed heating profiles correspond to profiles 7 and 8 from Table 3 respectively.

The heating assembly 100 was programmed such that the first heating unit 110 should reach a maximum operating temperature of 280° C. as quickly as possible. The heating assembly 100 was programmed such that the first heating unit 110 would remain at a temperature of 280° C. for the first 80 seconds of the session of use, then drop to a temperature of 220° C. for the remainder of the session of use.

The heating assembly 100 was programmed such that the first heating unit 110 should have an average temperature across the entire session of use of 243° C.

The heating assembly 100 was programmed such that the second heating unit 120 would reach an operating temperature of 160° C. approximately 60 seconds after the start of the session of use. The heating assembly 100 was programmed such that the second heating unit 120 would subsequently rise to a maximum heating temperature of 260° C. approximately 75 seconds after the start of the session of use, and remain at that temperature until the end of the session of use, 190 seconds after the start of the session of use.

The heating assembly 100 was programmed such that the second heating unit 120 should have an average temperature across the entire session of use of 169° C.

The device was configured such that the session of use would comprise a first portion starting approximately 60 seconds after the start of the session and ending approximately 75 seconds after the start of the session, during which the first heating unit 110 should have a sustained temperature of 280° C. for a duration of approximately 15 seconds, and the second heating unit 120 should have a lower sustained temperature of 160° C. for 15 seconds.

The device was configured such that the session of use would comprise a second portion starting approximately 80 seconds after the start of the session and ending approximately 190 seconds after the start of the session (i.e. the end of the session), during which the first heating unit 110 should have a sustained temperature of 220° C. for a duration of approximately 110 seconds, and the second heating unit 120 should have a higher sustained temperature of 260° C. for 110 seconds.

### Example 4

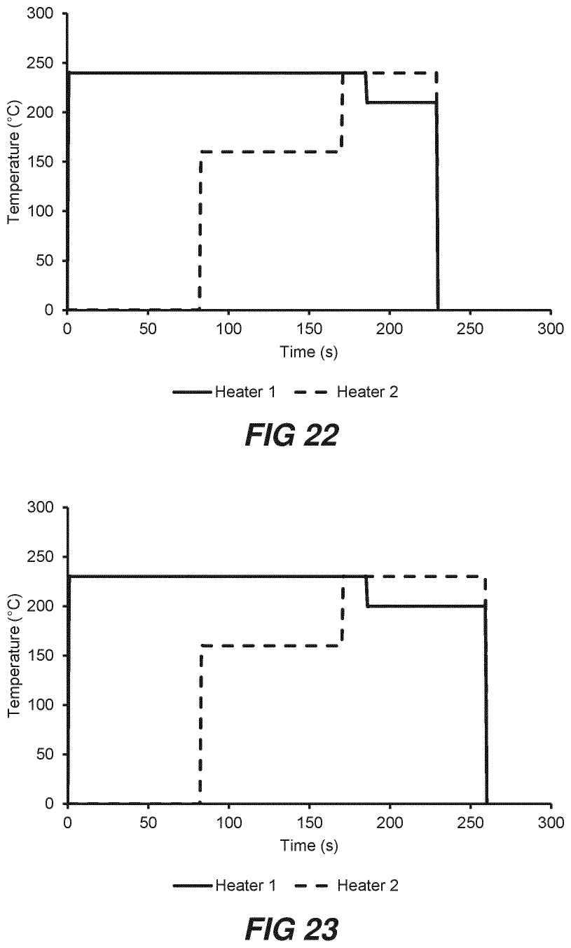

An aerosol-generating device containing the heating assembly 100 shown in FIG. 1 was monitored during session of use in a first mode of operation. FIG. 22 shows the programmed heating profile of the first heating unit 110 (solid line) and the second heating unit 120 (dashed line). The programmed heating profiles correspond to profiles 13 and 14 respectively from Table 3.

The heating assembly 100 was programmed such that the first heating unit 110 should reach a maximum operating temperature of 230° C. as quickly as possible. The heating assembly 100 was programmed such that the first heating unit 110 would remain at a temperature of 230° C. for the first 185 seconds of the session of use, then drop to a temperature of 200° C. for the remainder of the session of use.

The heating assembly 100 was programmed such that the first heating unit 110 should have an average temperature across the entire session of use of 220° C.

The heating assembly 100 was programmed such that the second heating unit 120 would reach an operating temperature of 160° C. approximately 82 seconds after the start of the session of use. The heating assembly 100 was programmed such that the second heating unit 120 would subsequently rise to a maximum heating temperature of 230° C. approximately 170 seconds after the start of the session of use, and remain at that temperature until the end of the session of use, 260 seconds after the start of the session of use.

The heating assembly 100 was programmed such that the second heating unit 120 should have an average temperature across the entire session of use of 132° C.

The device was configured such that the session of use would comprise a first portion starting approximately 82 seconds after the start of the session and ending approximately 170 seconds after the start of the session, during which the first heating unit 110 should have a sustained temperature of 230° C. for a duration of approximately 88 seconds, and the second heating unit 120 should have a lower sustained temperature of 160° C. for 88 seconds.

The device was configured such that the session of use would comprise a second portion starting approximately 185 seconds after the start of the session and ending approximately 260 seconds after the start of the session (i.e. the end of the session), during which the first heating unit 110 should have a sustained temperature of 200° C. for a duration of approximately 75 seconds, and the second heating unit 120 should have a higher sustained temperature of 230° C. for 75 seconds.

### Example 5

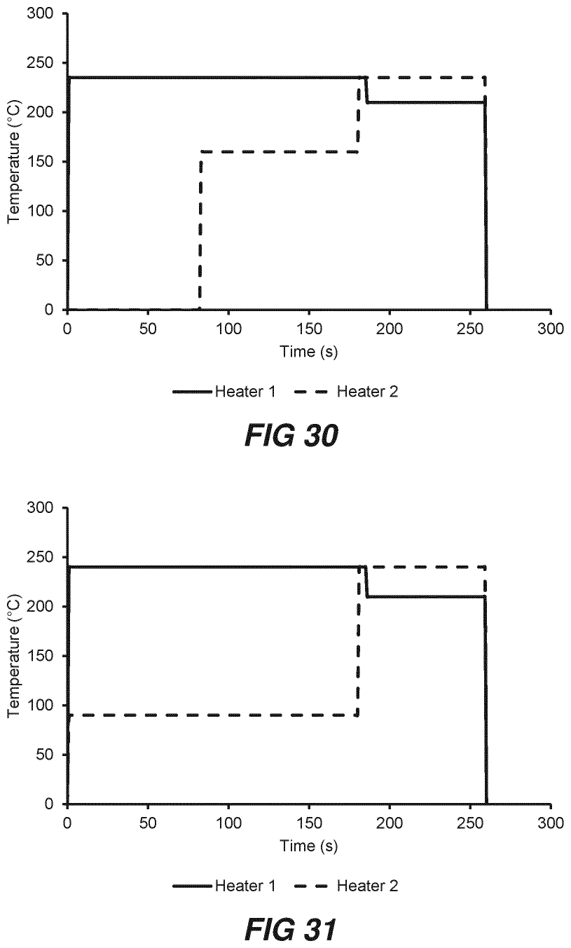

An aerosol-generating device containing the heating assembly 100 shown in FIG. 1 was monitored during a session of use in a first mode of operation. FIG. 30 shows the programmed heating profile of the first heating unit 110 (solid line) and the second heating unit 120 (dashed line). The programmed heating profiles correspond to profiles 27 and 28 respectively from Table 3.

The heating assembly 100 was programmed such that the first heating unit 110 should reach a maximum operating temperature of 235° C. as quickly as possible. The heating assembly 100 was programmed such that the first heating unit 110 would remain at a temperature of 235° C. for the first 185 seconds of the session of use, then drop to a temperature of 210° C. for the remainder of the session of use.

The heating assembly 100 was programmed such that the first heating unit 110 should have an average temperature across the entire session of use of 226° C.

The heating assembly 100 was programmed such that the second heating unit 120 would reach an operating temperature of 160° C. approximately 82 seconds after the start of the session of use. The heating assembly 100 was programmed such that the second heating unit 120 would subsequently rise to a maximum heating temperature of 235° C. approximately 180 seconds after the start of the session of use, and remain at that temperature until the end of the session of use, 260 seconds after the start of the session of use.

The heating assembly 100 was programmed such that the second heating unit 120 should have an average temperature across the entire session of use of 131° C.

The device was configured such that the session of use would comprise a first portion starting approximately 82 seconds after the start of the session and ending approximately 180 seconds after the start of the session, during which the first heating unit 110 should have a sustained temperature of 235° C. for a duration of approximately 98 seconds, and the second heating unit 120 should have a lower sustained temperature of 160° C. for 98 seconds.

The device was configured such that the session of use would comprise a second portion starting approximately 185 seconds after the start of the session and ending approximately 260 seconds after the start of the session (i.e. the end of the session), during which the first heating unit 110 should have a sustained temperature of 210° C. for a duration of approximately 75 seconds, and the second heating unit 120 should have a higher sustained temperature of 235° C. for 75 seconds.

### Example 6

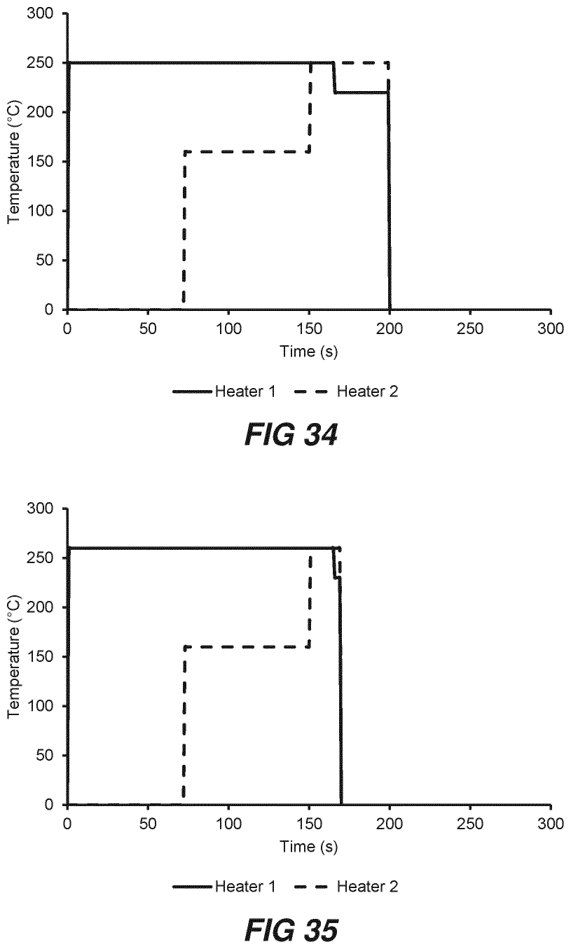

An aerosol-generating device containing the heating assembly 100 shown in FIG. 1 was monitored during another session of use in a second mode of operation. FIG. 34 shows the programmed heating profile of the first heating unit 110 (solid line) and the second heating unit 120 (dashed line). The programmed heating profiles correspond to profiles 35 and 36 respectively from Table 3.

The heating assembly 100 was programmed such that the first heating unit 110 should reach a maximum operating temperature of 250° C. as quickly as possible. The heating assembly 100 was programmed such that the first heating unit 110 would remain at a temperature of 250° C. for the first 165 seconds of the session of use, then drop to a temperature of 220° C. for the remainder of the session of use.

The heating assembly 100 was programmed such that the first heating unit 110 should have an average temperature across the entire session of use of 242° C.

The heating assembly 100 was programmed such that the second heating unit 120 would reach an operating temperature of 160° C. approximately 72 seconds after the start of the session of use. The heating assembly 100 was programmed such that the second heating unit 120 would subsequently rise to a maximum heating temperature of 250° C. approximately 150 seconds after the start of the session of use, and remain at that temperature until the end of the session of use, 200 seconds after the start of the session of use.

The heating assembly 100 was programmed such that the second heating unit 120 should have an average temperature across the entire session of use of 123° C.

The device was configured such that the session of use would comprise a first portion starting approximately 73 seconds after the start of the session and ending approximately 150 seconds after the start of the session, during which the first heating unit 110 should have a sustained temperature of 250° C. for a duration of approximately 78 seconds, and the second heating unit 120 should have a lower sustained temperature of 160° C. for 78 seconds.

The device was configured such that the session of use would comprise a second portion starting approximately 165 seconds after the start of the session and ending approximately 200 seconds after the start of the session (i.e. the end of the session), during which the first heating unit 110 should have a sustained temperature of 220° C. for a duration of approximately 35 seconds, and the second heating unit 120 should have a higher sustained temperature of 250° C. for 35 seconds.

### Example 7

An aerosol-generating device containing the heating assembly 100 shown in FIG. 1 was monitored during another session of use in a second mode of operation. FIG. 31 shows the programmed heating profile of the first heating unit 110 (solid line) and the second heating unit 120 (dashed line). The programmed heating profiles correspond to profiles 39 and 40 respectively from Table 3.

The heating assembly 100 was programmed such that the first heating unit 110 should reach a maximum operating temperature of 250° C. as quickly as possible. The heating assembly 100 was programmed such that the first heating unit 110 would remain at a temperature of 250° C. for the first 165 seconds of the session of use, then drop to a temperature of 230° C. for the remainder of the session of use.

The heating assembly 100 was programmed such that the first heating unit 110 should have an average temperature across the entire session of use of 247° C.

The heating assembly 100 was programmed such that the second heating unit 120 would reach an operating temperature of 160° C. approximately 72 seconds after the start of the session of use. The heating assembly 100 was programmed such that the second heating unit 120 would subsequently rise to a maximum heating temperature of 250° C. approximately 150 seconds after the start of the session of use, and remain at that temperature until the end of the session of use, 170 seconds after the start of the session of use.

The heating assembly 100 was programmed such that the second heating unit 120 should have an average temperature across the entire session of use of 101° C.

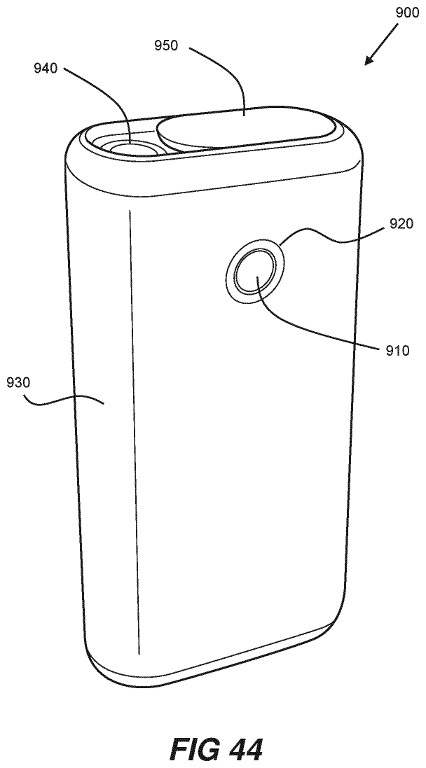

FIG. 44 shows an example of an aerosol-generating device 900 according to aspects of the present disclosure. The device comprises a user interface 910 and an indicator 920. In this example, the user interface 910 is a push button. The indicator 920 comprises a visual indicator. Preferably, the indicator 920 also comprises a haptic indicator (not shown). The haptic indicator of the indicator 920 is disposed apart from the visual indicator in the device 900.

The indicator 920 is arranged to surround the user interface 910. It has been found by the present inventors that arranging the indicator 920 to surround the user interface 910 may mean that a user finds the device simpler to operate.

As shown in FIG. 44, the user interface 910 has a substantially circular shape in a first plane. Preferably, the user interface 910 extends in a dimension perpendicular to the first plane. That is, the user interface 910 preferably has a convex or concave shape. The user interface 910 may advantageously form a concave shape on the surface of the device. Providing the user interface 910 with a concave shape may allow for simpler and more accurate operation of the device with the fingertip of a user.

The indicator 920 also has a substantially circular outline. Preferably, the indicator 920 is provided as an annulus so that the user interface 910 may be provided in the center of the indicator 920.

The device 900 comprises a housing 930. The housing 930 may be provided with a receptacle 940 for receiving an aerosol-generating article in use. The receptacle 940 comprises a heating assembly (not shown) for heating, but not burning, the aerosol-generating article disposed therein. The device 900 may optionally further comprise a movable cover 950 for covering the opening of the receptacle 940 when the device is not in use. Preferably, the movable cover 950 is a sliding cover.

A user may interact with the user interface 910 to activate the device. The device is configured such that the device is activated by depression of the push button by a user.

In this example, the device is configured to operating in two modes—a “normal” mode and a “boost” mode. The user may interact with the user interface 910 to select a mode of operation. The device is configured such that the modes of operation are selectable by depressing the push button for differing periods. Once a mode of operation is selected, power is supplied to at least one heating unit in the heating assembly.

The device 900 is configured such that, once a mode of operation has been selected by a user, the indicator 920 indicates the selected mode to the user. The selected mode is indicated by activation of light sources in the visual indicator component of the indicator 920 in a pre-determined manner. The selected mode is also indicated by activation of the haptic indicator component of the indicator 920 in a pre-determined manner.

At least one component of the indicator 920 continues to indicate the selected mode to the user until the device is ready for use. Preferably, the visual indicator portion of the indicator 920 continues to indicate the selected mode from the point at which the mode is selected until the device is ready for use, at which point the indicator indicates that the device is ready for use.

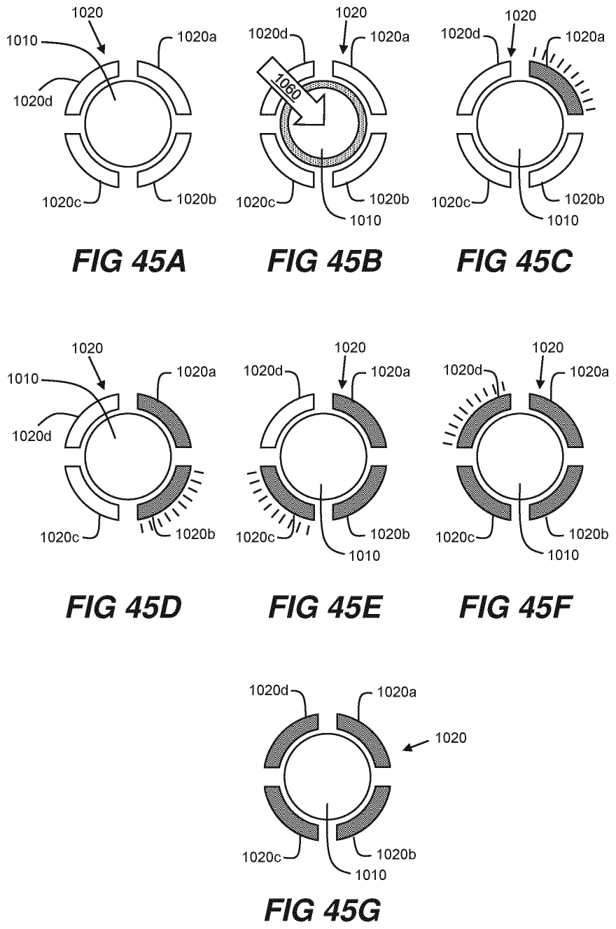

FIGS. 45A to 45G show a user selecting a first mode of operation using user interface 1010, and indicator 1020 indicating the selected mode while the device ramps up (the period between selection of the mode of operation and indicating to the user that the device is ready for use). User interface 1010 and indicator 1020 are examples of the user interface 910 and the indicator 920 shown in FIG. 44.

Indicator 1020 comprises a haptic indicator component (not shown) as well as a visual indicator component. The visual indicator component comprises a plurality of light sources 1020a-1020d.

FIG. 45A shows user interface 1010 and indicator 1020 before the device is activated. FIG. 45B shows depression 1060 of the user interface 1010 for a first duration. Upon depression 1060 of the user interface, the device is activated. Preferably, the device is configured such that a continuing depression 1060 of three seconds from activation of the device selects the first mode of use. After the depression 1060 of three seconds, the haptic indicator component indicates that the first mode has been selected by a single vibration pulse and that the user should terminate depression 1060 of the user interface 1010 to select the first mode. In some embodiments, once the user has terminated depression 1060, it is not possible to re-select a mode of operation until the session of use has ended.

Once the user has terminated depression 1060 of the user interface 1010, the visual indicator indicates that the first mode has been selected while the device ramps up to be ready for use. The light sources 1020a-1020d of the visual indicator component are sequentially activated. The light sources may activate clockwise or counter-clockwise. Preferably, as shown in FIGS. 45C to 45F, the light sources sequentially activate clockwise.

First, the first light source 1020a is activated (FIG. 45C). Preferably, once activated, the first light source 1020a is activated intermittently (i.e. pulses on and off) until the second light source 1020b is first activated (FIG. 45D). The second light source 1020b may be first activated approximately 5 seconds after selection of the first mode. Once the second light source 1020b is activated, the first light source 1020a is activated continuously (i.e. stops pulsing) until the device is ready for use, and the second light source 1020b is activated intermittently (i.e. pulses on and off). The second light source 1020b is activated intermittently until the third light source 1020c is first activated (FIG. 45E). The third light source 1020c may be first activated approximately 10 seconds after selection of the first mode. Once the third light source 1020c is activated, the second light source 1020b is activated continuously until the device is ready for use, and the third light source 1020c is activated intermittently. The third light source 1020c is activated intermittently until the fourth light source 1020d is first activated (FIG. 45F). The fourth light source 1020d may be first activated approximately 15 seconds after selection of the first mode. Once the fourth light source 1020d is activated, the third light source 1020c is activated continuously until the device is ready for use, and the fourth light source 1020d is activated intermittently.

The device is then configured to indicate when the device is ready for use in the first mode (FIG. 45G). The indicator 1020 may indicate that the device is ready for use approximately 20 seconds after selection of the first mode. The indicator 1020 indicates that the device is ready for use by continuously activating each of the light sources 1020a-1020d of the visual indicator component of the indicator 1020, and by activation of the haptic indicator component (not shown) for a single vibration pulse.

Preferably, each of the light sources 1020a-1020d continues to be activated after the device is ready for use. In one embodiment (not shown), all of the light sources continue to be activated until some of the light sources are deactivated to indicate that the session of use is nearly at an end. For example, after indication that the device is ready for use (FIG. 45G) all of the light sources 1020a-1020d are activated continuously until 20 seconds before the end of the programmed session of use, at which point three of the light sources (e.g. 1020b-1020d) are deactivated, leaving only one light source 1020a activated. The haptic indicator component may also be activated for a single pulse when the three light sources 1020b-1020d are deactivated. Then, at the end of the session of use, all of the light sources 1020a-1020d may be deactivated to indicate the end of the session of use.

The device may be configured such that the session of use has a predetermined duration in the first mode. For example, the session of use may have a duration of from approximately 2 minutes 30 seconds to 5 minutes in the first mode, or preferably from approximately 3 minutes to 4 minutes 30 seconds.

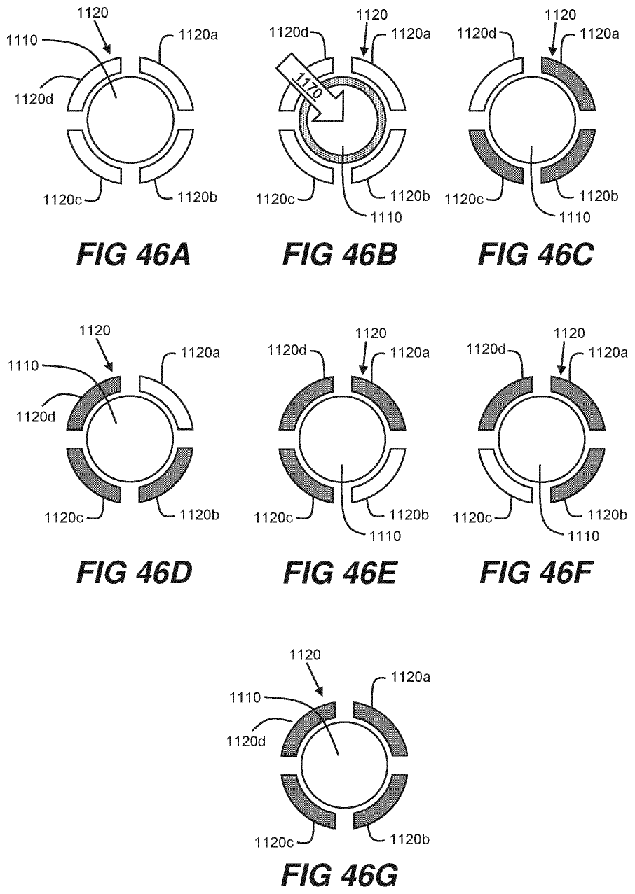

FIGS. 46A to 46G show a user selecting a first mode of operation using user interface 1110, and indicator 1120 indicating the selected mode while the device ramps up. User interface 1110 and indicator 1120 are examples of the user interface 910 and the indicator 920 shown in FIG. 44.

Indicator 1120 comprises a haptic indicator component (not shown) as well as a visual indicator component. The visual indicator component comprises a plurality of light sources 1120a-1120d.

FIG. 46A shows user interface 1110 and indicator 1120 before the device is activated. FIG. 46B shows depression 1170 of the user interface 1110 for a first duration. Upon depression 1170 of the user interface 1110, the device is activated. Preferably, the device is configured such that a continuing depression 1170 of three seconds from activation of the device selects the first mode of use, as described hereinabove with reference to FIGS. 2A to 2G. After the depression 1170 of three seconds, the haptic indicator component indicates that the first mode has been selected by a single vibration pulse and that the user should terminate depression 1170 of the user interface 1110 to select the first mode.

The device is configured such that continued depression 1170 of the user interface 1110 for a total of approximately five seconds (i.e. continued depression of approximately two seconds past the single vibration pulse indicating that the first mode of operation has been selected) selects the second mode of use. After the depression 1170 of five seconds, the haptic indicator component indicates that the second mode has been selected by two vibration pulses (a “double pulse”) and that the user should terminate depression 1170 of the user interface 1110 at that point to select the second mode.

Once the user has terminated depression 1170 of the user interface 1110 after five seconds, the visual indicator indicates that the second mode has been selected while the device ramps up to be ready for use. The light sources 1120a-1120d of the visual indicator component are sequentially activated. The light sources may activate clockwise or counter-clockwise. Preferably, as shown in FIGS. 46C to 46F, the light sources sequentially activate clockwise. The sequence differs from the sequence used to indicate selection of the first mode of operation.

First, the first, second and third light sources 1120a-1120c are activated (FIG. 46C). Sometime after activation of the first, second and third light source 1120a-1120c (for example, approximately 500 ms), the first light source 1120a is deactivated, and the fourth light source 1120d is activated (FIG. 46D). After a further period of time (preferably the same amount of time, such as approximately 500 ms), the second light source 1120b is deactivated, and the first light source 1120a is activated (FIG. 46E). After a further period of time (preferably the same amount of time, such as approximately 500 ms), the third light source 1120c is deactivated, and the second light source 1120d is activated (FIG. 46F). After a further period of time (preferably the same amount of time, approximately 500 ms), the fourth light source 1120d is deactivated, and the third light source 1120c is activated (back to FIG. 46C). The visual indicator component of the indicator 1120 continues to cycle through the sequence shown from FIG. 46C to FIG. 46F while the device ramps up, until the device is ready for use.

The device is then configured to indicate when the device is ready for use in the second mode (FIG. 46F). The indicator 1120 may indicate that the device is ready for use approximately 20 seconds after selection of the second mode, preferably approximately 10 seconds after selection of the second mode. The cycling sequence shown in FIGS. 46C to 46F stops, and the indicator 1120 indicates that the device is ready for use by continuous activation of each of the light sources 1120a-1120d of the visual indicator component of the indicator 1120, and by activation of the haptic indicator component (not shown) for a double pulse vibration.

As in the first mode, each of the light sources 1120a-1120d preferably continues to be activated after the device is ready for use. In one embodiment (not shown), all of the light sources continue to be activated until some of the light sources are deactivated to indicate that the session of use is nearly at an end. For example, all of the light sources 1120a-1120d are activated until 20 seconds before the end of the programmed session of use, at which point three of the light sources (e.g. 1120b-1120d) are deactivated, leaving only one light source 1120a activated. The haptic indicator component may also be activated for a single pulse when the three light sources 1120b-1120d are deactivated. Then, at the end of the session of use, all of the light sources 1120a-1120d may be deactivated to indicate the end of the session of use.

In a particularly preferred embodiment, the device is configured such that the indicator 1120 operates in the second mode in the same way as the indicator 220 in the first mode from the point at which the device is ready for use.

The device may be configured such that the session of use has a predetermined duration in the second mode. In a preferred embodiment, the session of use in the second mode has a duration different from the session of use in the first mode. In some examples, the session of use in the second mode may have a duration of from approximately 2 minutes to 4 minutes 30 seconds in the second mode, or preferably from approximately 2 minutes 30 seconds to 4 minutes.

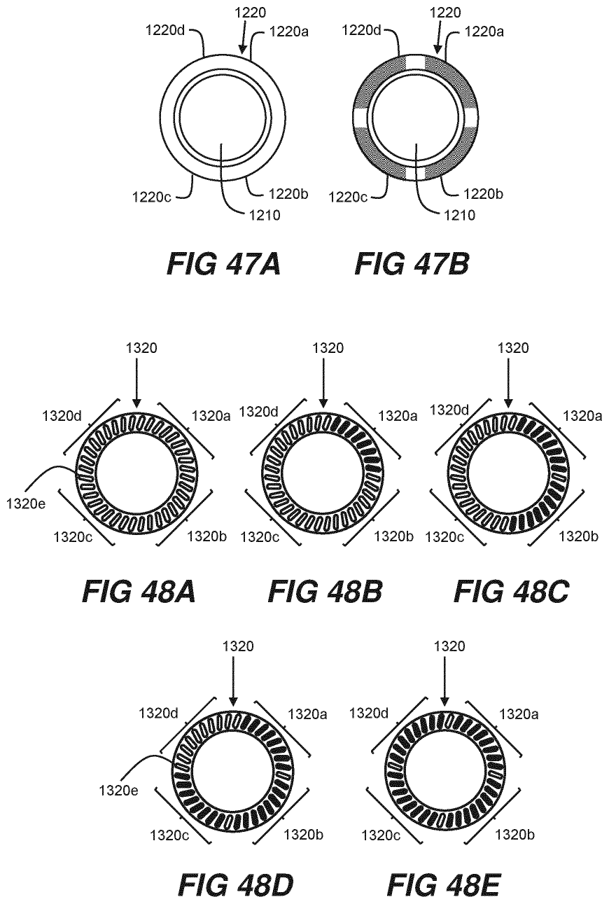

FIGS. 45A to 45G and 46A to 46G are representative examples of an indicator comprising a plurality of light sources. In these figures, the light sources are shown as visibly distinct to a user even when deactivated. However, this is not necessarily required. For example, FIGS. 47A and 47B show a user interface 1210 and an indicator 1220 according to the present invention. FIG. 47A shows the user interface 1220 when the device is deactivated and none of the component light sources are activated; FIG. 47B shows the user interface when a plurality of the component light sources 1220a-1220d are activated. In this example, the light sources forming the visual indicator component are substantially visibly indistinct before activation of the light sources, but are distinct after activation of the light sources.

As described hereinabove, a single light source may comprise a plurality of light sources which are configured to act as one. FIGS. 48A to 48E show an example of such an indicator.

FIGS. 48A to 48E show the sequence indicating selection of the first mode corresponding to that shown in FIGS. 45A to 45G. In this example, the indicator 1320 comprises a large number of sources of light (shown as 1320e in FIGS. 48A and 48D). These sources of light may be referred to in this example as “perforations” with reference to the appearance to a user. In this example, a number of perforations may act as a single light source 1320a, 1320b, 1320c or 1320d, because each section is controlled as one in the sequence indicating selection of the first mode. Thus, in the example shown in FIGS. 48A to 48E, the indicator may be said to include a total of four light sources 1320a-1320d. Nevertheless, the device may be configured such that the perforations may in other indications form a different number of light sources, such as for indicating an error with the device.

In another example, the visual appearance of the indicator 1320 can be achieved with four separate LED light sources arranged behind a cover, wherein the cover includes perforations to give the appearance of many smaller light sources to the user.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

### CLAUSES

1. An aerosol-generating device for generating aerosol from an aerosol-generating material, the aerosol-generating device comprising:

a heating assembly having a mouth end and a distal end, the heating assembly comprising: a first induction heating unit arranged to heat, but not burn, the aerosol-generating material in use;

a second induction heating unit arranged to heat, but not burn, the aerosol-generating material in use, the first induction heating unit being disposed closer to the mouth end of the heating assembly than the second induction heating unit; and
a controller for controlling the first and second induction heating units;
wherein the heating assembly is configured such that at least one induction heating unit reaches a maximum operating temperature within 20 seconds of supplying power to the at least one induction heating unit.
2. An aerosol-generating device for generating aerosol from an aerosol-generating material, the aerosol-generating device comprising:
a heating assembly having a mouth end and a distal end, the heating assembly comprising:
a first induction heating unit arranged to heat, but not burn, the aerosol-generating material in use;
a second induction heating unit arranged to heat, but not burn, the aerosol-generating material in use, the first induction heating unit being disposed closer to the mouth end of the heating assembly than the second induction heating unit; and
a controller for controlling the first and second induction heating units;
wherein the heating assembly is configured such that at least one induction heating unit reaches a maximum operating temperature at a rate of at least 50° C. per second in use.
3. An aerosol-generating device according to clause 1 or 2, wherein the at least one induction heating unit includes the first induction heating unit.
4. An aerosol-generating device according to any preceding clause, wherein the first inductive heating unit is controllable independent from the second inductive heating unit.
5. An aerosol-generating device according to any preceding clause, wherein the heating assembly is configured such that the first and second induction heating units have temperature profiles which differ from each other in use.
6. An aerosol-generating device according to any preceding clause, wherein the wherein the heating assembly is configured such that in use the second induction unit rises from a first operating temperature to a maximum operating temperature which is higher than the first operating temperature at a rate of at least 50° C. per second.
7. An aerosol-generating device according to any of the preceding clauses, wherein the heating assembly is configured such that the first induction heating unit reaches a maximum operating temperature within 2 seconds of activating the device.
8. An aerosol-generating device for generating aerosol from an aerosol-generating material, the aerosol-generating device comprising:

a heating assembly having a mouth end and a distal end, the heating assembly comprising:

a first heating unit arranged to heat, but not burn, the aerosol-generating material in use;
a second heating unit arranged to heat, but not burn, the aerosol-generating material in use, the first heating unit being disposed closer to the mouth end of the heating assembly than the second heating unit; and
a controller for controlling the first and second heating units;
wherein the heating assembly is configured such that at least one heating unit reaches a maximum operating temperature within 15 seconds of supplying power to the first heating unit.
9. An aerosol-generating device according to clause 8, wherein the at least one heating unit includes the first heating unit.
10. An aerosol-generating device according to any preceding clause, wherein the aerosol-generating device is configured to generate aerosol from a non-liquid aerosol-generating material.
11. An aerosol-generating device according to clause 10, wherein the non-liquid aerosol-generating material comprises tobacco.
12. An aerosol-generating device according to clause 11, wherein the aerosol-generating device is a tobacco heating product.
13. An aerosol-generating device according to any preceding clause, further comprising an indicator for indicating to a user that the device is ready for use within 20 seconds of activating the device.
14. An aerosol-generating device according to any of preceding clause, wherein the maximum operating temperature of the first heating unit is from approximately 200° C. to approximately 300° C.
15. An aerosol-generating device according to any preceding clause comprising a further heating unit.
16. A method of generating aerosol from an aerosol-generating material using an aerosol-generating device according to any of clauses 1 to 15, the method comprising supplying power to at least one heating unit such that the at least one heating unit reaches its maximum operating temperature within 20 seconds of supplying the power to the at least one heating unit.
17. An aerosol-generating system comprising an aerosol-generating device according to any of clauses 1 to 15 in combination with an aerosol-generating article.
18. Use of an aerosol-generating device according to any of clauses 1 to 15.
19. An aerosol-generating aerosol from an aerosol-generating material, the aerosol-generating device comprising:
a heating assembly including one or more heating units arranged to heat, but not burn, the aerosol-generating material in use; and
a controller for controlling the one or more heating units;
wherein the heating assembly is operable in at least a first mode and a second mode;
the first mode comprising supplying energy to the one or more heating units for a first-mode session of use having a first predetermined duration; and
the second mode comprising supplying energy to the one or more heating units for a second-mode session of use having a second predetermined duration;
wherein the first predetermined duration is different from the second predetermined duration.
20. An aerosol-generating device according to clause 19, wherein the first predetermined duration is longer than the second predetermined duration.
21. An aerosol-generating device according to clause 19 or 20, wherein the heating plurality of heating units, the plurality comprising a first heating unit arranged to heat, but not burn, the aerosol-generating material in use, and a second heating unit arranged to heat, but not burn, the aerosol-generating material in use.
22. An aerosol-generating device according to clause 21, wherein
the first mode comprises supplying energy to the first heating unit for a first-mode predetermined duration; and
the second mode comprises supplying energy to the first heating unit for a second-mode predetermined duration;
wherein the first-mode predetermined duration of supplying energy to the first heating unit is different from the second-mode predetermined duration of supplying energy to the first heating unit.
23. An aerosol-generating device according to clause 22, wherein the first-mode predetermined duration of supplying energy to the first heating unit is from approximately 3 minutes to 5 minutes.
24. An aerosol-generating device according to clause 22 or clause 23, wherein the second-mode predetermined duration of supplying energy to the first heating unit is from approximately 2 minutes 30 seconds to 3 minutes 30 seconds.
25. An aerosol-generating device according to any of clauses 4 to 24, wherein the first mode comprises supplying energy to the second heating unit for a first-mode predetermined duration; and
the second mode comprises supplying energy to the second heating unit for a second-mode predetermined duration.
wherein the first-mode predetermined duration of supplying energy to the second heating unit is different from the second-mode predetermined duration of supplying energy to the first heating unit.
26. An aerosol-generating device according to clause 25, wherein the first-mode predetermined duration of supplying energy to the second heating unit is from approximately 2 minutes to 3 minutes 30 seconds.
27. An aerosol-generating device according to clause 25 or 26, wherein the second-mode predetermined duration of supplying energy to the second heating unit is from approximately 1 minute 30 seconds to 3 minutes.
28. An aerosol-generating device according to any of clauses 25 to 27, wherein the first-mode predetermined duration of supplying energy to the first heating unit is different from the first-mode predetermined duration of supplying energy to the second heating unit.
29. An aerosol-generating device according to any of clauses 25 or 28, wherein the second-mode predetermined duration of supplying energy to the first heating unit is different from the second-mode predetermined duration of supplying energy to the second heating unit.
30. An aerosol-generating device according to any of clauses 25 to 29, wherein the first predetermined duration of the first-mode session of use is greater than the first-mode predetermined duration of supplying energy to the second heating unit.
31. An aerosol-generating device according to any of clauses 25 to 30, wherein the second predetermined duration of the second-mode session of use is greater than the second-mode predetermined duration of supplying energy to the second heating unit.
32. An aerosol-generating device according to any of clauses 22 to 31, wherein the first predetermined duration of the first-mode session of use is substantially the same as the first-mode predetermined duration of supplying energy to the first heating unit.
33. An aerosol-generating device according to any of clauses 22 to 32, wherein the second predetermined duration of the second-mode session of use is substantially the same as the second-mode predetermined duration of supplying energy to the first heating unit.
34. An aerosol-generating device according to any of clauses 19 to 33, wherein the first duration of the first-mode session of use and/or the second duration of the second-mode session of use is less than 7 minutes.
35. An aerosol-generating device according to clause 34, wherein the first duration of the first-mode session of use and/or the second duration of the second-mode session of use is from approximately 2 minutes 30 seconds to 5 minutes.
36. An aerosol-generating device according to any of clauses 33 to 39, wherein the duration of each session of use is less than 4 minutes 30 seconds.
37. An aerosol-generating device according to clause 35 or 36, wherein the first predetermined duration is from approximately 3 minutes to 5 minutes, and the second predetermined duration is from approximately 2 minutes 30 seconds to 3 minutes 30 seconds.
38. An aerosol-generating device according to any of clauses 34 to 37, wherein the duration of the first-mode session of use is longer than the duration of the second-mode session of use.
39. An aerosol-generating device according to any of clauses 34 to 38, wherein the first-mode session of use has a duration of less than 4 minutes.
40. An aerosol-generating device according to any of clauses 34 to 39, wherein the second-mode session of use has a duration of less than 3 minutes.
41. An aerosol-generating device according to any of clauses 19 to 40, wherein each heating unit in the heating assembly comprises a coil.
42. An aerosol-generating device according to clause 41, wherein each heating unit in the heating assembly is an induction heating unit comprising a susceptor heating element and the coil configured to be an inductor element for supplying a varying magnetic field to the susceptor heating element.
43. An aerosol-generating device according to any of clauses 19 to 41, wherein each heating unit in the heating assembly is a resistive heating unit.
44. An aerosol-generating system comprising an aerosol-generating device according to any of clauses 19 to 43 in combination with an aerosol-generating article.
45. An aerosol-generating device for generating aerosol from an aerosol-generating material, the aerosol-generating device comprising a heating assembly including:
a first heating unit arranged to heat, but not burn, the aerosol-generating material in use; and
a controller for controlling the first heating unit;

the heating assembly being configured such that the first heating unit reaches a maximum operating temperature of from 245° C. to 340° C. in use.

46. An aerosol-generating device according to clause 45, the heating assembly being configured such that the first heating unit reaches a maximum operating temperature of from 245° C. to 300° C. in use.
47. An aerosol-generating device according to clause 45 or 46, the heating assembly being configured such that the first heating unit reaches a maximum operating temperature of from 250° C. to 280° C. in use.
48. An aerosol-generating device according to any of clauses 45 to 47, wherein the heating assembly is operable in at least a first mode and a second mode;
the heating assembly being configured such that the first heating unit reaches
a first-mode maximum operating temperature in the first mode, and
a second-mode maximum operating temperature in the second mode;
the first-mode maximum operating temperature being different from the second-mode operating temperature.
49. An aerosol-generating device according to clause 48, wherein
the second-mode maximum operating temperature of the first heating unit
is higher than
the first-mode maximum operating temperature of the first heating unit.
50. An aerosol-generating device according to any of clauses 45 to 49, wherein the heating assembly further comprises a second heating unit arranged to heat, but not burn, the aerosol-generating material in use, the second heating unit being controllable by the controller.
51. An aerosol-generating device according to clause 50, the heating assembly being configured such that the second heating unit reaches
a first-mode maximum operating temperature in the first mode, and
a second-mode maximum operating temperature in the second mode.
52. An aerosol-generating device according to clause 51, wherein
the first-mode maximum operating temperature of the second heating unit
is different from
the second-mode maximum operating temperature of the second heating unit.
53. An aerosol-generating device according to clause 52, wherein
the second-mode maximum operating temperature of the second heating unit
is higher than
the first-mode maximum operating temperature of the second heating unit.
54. An aerosol-generating device according to any of clauses 51 to 53, wherein
the first-mode maximum operating temperature of the first heating unit
is substantially the same as
the first-mode maximum operating temperature of the second heating unit.
55. An aerosol-generating device according to any of clauses 51 to 54, wherein

the second-mode maximum operating temperature of the first heating unit is different from

the second-mode maximum operating temperature of the second heating unit.

56. An aerosol-generating device according to clause 55, wherein
the second-mode maximum operating temperature of the first heating unit
is higher than
the second-mode maximum operating temperature of the second heating unit.
57. An aerosol-generating device according to clause any of clauses 51 to 56, wherein
the first-mode maximum operating temperature of the first heating unit
and/or
the first-mode maximum operating temperature of the second heating unit
is from 240° C. to 300° C.
58. An aerosol-generating device according to clause 57, wherein
the second-mode maximum operating temperature of the first heating unit,
and/or
the second-mode maximum operating temperature of the second heating unit,
is from 250° C. to 300° C.
59. An aerosol-generating device according to any of clauses 51 to 58, wherein
the ratio between the first-mode maximum operating temperature of the first heating unit and the first-mode maximum operating temperature of the second heating unit
is different from
the ratio between the second-mode maximum operating temperature of the first heating unit and the second-mode maximum operating temperature of the second heating unit.
60. An aerosol-generating device according to clause 59, wherein
the ratio between the first-mode maximum operating temperature of the first heating unit and the first-mode maximum operating temperature of the second heating unit
and/or
the ratio between the second-mode maximum operating temperature of the first heating unit and the second-mode maximum operating temperature of the second heating unit
is from 1:1 to 1.2:1.
61. An aerosol-generating device according to clause 60, wherein
the ratio between the first-mode maximum operating temperature of the first heating unit and the first-mode maximum operating temperature of the second heating unit
is approximately 1:1.
62. An aerosol-generating device according to clause 60 or 61, wherein the ratio between the second-mode maximum operating temperature of the first heating unit and the second-mode maximum operating temperature of the second heating unit
is from 1.01:1 to 1.2:1.
63. An aerosol-generating device according to any of clauses 51 to 62, wherein the heating assembly is configured such that, in use, for each mode, the second heating unit rises to a first operating temperature which is lower than its maximum operating temperature, then subsequently rises to the maximum operating temperature.
64. An aerosol-generating device according to clause 63, wherein
the ratio between the first-mode first operating temperature and the first-mode maximum operating temperature
is different from
the ratio between the second-mode first operating temperature and the second-mode maximum operating temperature.
65. An aerosol-generating device according to clause 64, wherein the first-mode and/or second mode first operating temperature is from 150° C. to 200° C.
66. An aerosol-generating device according to clause 64 or 65, wherein
the ratio between the first-mode first operating temperature and the first-mode maximum operating temperature,
and/or
the ratio between the second-mode first operating temperature and the second-mode maximum operating temperature,
is from 1:1.1 to 1:2.
67. An aerosol-generating device according to clause 66, wherein the ratio between the first mode first operating temperature and the first-mode maximum operating temperature is from 1:1.1 to 1:1.6.
68. An aerosol-generating device according to clause 66 or 67, wherein the ratio between the second-mode first operating temperature and the second-mode maximum operating temperature is from 1:1.6 to 1:2.
69. An aerosol-generating device according to any of clauses 48 to 58, wherein the heating assembly is configured such that, in use, for each mode, the first heating unit is maintained at its maximum operating temperature for a first duration, and then the temperature of the first heating unit drops from the maximum operating temperature to a second operating temperature which is lower than its maximum operating temperature, and held at the second operating temperature for a second duration.
70. An aerosol-generating device according to clause 69, wherein
the ratio between the first-mode maximum operating temperature and the first-mode second operating temperature
is different from
the ratio between the second-mode maximum operating temperature and the second-mode second operating temperature.
71. An aerosol-generating device according to clause 70, wherein the first-mode and/or second mode second operating temperature is from 180° C. to 240° C.
72. An aerosol-generating device according to clause 69 or 70, wherein
the ratio between the first-mode maximum operating temperature and the first-mode second operating temperature,
and/or
the ratio between the second-mode maximum operating temperature and the second-mode second operating temperature,
is from 1.1:1 to 1.4:1.
73. An aerosol-generating device according clause 72, wherein the ratio between the first mode maximum operating temperature and the first-mode second operating temperature is from 1:1 to 1.2:1.
74. An aerosol-generating device according to clause 72 or 73, wherein the ratio between the second-mode maximum operating temperature and the second-mode second operating temperature is from 1.1:1 to 1.4:1.
75. An aerosol-generating device according to any of clauses 69 to 74, wherein the first duration is greater than the second duration in each mode.
76. An aerosol-generating device according to clause 75, wherein the ratio of the first duration to the second duration in each mode is from 1.1:1 to 7:1.
77. An aerosol-generating device according to any of clauses 45 to 76, wherein at least one heating unit present in the heating assembly comprises a coil.
78. An aerosol-generating device according clause 77, wherein the at least one heating unit is an induction heating unit comprising a susceptor heating element, wherein the coil is configured to be an inductor for supplying a varying magnetic field to the susceptor heating element.
79. An aerosol-generating device according to any of clauses 45 to 77, wherein at least one heating unit present in the heating assembly comprises a resistive heating element.
80. An aerosol-generating device according to any of clauses 45 to 79, wherein the heating assembly comprises a maximum of two heating units.
81. An aerosol-generating device according to any of clauses 45 to 79, wherein the heating assembly comprises three or more heating units.
82. A method of generating aerosol from an aerosol-generating material using an aerosol-generating device according to any of clauses 45 to 81.
83. An aerosol-generating system comprising an aerosol-generating device according to any of clauses 45 to 81 in combination with an aerosol-generating article comprising aerosol-generating material.
84. An aerosol-generating device for generating aerosol from an aerosol-generating material, the aerosol-generating device comprising:
a heating assembly including at least a first heating unit arranged to heat, but not burn, the aerosol-generating material in use, and
a controller for controlling the at least first heating unit;
wherein the heating assembly is operable in at least a first mode and a second mode;

wherein the first mode and second mode are selectable by a user interacting with user interface for selecting the first mode or second mode.

85. An aerosol-generating device according to clause 84, wherein the first mode and second mode are selectable from a single user interface.
86. An aerosol-generating device according to clause 85, wherein the first mode is selectable by activating the user interface for a first duration, and the second mode is selectable by activating the user interface for a second duration, the first duration being different from the second duration.
87. An aerosol-generating device according to clause 86, wherein the second duration is longer than the first duration.
88. An aerosol-generating device according to clause 87, wherein the first duration and/or the second duration is from 1 second to 10 seconds.
89. An aerosol-generating device according to clause 88 wherein the first duration is from 1 second to 5 seconds, and the second duration is from 2 seconds to 10 seconds.
90. An aerosol-generating device according to clause 85, wherein the first mode is selectable by a first number of activations of the user interface, and the second mode is selectable by a second number of activations of the user interface, the first number of activations being differing from the second number of activations.
91. An aerosol-generating device according to clause 91, wherein the first number of activations is a single activation, and the second number of activations is a plurality of activations.
92. An aerosol-generating device according to any of clauses 84 to 91, wherein the user interface comprises a mechanical switch, an inductive switch, a capacitive switch.
93. An aerosol-generating device according to any of clauses 84 to 92, wherein the user interface is configured such that a user interacts with the user interface by depressing at least a portion of the user interface.
94. An aerosol-generating device according to any of clauses 84 to 93, wherein the user interface comprises a push button.
95. An aerosol-generating device according to any of clauses 84 to 94, wherein the user interface is also configured for activating the device.
96. A method of operating an aerosol-generating device according to any of clauses 84 to 95, the method comprising:

receiving a signal from the user interface;

identifying a selected mode of operation associated with the received signal; and

instructing the at least one heating element to operate according to a predetermined heating profile based on the selected mode of operation.

97. An aerosol-generating device according to any of clauses 84 to 95, further comprising an indicator for indicating the selected mode to a user.
98. An aerosol-generating device according to clause 97, wherein the indicator is configured to provide a visual indication of the selected mode.
99. An aerosol-generating device according to clause 98, wherein the indicator comprises a plurality of light sources, the indicator being configured to indicate the selected mode by selective activation of the light sources.
100. An aerosol-generating device according to clause 99, wherein the device is configured such that the indicator indicates selection of the first mode by sequentially activating each of the light sources, the sequence comprising activating a first light source, subsequently activating a second light source adjacent to the first light source, and subsequently activating further light sources adjacent to activated light sources sequentially until all of the light sources are activated.
101. An aerosol-generating device according to clause 99 or 100, wherein the indicator is configured to indicate selection of the second mode by activating a selection of the plurality of light sources, the selection changing throughout indication of selection of the second mode, but the number of activated light sources remaining constant throughout indication of selection of the second mode.
102. An aerosol-generating device according to any of clauses 97 to 101, wherein the indicator is configured to provide haptic indication of the selected mode.
103. An aerosol-generating device according to clause 102, wherein the indicator comprises a vibration motor, preferably an eccentric rotating mass vibration motor or a linear resonant actuator.
104. An aerosol-generating device according to clause 102 or 103, wherein the indicator is configured to indicate selection of the first mode by activating the vibration motor for a first duration, and selection of the second mode by activating the vibration motor for a second duration, the first duration being different from the second duration.
105. An aerosol-generating device according to any of clauses 102 to 104, wherein the indicator is configured to indicate selection of the first mode by activating the vibration motor for a first number of pulses, and selection of the second mode by activating the vibration for a second number of pulses, the first number of pulses being different from the second number of pulses.
106. An aerosol-generating device according to clause 105, wherein the second number of pulses is greater than the first number of pulses.
107. An aerosol-generating device according to clause 106, wherein the first number of pulses is a single pulse, and the second number of pulses is a plurality of pulses.
108. An aerosol-generating device according to any of clauses 97 to 107, wherein the indicator is configured to provide audible indication of the selected mode.
109. An aerosol-generating device according to any of clauses 97 to 108, wherein the indicator is configured to indicate the selected mode to a user for a portion of a session of use shorter than the session of use.
110. An aerosol-generating device according to any of clauses 84 to 109, wherein the heating assembly is configured such that:
the first mode and second mode are selectable by a user before a session of use and/or during a first portion of a session of use; and
the selected mode cannot be changed by the user during a second portion of the session of use.
111. An aerosol-generating device according to clause 110, wherein the session of use starts when power is first supplied to the at least first heating unit of the heating assembly.
112. An aerosol-generating device according to clause 110 or 111, wherein the first mode and second mode are selectable by a user after activation of the device and before the session of use, and optionally during the first portion of the session of use.
113. An aerosol-generating device according to any of clauses 110 to 112, wherein the first portion of the session of use ends at or before the point at which the first heating unit reaches an operating temperature.
114. An aerosol-generating device according to any of clauses 110 to 113, wherein the second portion begins at or after the point at which the first heating unit reaches an operating temperature.
115. An aerosol-generating device according to any of clauses 110 to 113, wherein the first portion of the session of use ends at or before the point at which the first heating unit reaches a maximum operating temperature.
116. An aerosol-generating device according to any of clauses 110 to 115, wherein the second portion begins at or after the point at which the first heating unit reaches a maximum operating temperature.
117. An aerosol-generating device according to any of clauses 110 to 116, wherein the first portion of the session of use ends between 5 and 20 seconds after the beginning of the session of use.
118. An aerosol-generating device according to any of clauses 110 to 117, wherein the first portion of the session of use ends when a user terminates interaction with the user interface.
119. An aerosol-generating system comprising an aerosol-generating device according to any of clauses 84 to 118 in combination with an aerosol-generating article.
120. An aerosol-generating device for generating aerosol from an aerosol-generating material, the aerosol-generating device comprising a heating assembly including:
a first heating unit arranged to heat, but not burn, the aerosol-generating material in use; and a controller for controlling the first heating unit;
the heating assembly being configured such that the first heating unit has an average temperature of from 180° C. to 280° C. over an entire session of use,
wherein the average temperature is calculated from temperature measurements taken at the first heating unit with a frequency of at least 1 Hz across the entire session of use.
121. An aerosol-generating device according to clause 120, wherein the heating assembly includes a plurality of heating units, the plurality comprising the first heating unit and at least a second heating unit arranged to heat, but not burn, the aerosol-generating material in use.
122. An aerosol-generating device according to clause 121, wherein the heating assembly comprises more than two heating units.
123. An aerosol-generating device according to clause 122, wherein the heating assembly comprises a maximum of two heating units.
124. An aerosol-generating device according to any of clauses 121 to 123, wherein the heating assembly is configured such that the second heating unit has an average temperature of from 180 to 280° C. over an entire session,
wherein the average temperature is calculated from temperature measurements taken at the second heating unit with a frequency of at least 1 Hz across the entire session of use.
125. An aerosol-generating device according to clause 124, wherein the average temperature of the second heating unit over the entire session of use is different from the average temperature of the first heating unit over the entire session of use.
126. An aerosol-generating device according to clause 125, wherein the average temperature of the second heating unit over the entire session of use is higher than the average temperature of the first heating unit over the entire session of use.
127. An aerosol-generating device according to clause 120, wherein the heating assembly is operable in a plurality of modes, the plurality comprising at least a first mode and a second mode, wherein the heating assembly is configured such that the average temperature of the first heating unit in the first mode is different from the average temperature of the first heating unit in the second mode.
128. An aerosol-generating device according to clause 127, wherein the heating assembly is configured such that the average temperature of the first heating unit in the second mode is higher than the average temperature of the first second heating unit in the first mode.
129. An aerosol-generating device according to any of clauses 121 to 126, wherein the heating assembly is operable in a plurality of modes, the plurality comprising at least a first mode and a second mode, wherein the heating assembly is configured such that the average temperature of the first and/or second heating unit in the first mode is different from the average temperature of the first and/or second heating unit in the second mode respectively.
130. An aerosol-generating device according to clause 129, wherein the heating assembly is configured such that the average temperature of each heating unit present in the heating assembly in the first mode is different from that in the second mode.
131. An aerosol-generating device according to clause 129 or 130, wherein the heating assembly is configured such that the average temperature of the first and/or second heating unit in the second mode is higher than in the first mode.
132. An aerosol-generating device according to clause 130 or 131, wherein the heating assembly is configured such that the average temperature of each heating unit present in the heating assembly in the second mode is higher than in the first mode.
133. An aerosol-generating device according to clause 131 or 132, wherein the average temperature of the first and/or second heating unit in the second mode is from approximately 1 to 100° C. higher than in the first mode.
134. An aerosol-generating device according to any of clauses 129 to 133, wherein the average temperature of the first heating unit in the first and/or second mode is from approximately 180° C. to 280° C.
135. An aerosol-generating device according to any of clauses 129 to 134, wherein the average temperature of the second heating unit in the first and/or second mode is from approximately 140° C. to 240° C.
136. An aerosol-generating device according to any of clauses 120 to 135, wherein each heating unit present in the heating assembly comprises a coil.
137. An aerosol-generating device according to clause 136, wherein each heating unit present in the heating assembly is an induction heating unit comprising a susceptor, wherein the coil is configured to be an inductor element for supplying a variable magnetic field to the susceptor.
138. An aerosol-generating device according to any of clauses 120 to 137, wherein the aerosol-generating device is a tobacco heating product, also known as a heat-not-burn device.
139. An aerosol-generating assembly comprising an aerosol-generating device according to any of clauses 120 to 138 and an aerosol-generating article.
140. A method of generating an inhalable aerosol with an aerosol-generating device according to any of clauses 120 to 139, the method comprising instructing the first heating unit of the heating assembly to heat an aerosol-generating material over a session of use, the first heating unit having an average temperature of from 180° C. to 280° C. over the session of use.
141. An aerosol-generating device for generating an inhalable aerosol from aerosol-generating material, the aerosol-generating device including a heating assembly comprising:

a first induction heating unit arranged to heat, but not burn, the aerosol-generating material in use;

a second induction heating unit arranged to heat, but not burn, the aerosol-generating material in use; and

a controller for controlling the first and second induction heating units;

wherein the heating assembly is configured such that during one or more portions of a session of use of the aerosol-generating device, the first induction heating unit operates at a substantially constant first temperature and the second induction heating temperature operates at a substantially constant second temperature.

142. An aerosol-generating device according to clause 141, wherein the first temperature is different from the second temperature.
143. An aerosol-generating device according to clause 141 or 142, wherein at least one of the one or more portions has a duration of at least 10 seconds.
144. An aerosol-generating device according to clause 142 or 143, wherein the difference between the first and second temperatures is at least 25° C.
145. An aerosol-generating device according to any of clauses 142 to 144, wherein the one or more portions comprises a first portion during which the first temperature is higher than the second temperature, the first portion beginning within the first half of the session of use.
146. An aerosol-generating device according to clause 145, wherein the first portion begins within the first 60 seconds of the session of use.
147. An aerosol-generating device according to clause 145 or 146, wherein the first portion ends after 60 seconds or more from the beginning of the session of use.
148. An aerosol-generating device according to any of clauses 145 to 147, wherein the first temperature during the first portion is from 240° C. to 300° C.
149. An aerosol-generating device according to any of clauses 145 to 148, wherein the second temperature during the first portion is from 100 to 200° C.
150. An aerosol-generating device according to any of clauses 145 to 149, wherein the one or more portions further comprises a second portion during which the second temperature is higher than the first temperature, the second portion beginning after not less than 60 seconds from the beginning of the session of use.
151. An aerosol-generating device according to clause 150, wherein the second portion ends within 60 seconds of the end of the session of use.
152. An aerosol-generating device according to clause 151, wherein the second portion ends substantially simultaneously with the end of the session of use.
153. An aerosol-generating device according to any of clauses 150 to 152, wherein the first temperature during the second portion is from 140° C. to 250° C.
154. An aerosol-generating device according to any of clauses 150 to 153, wherein the second temperature during the second portion is from 240° C. to 300° C.
155. An aerosol-generating device according to any of clauses 141 to 154, wherein the device has a mouth end and a distal end, and the first and second heating units are arranged in the heating assembly along an axis extending from the mouth end to the distal end, the first induction unit being arranged closer to the mouth end than the second induction heating unit.
156. An aerosol-generating device according to clause 155, wherein the first and second heating units each have an extent along the axis, the extent of the second heating unit being greater than the first heating unit.
157. An aerosol-generating device according to any of clauses 141 to 156, wherein the controller is configured to selectively activate the first induction heating unit and the second induction heating unit such that only one of the first induction heating unit and the second induction heating unit is active at any one time during the one or more portions of the session of use.
158. A method of providing an aerosol using an aerosol-generating device according to clause 157, the method comprising:

controlling the first induction heating unit to have the first temperature and the second induction heating unit to have the second temperature during the one or more portions, wherein the controlling comprises selectively activating the first induction heating unit and the second induction heating unit such that only one of the first induction heating unit and the second induction heating unit is active at any one time during the one or more portions.

159. A method according to clause 158, wherein further comprising detecting a characteristic of at least one of the induction heating units, and selectively activating the induction heating unit based on the detected characteristic.
160. An aerosol-generating system comprising an aerosol-generating device according to any of clauses 141 to 157 in combination with an aerosol-generating article.
161. An aerosol-generating device for generating aerosol from an aerosol-generating material, the aerosol-generating device comprising a heating assembly including:
a first heating unit arranged to heat, but not burn, the aerosol-generating material in use; and
a controller for controlling the first heating unit;
the heating assembly being configured such the controller specifies a programmed temperature profile for the first heating unit over a session of use, and the first heating unit has an observed temperature profile over a session of use;
wherein the mean absolute error of the observed temperature profile from the programmed temperature profile over the session of use is less than 20° C.,
wherein the mean absolute error is calculated from temperature measurements taken at the first heating unit at a frequency of at least 1 Hz during the session of use, and the programmed temperatures at corresponding timepoints of the programmed temperature profile.
162. An aerosol-generating device according to clause 161, wherein the mean absolute error is less than 15° C.
163. An aerosol-generating device according to clause 161 or 162, wherein the mean absolute error is less than 10° C.
164. An aerosol-generating device according any of clauses 161 to 163, wherein the mean absolute error is less than 5° C.
165. An aerosol-generating device according to any of clauses 161 to 164, wherein the heating assembly further comprises a second heating unit, the heating assembly being configured such that the controller specifies a programmed temperature profile for the second heating unit over a session of use, and the second heating unit has an observed temperature profile over a session of use.
166. An aerosol-generating device according to clause 165, wherein the programmed temperature profile for the second heating unit is different from the programmed temperature profile for the second heating unit.
167. An aerosol-generating device according to clause 165 or 166, wherein the heating assembly is configured such that the second heating unit has a mean absolute error of the observed temperature profile from the programmed temperature profile over the session of use which is less than 50° C.
168. An aerosol-generating device according to any of clauses 165 to 167, wherein the first and second heating units taken together have a mean absolute error of the observed temperature profiles from the programmed temperature profiles over the session of use which is less than 40° C.
169. An aerosol-generating device according to any of clauses 165 to 168, wherein the heating assembly is configured to have a mean absolute error of less than 40° C.
170. An aerosol-generating device according to any of clauses 165 to 169, the heating assembly being configured such that the first heating unit has a first average temperature over a session of use and the second heating unit has a second average temperature over a session of use, the first average temperature being different from the second average temperature.
171. An aerosol-generating device according to any of clauses 165 to 170, wherein the mean absolute error of the first heating unit is less than the mean absolute error of the second heating unit.
172. An aerosol-generating device according to any of clauses 161 to 171, wherein the heating assembly is operable in a plurality of modes, the plurality comprising at least a first mode and a second mode.
173. An aerosol-generating device according to clause 172, wherein the heating assembly is configured such that the mean absolute error of the first heating unit in the first mode is substantially the same as the mean absolute error of the first heating unit in the second mode, or differs by less than 5° C.
174. An aerosol-generating device according to any of clauses 161 to 173, comprising a temperature sensor arranged at each heating unit in the heating assembly.
175. An aerosol-generating device according to any of clauses 161 to 174, wherein the controller is configured to control the temperature of each heating unit in the heating assembly by a control feedback mechanism based on temperature data supplied from the temperature sensor arranged at each heating unit.
176. An aerosol-generating device according to any of clauses 161 to 175, wherein each heating unit present in the heating assembly comprises a coil
177. An aerosol-generating device according to clause 176, wherein each heating unit present in the heating assembly is an induction heating unit comprising a susceptor, wherein the coil is configured to be an inductor element for supplying a variable magnetic field to the susceptor.
178. An aerosol-generating device according to any of clauses 161 to 177, wherein the heating assembly is configured such that the first heating unit has a maximum operating temperature of from 200° C. to 300° C.
179. An aerosol-generating system comprising an aerosol-generating device according to any of clauses 161 to 178 in combination with an aerosol-generating article.

1. An aerosol-generating device for generating aerosol from an aerosol-generating material, the aerosol-generating device comprising:
a heating assembly having a mouth end and a distal end, the heating assembly comprising:
a first induction heating unit arranged to heat, but not burn, the aerosol-generating material in use;
a second induction heating unit arranged to heat, but not burn, the aerosol-generating material in use, the first induction heating unit being disposed closer to the mouth end of the heating assembly than the second induction heating unit; and
a controller for controlling the first and second induction heating units;
wherein the heating assembly is configured such that at least one induction heating unit reaches a maximum operating temperature within 20 seconds of supplying power to the at least one induction heating unit.

2. An aerosol-generating device for generating aerosol from an aerosol-generating material, the aerosol-generating device comprising:
a heating assembly having a mouth end and a distal end, the heating assembly comprising:
a first induction heating unit arranged to heat, but not burn, the aerosol-generating material in use;
a second induction heating unit arranged to heat, but not burn, the aerosol-generating material in use, the first induction heating unit being disposed closer to the mouth end of the heating assembly than the second induction heating unit; and
a controller for controlling the first and second induction heating units;
wherein the heating assembly is configured such that at least one induction heating unit reaches a maximum operating temperature at a rate of at least 50° C. per second in use.

3. An aerosol-generating device according to claim 1, wherein the at least one induction heating unit includes the first induction heating unit.

4. An aerosol-generating device according to claim 1, wherein the first inductive heating unit is controllable independent from the second inductive heating unit.

5. An aerosol-generating device according to claim 1, wherein the heating assembly is configured such that the first and second induction heating units have temperature profiles which differ from each other in use.

6. An aerosol-generating device according to claim 1, wherein the wherein the heating assembly is configured such that in use the second induction unit rises from a first operating temperature to a maximum operating temperature which is higher than the first operating temperature at a rate of at least 50° C. per second.

7. An aerosol-generating device according to claim 1, wherein the heating assembly is configured such that the first induction heating unit reaches a maximum operating temperature within 2 seconds of activating the device.

8. An aerosol-generating device for generating aerosol from an aerosol-generating material, the aerosol-generating device comprising:
a heating assembly having a mouth end and a distal end, the heating assembly comprising:
a first heating unit arranged to heat, but not burn, the aerosol-generating material in use;
a second heating unit arranged to heat, but not burn, the aerosol-generating material in use, the first heating unit being disposed closer to the mouth end of the heating assembly than the second heating unit; and
a controller for controlling the first and second heating units;
wherein the heating assembly is configured such that at least one heating unit reaches a maximum operating temperature within 15 seconds of supplying power to the first heating unit.

9. An aerosol-generating device according to claim 8, wherein the at least one heating unit includes the first heating unit.

10. An aerosol-generating device according to claim 8, wherein the aerosol-generating device is configured to generate aerosol from a non-liquid aerosol-generating material.

11. An aerosol-generating device according to claim 10 wherein the non-liquid aerosol-generating material comprises tobacco.

12. An aerosol-generating device according to claim 11, wherein the aerosol-generating device is a tobacco heating product.

13. An aerosol-generating device according to claim 8, further comprising an indicator for indicating to a user that the device is ready for use within 20 seconds of activating the device.

14. An aerosol-generating device according to claim 8, wherein the maximum operating temperature of the first heating unit is from approximately 200° C. to approximately 300° C.

15. An aerosol-generating device according to claim 8, further comprising a further heating unit.

16. A method of generating aerosol from an aerosol-generating material using an aerosol-generating device according to claim 1, the method comprising supplying power to at least one heating unit such that the at least one heating unit reaches its maximum operating temperature within 20 seconds of supplying the power to the at least one heating unit.

17. An aerosol-generating system comprising an aerosol-generating device according to claim 1 in combination with an aerosol-generating article.

18. (canceled)
